(19) United States
(12) Patent Application Publication
(10) Pub. No.: US 2025/0331610 A1
(43) Pub. Date: Oct. 30, 2025

(54) SKATE OR OTHER FOOTWEAR

(71) Applicant: BAUER HOCKEY LLC, EXETER, NH (US)

(72) Inventors: Jean-François Corbeil, Prevost (CA); Alexis Seguin, Laval (CA); Ivan Labonté, Montreal (CA)

(21) Appl. No.: 18/855,353

(22) PCT Filed: Apr. 28, 2023
(86) PCT No.: PCT/CA2023/050578

§ 371 Date: Oct. 9, 2024

Related U.S. Application Data
(60) Provisional application No. 63/336,646, filed on Apr. 29, 2022.

(51) Int. Cl. A43B 23/08; A43B 3/00; A43B 5/16; B29D 35/14

(52) U.S. Cl. CPC A43B 23/088; A43B 3/0078; A43B 5/1666; B29D 35/146

(57) ABSTRACT

A skate or other footwear, comprising a skate boot or other foot-receiving structure for receiving a user's foot and possibly one or more other components, such as a skating device below the skate boot to engage a skating surface. At least part of the skate 5 boot or other foot-receiving structure and optionally at least part of one or more other components (e.g., the skating device) may be constructed from one or more materials (e.g., foams) molded by flowing during a molding process (e.g., injection molding or casting). This may allow useful performance characteristics (e.g., reduced weight, better comfort, etc.) and cost-effective manufacturing. One or more parts of the skate 0 boot or other foot-receiving structure (e.g., a toe cap, a tendon guard, etc.) may be reinforced to enhance impact resistance, durability, and/or other aspects thereof. The skate boot or other foot-receiving structure may be customized by being thermoformed on the user's foot more efficiently.

### CROSS-REFERENCE TO RELATED APPLICATION

This application claims the benefit of U.S. Provisional Patent Application No. 63/336,646 filed on Apr. 29, 2022, the entire content of which is incorporated by reference herein.

### FIELD

This disclosure generally relates to footwear, including skates (e.g., ice skates) such as for playing hockey and/or other skating activities and other footwear.

### BACKGROUND

Skates are used by skaters in various sports such as ice hockey, roller hockey, etc. A skate comprises a skate boot that typically comprises a number of components that are assembled together to form the skate boot. This can include a body, sometimes referred to as a “shell”, a toe cap, a tongue, a tendon guard, etc.

For example, an approach to manufacturing a shell of a skate boot of conventional skates consists of thermoforming different layers of synthetic material and then assembling these layers to form the shell. However, such conventional skates may sometimes be overly heavy, uncomfortable, lacking in protection in certain areas, and/or a bad fit on a skater's foot. Moreover, such conventional skates can be expensive to manufacture.

Also, a skating device, such as a blade holder holding a blade for ice skating or a wheel holder holding wheels for roller skating (e.g., inline skating), is normally fastened under a skate boot. This may add attachment, manufacturing, and/or other issues.

Similar considerations may arise for other types of footwear (e.g., ski boots, snowboarding boots, motorcycle boots, work boots, etc.).

For these and/or other reasons, there is a need for improvements directed to skates and other footwear.

### SUMMARY

In accordance with various aspects of this disclosure, there is provided a skate (e.g., an ice skate) or other footwear for a user. The skate or other footwear comprises a skate boot or other foot-receiving structure for receiving a foot of the user and possibly one or more other components, such as a skating device (e.g., a blade and a blade holder) disposed beneath the skate boot to engage a skating surface. In some cases, at least part of the skate boot or other foot-receiving structure and optionally at least part of one or more other components (e.g., the skating device) of the skate or other footwear may be constructed from one or more materials (e.g., foams) molded by flowing in molding equipment during a molding process (e.g., injection molding or casting). This may allow the skate or other footwear to have useful performance characteristics (e.g., reduced weight, proper fit and comfort, etc.) while being more cost-effectively manufactured. One or more parts of the skate boot or other foot-receiving structure (e.g., a toe cap, a tendon guard, etc.) may be reinforced to enhance impact resistance, durability, and/or other aspects thereof. The skate boot or other foot-receiving structure may be customized by being thermoformed on the user's foot more efficiently.

For example, in accordance with an aspect of the disclosure, there is provided a skate boot for a skate. The skate boot is configured to receive a foot of a user and comprises: a body comprising a medial side portion configured to face a medial side of the user's foot, a lateral side portion configured to face a lateral side of the user's foot, an ankle portion configured to receive an ankle of the user, and a heel portion configured to receive a heel of the user's foot; and a tendon guard configured to face an Achilles tendon of the user and extending upwardly from the body of the skate boot. The body of the skate boot is overmolded onto the tendon guard. The tendon guard comprises an anchor extending forwardly and overmolded by the ankle portion of the body of the skate boot.

In accordance with another aspect of the of the disclosure, there is provided a skate boot for a skate. The skate boot is configured to receive a foot of a user and comprises: a body comprising a medial side portion configured to face a medial side of the user's foot, a lateral side portion configured to face a lateral side of the user's foot, an ankle portion configured to receive an ankle of the user, and a heel portion configured to receive a heel of the user's foot; and a tendon guard configured to face an Achilles tendon of the user and extending upwardly from the body of the skate boot. The ankle portion of the body of the skate boot comprises a medial ankle portion configured to face a medial side of the user's ankle and a lateral ankle portion configured to face a lateral side of the user's ankle. The body of the skate boot is overmolded onto the tendon guard. The tendon guard comprises an anchor extending forwardly and overmolded by each of the medial ankle portion and the lateral ankle portion of the body of the skate boot.

In accordance with another aspect of the of the disclosure, there is provided a skate boot for a skate. The skate boot is configured to receive a foot of a user and comprises: a body comprising a medial side portion configured to face a medial side of the user's foot, a lateral side portion configured to face a lateral side of the user's foot, an ankle portion configured to receive an ankle of the user, and a heel portion configured to receive a heel of the user's foot; a tendon guard configured to face an Achilles tendon of the user and extending upwardly from the body of the skate boot; and a lacing system configured to receive a lace for tying the skate boot. The body of the skate boot is overmolded onto the tendon guard. The tendon guard comprises an anchor extending forwardly, engaging and affixed to the lacing system, and overmolded by the ankle portion of the body of the skate boot.

In accordance with another aspect of the of the disclosure, there is provided a skate boot for a skate. The skate boot is configured to receive a foot of a user and comprises: a body comprising a medial side portion configured to face a medial side of the user's foot, a lateral side portion configured to face a lateral side of the user's foot, an ankle portion configured to receive an ankle of the user, and a heel portion configured to receive a heel of the user's foot; a tendon guard configured to face an Achilles tendon of the user and extending upwardly from the body of the skate boot; and a medial lacing member and a lateral lacing member configured to receive a lace for tying the skate boot. The body of the skate boot is overmolded onto the tendon guard. The tendon guard comprises an anchor extending forwardly, engaging and affixed to each of the medial lacing member and the lateral lacing member, and overmolded by the ankle portion of the body of the skate boot.

In accordance with another aspect of the of the disclosure, there is provided a skate boot for a skate. The skate boot is configured to receive a foot of a user and comprises: a body comprising a medial side portion configured to face a medial side of the user's foot, a lateral side portion configured to face a lateral side of the user's foot, an ankle portion configured to receive an ankle of the user, a heel portion configured to receive a heel of the user's foot, and a toe portion configured to enclose toes of the user's foot; and a reinforcement affixed to the toe portion of the body of the skate boot. The medial side portion, the lateral side portion, the ankle portion, the heel portion, and the toe portion of the body of the skate boot are injection molded with one another. The reinforcement comprises a lateral side portion configured to face a small toe of the user's foot, a medial side portion configured to face a big toe of the user's foot, an upper portion configured to face a top of the user's toes, and an end portion disposed between the lateral side portion and the medial side portion of the reinforcement and extending downwardly from the upper portion of the reinforcement.

In accordance with another aspect of the of the disclosure, there is provided a skate boot for a skate. The skate boot is configured to receive a foot of a user and comprises:

a body comprising a medial side portion configured to face a medial side of the user's foot, a lateral side portion configured to face a lateral side of the user's foot, an ankle portion configured to receive an ankle of the user, a heel portion configured to receive a heel of the user's foot, and a toe portion configured to enclose toes of the user's foot; and a reinforcement affixed to the toe portion of the body of the skate boot. The medial side portion, the lateral side portion, the ankle portion, the heel portion, and the toe portion of the body of the skate boot are injection molded with one another. The body of the skate boot includes a plurality of injection-molded layers that are injection molded with one another. The reinforcement comprises a lateral side portion configured to face a small toe of the user's foot, a medial side portion configured to face a big toe of the user's foot, an upper portion configured to face a top of the user's toes, and an end portion disposed between the lateral side portion and the medial side portion of the reinforcement and extending downwardly from the upper portion of the reinforcement. The reinforcement is disposed within at least one of the injection-molded layers.

In accordance with another aspect of the of the disclosure, there is provided a skate boot for a skate. The skate boot is configured to receive a foot of a user and comprises: body comprising a medial side portion configured to face a medial side of the user's foot, a lateral side portion configured to face a lateral side of the user's foot, an ankle portion configured to receive an ankle of the user, a heel portion configured to receive a heel of the user's foot, and a toe portion configured to enclose toes of the user's foot; and a reinforcement affixed to the toe portion of the body of the skate boot. The medial side portion, the lateral side portion, the ankle portion, the heel portion, and the toe portion of the body of the skate boot are injection molded with one another. The body of the skate boot includes a plurality of injection-molded layers that are injection molded with one another. The reinforcement comprises a lateral side portion configured to face a small toe of the user's foot, a medial side portion configured to face a big toe of the user's foot, an upper portion configured to face a top of the user's toes, and an end portion disposed between the lateral side portion and the medial side portion of the reinforcement and extending downwardly from the upper portion of the reinforcement. The reinforcement is embedded in a foam one of the injection-molded layers.

In accordance with another aspect of the of the disclosure, there is provided a skate boot for a skate. The skate boot is configured to receive a foot of a user and comprises: a body comprising a medial side portion configured to face a medial side of the user's foot, a lateral side portion configured to face a lateral side of the user's foot, an ankle portion configured to receive an ankle of the user, a heel portion configured to receive a heel of the user's foot, and a toe portion configured to enclose toes of the user's foot; and a reinforcement affixed to the toe portion of the body of the skate boot. The medial side portion, the lateral side portion, the ankle portion, the heel portion, and the toe portion of the body of the skate boot are injection molded with one another. The body of the skate boot includes a plurality of injection-molded layers that are injection molded with one another. The reinforcement comprises a lateral side portion configured to face a small toe of the user's foot, a medial side portion configured to face a big toe of the user's foot, an upper portion configured to face a top of the user's toes, and an end portion disposed between the lateral side portion and the medial side portion of the reinforcement and extending downwardly from the upper portion of the reinforcement. The reinforcement is disposed beneath a clear external one of the injection-molded layers.

In accordance with another aspect of the of the disclosure, there is provided a sleeve for thermoforming a skate boot of a skate on a foot of a user. The skate boot comprises a cavity configured to receive the user's foot. The sleeve comprises: a covering configured to cover at least part of the skate boot; and a fastening system configured to fasten the covering to the skate boot and support the skate boot while the skate boot is being thermoformed with the user's foot in the skate boot.

In accordance with another aspect of the of the disclosure, there is provided, in combination: a skate for a user, the skate comprising a skate boot comprising a cavity configured to receive the user's foot; and a sleeve for thermoforming the skate boot on the user's foot. The sleeve comprises: a covering configured to cover at least part of the skate boot; and a fastening system configured to fasten the covering to the skate boot and support the skate boot while the skate boot is being thermoformed with the user's foot in the skate boot.

In accordance with another aspect of the of the disclosure, there is provided a method for thermoforming a skate boot of a skate on a foot of a user. The skate boot comprises a cavity configured to receive the user's foot. The method comprises: heating the skate boot; mounting a sleeve on the skate boot; and thermoforming the skate boot with the user's foot in the skate boot while the sleeve is mounted to and supports the skate boot.

In accordance with another aspect of the of the disclosure, there is provided an article of footwear configured to receive a foot of a user. The article of footwear comprises: a body comprising a medial side portion configured to face a medial side of the user's foot, a lateral side portion configured to face a lateral side of the user's foot, an ankle portion configured to receive an ankle of the user, a heel portion configured to receive a heel of the user's foot, and a toe portion configured to enclose toes of the user's foot; and a reinforcement affixed to the toe portion of the body of the article of footwear.

The medial side portion, the lateral side portion, the ankle portion, the heel portion, and the toe portion of the body of the article of footwear are injection molded with one another. The reinforcement comprises a lateral side portion configured to face a small toe of the user's foot, a medial side portion configured to face a big toe of the user's foot, an upper portion configured to face a top of the user's toes, and an end portion disposed between the lateral side portion and the medial side portion of the reinforcement and extending downwardly from the upper portion of the reinforcement.

In accordance with another aspect of the of the disclosure, there is provided a sleeve for thermoforming an article of footwear on a foot of a user. The article of footwear comprises a cavity configured to receive the user's foot. The sleeve comprises: a covering configured to cover at least part of the article of footwear; and a fastening system configured to fasten the covering to the article of footwear and support the article of footwear while the article of footwear is being thermoformed with the user's foot in the article of footwear.

In accordance with another aspect of the of the disclosure, there is provided a method for thermoforming an article of footwear on a foot of a user. The article of footwear comprises a cavity configured to receive the user's foot. The method comprises: heating the article of footwear; mounting a sleeve on the article of footwear; and thermoforming the article of footwear with the user's foot in the article of footwear while the sleeve is mounted to and supports the article of footwear.

In accordance with another aspect of the of the disclosure, there is provided, in combination: an article of footwear comprising a cavity configured to receive a user's foot; and a sleeve for thermoforming the article of footwear on the user's foot. The sleeve comprises: a covering configured to cover at least part of the article of footwear; and a fastening system configured to fasten the covering to the article of footwear and support the article of footwear while the article of footwear is being thermoformed with the user's foot in the article of footwear.

These and other aspects of this disclosure will now become apparent to those of ordinary skill in the art upon review of a description of embodiments that follows in conjunction with accompanying drawings.

### BRIEF DESCRIPTION OF DRAWINGS

A detailed description of embodiments is provided below, by way of example only, with reference to drawings annexed hereto, in which:

FIG. 1 is an example of a skate for a skater, in accordance with an embodiment;

FIG. 2 is an exploded view of the skate;

FIG. 3 is a perspective view of a shell of a skate boot of the skate;

FIG. 4 is a block diagram showing a molding process implementing a molding apparatus to form the shell of the skate boot;

FIG. 5 is a cross-sectional view of the shell showing a plurality of subshells of the shell, including an internal, an intermediate and an external subshell of the shell;

FIG. 6 is a cross-sectional view of the shell of the skate boot in an embodiment in which the shell is a unitary shell (i.e., has no subshells);

FIG. 7 is a cross-sectional view of the shell of the skate boot in an embodiment in which the shell comprises subshells;

FIGS. 8 to 10 are cross-sectional views of the shell in embodiments in which at least one of the subshells comprise an opening in a sole region of the shell;

FIG. 11 is a cross-sectional view of the shell in embodiments in which a footbed of the skate boot is formed integrally with the shell of the skate boot;

FIGS. 12 and 13 are cross-sectional views of the shell in embodiments in which the external subshell of the shell and/or the internal subshell of the shell comprises an opening at the sole region of the shell;

FIG. 14 is a cross-sectional view of the shell in an embodiment in which the shell comprises four subshells;

FIG. 15 is an example of a last of the molding apparatus used to form the shell;

FIG. 16 is a cross-sectional view of the last and a first female mold used to produce the internal subshell of the shell;

FIG. 17 is a cross-sectional view of the last and a second female mold used to produce the intermediate subshell of the shell;

FIG. 18 is a cross-sectional view of the last and a third female mold used to produce the external subshell of the shell;

FIGS. 19 and 20 are side views of the shell in embodiments in which the shell comprises a reinforcement and the reinforcement comprises a rib;

FIGS. 21 and 22 are side views of the shell in embodiments in which the reinforcement comprises a reinforcing sheet;

FIG. 23 is a side view of the shell in embodiments in which the shell comprises more than one reinforcements;

FIG. 24 is a side view of the shell in embodiments in which the reinforcement is a toe reinforcement;

FIG. 25 is a cross-sectional view of the shell of FIG. 24;

FIG. 26 is a perspective view of the toe reinforcement;

FIGS. 27 to 29 are cross-sectional views of variants of the shell comprising a toe reinforcement;

FIG. 30 is a side view of the shell in accordance with an embodiment in which the reinforcement comprises a single fiber;

FIG. 31 is a cross-sectional view of the shell in an embodiment in which the shell comprises a reinforcement and a graphical element disposed between the intermediate subshell and the external subshell;

FIG. 32 is a side view of the skate comprising the reinforcement and the graphical element;

FIG. 33 is a film having graphical ink on an ink-providing side;

FIG. 34 shows the film after a molding process;

FIG. 35 shows a cross-sectional view of the skate comprising the graphical ink;

FIG. 36 shows a variant of the film after the molding process wherein the film is configured to cover eyelets of the skate boot;

FIG. 37 is a conceptual illustration of constituents of a material flowing into a mold cavity to produce a resulting polymeric material;

FIG. 38 is a perspective view of an embodiment in which the shell comprises an overlay;

FIGS. 39 to 41 are variants of the skate wherein an insole of the skate boot is affixed to the skate boot;

FIG. 42 shows an example of an embodiment wherein an inner liner of the skate boot comprises a sole portion;

FIG. 43 shows an example of an embodiment wherein an inner liner of the skate boot does not comprise a sole portion;

FIGS. 44 and 45 show a sheet of material used for manufacturing the inner liner in accordance with an embodiment;

FIG. 46 shows the inner liner of FIGS. 44 and 45;

FIGS. 47 to 50 are respective side, front, top and bottom views of the shell of FIG. 3;

FIG. 51 is a cross-sectional view of the shell taken along line 51-51 of FIG. 48;

FIGS. 52 and 53 are cross-sectional views of the shell taken along lines 52-52 and 53-53 of FIG. 47;

FIG. 54 is a perspective view of a tongue of the skate boot;

FIG. 55 is a side view of a blade of a skating device of the skate;

FIG. 56 shows embodiments in which the blade is affixed to a blade holder of the skating device of the skate;

FIGS. 57 and 58 show a blade-receiving slot of the blade holder;

FIGS. 59 and 60 show an example of an embodiment in which an outermost one of the subshells makes up an outer surface of the shell and an outer surface of the blade holder;

FIGS. 61 to 70 show an example of an embodiment in which the blade holder comprises a core;

FIGS. 71 to 74 show examples of an embodiment in which the skate comprises a connection system to attach a blade to and detach the blade from the skate;

FIG. 75 is a side view of the shell in an embodiment in which a limited part of the blade holder is molded integrally with the shell;

FIGS. 76 and 77 are cross-sectional views of examples of securing the limited part of the blade holder which is molded integrally with the shell with another part of the blade holder;

FIGS. 78 to 82 show different examples of embodiments in which the blade is affixed to a blade holder of the skating device of the skate;

FIG. 83 is a side view of the blade of the skating device;

FIG. 84 is a cross-sectional view of the blade taken along line 84-84 of FIG. 83;

FIGS. 85 and 86 are cross-sectional views of the shell in embodiments in which at least part of the blade holder is molded integrally with the shell;

FIG. 87 is an exploded view of the skate in an embodiment in which the shell is molded separately from the blade holder and from other components of the skate boot, notably the toe cap, the tongue, the tendon guard, the footbed and the lace members of the skate boot;

FIGS. 88 to 90 show an example of an embodiment in which the skate comprises a connection system to attach the blade holder to and detach the blade holder from the skate boot;

FIG. 91 is a side of the skate in an embodiment in which the shell of the skate boot is molded alone (i.e., separately from the toe cap, the tongue, the tendon guard, the footbed and the lace members of the skate boot);

FIG. 92 is a side view of the skate in an embodiment in which any of the toe cap, the tongue, the tendon guard, the footbed and the lace members are molded integrally with the shell of the skate boot;

FIG. 93 is a cross-sectional view of the shell in an embodiment in which the shell comprises the internal, intermediate and external subshells and is molded separately from the blade holder;

FIG. 94 is a cross-sectional view of the shell in an embodiment in which the blade holder is molded separately from the shell and is affixed to the shell;

FIG. 95 is a perspective view of the blade holder in an embodiment in which the blade holder is formed separately from the shell of the skate boot;

FIGS. 96 and 97 show an example of a variant in which the shell and/or the blade holder comprises one or more inserts over which a subshell is molded;

FIGS. 98 to 103 show an embodiment of a tendon guard connected to lacing members;

FIGS. 104 to 109 show variants of the tendon guard and the lacing members;

FIGS. 110 to 113 show examples of variants in which the tendon guard is overmolded on the shell;

FIG. 115 shows an example of a variant in which one or more of the subshells comprises a thermoformable memory-shape material;

FIG. 116 shows an example of a variant in which the skate boot comprises a toe cap and a graphic element occupying a significant portion of a surface of the toe cap;

FIG. 117 shows an example of a test for determining the stiffness of a part of a subshell;

FIGS. 118A and 118B show a side view and a rear view of a sleeve attached to the skate;

FIGS. 119A and 119B show a side view and a rear view of the sleeve;

FIG. 120 shows a lacing actuator of the sleeve;

FIGS. 121 to 125 show examples of variants in which the footwear is a ski boot, a work boot, a snowboard boot, a sport cleat or a hunting boot; and

FIGS. 126 and 127 are side and front views of a right foot of the skater with an integument of the foot shown in dotted lines and bones shown in solid lines.

In the drawings, embodiments are illustrated by way of example. It is to be expressly understood that the description and drawings are only for purposes of illustration and as an aid to understanding and are not intended to be and should not be limitative.

### DETAILED DESCRIPTION OF EMBODIMENTS

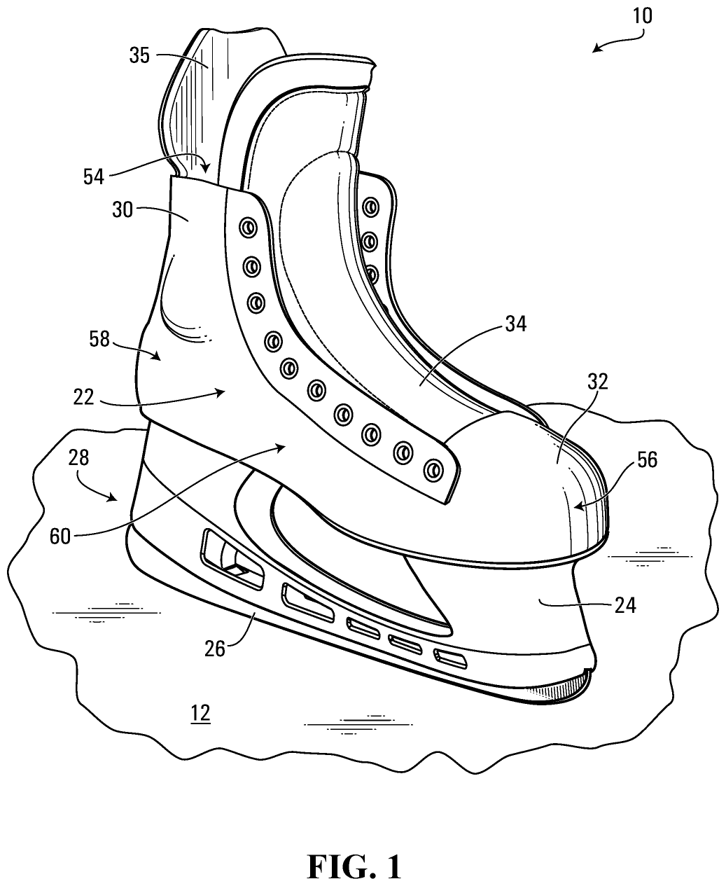

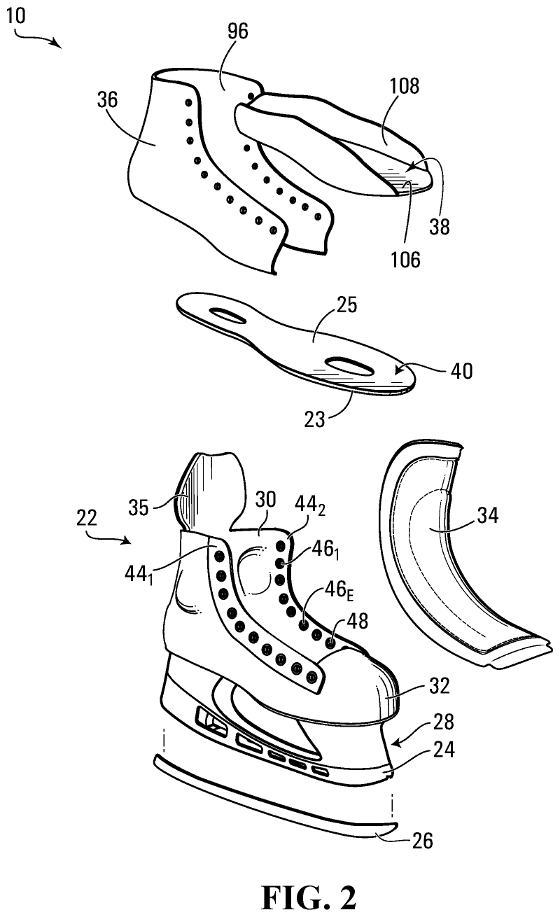

FIGS. 1 and 2 show an example of an embodiment of footwear 10 for a user. In this embodiment, the footwear 10 is a skate for the user to skate on a skating surface 12. More particularly, in this embodiment, the skate 10 is a hockey skate for the user who is a hockey player playing hockey. In this example, the skate 10 is an ice skate, a type of hockey played is ice hockey, and the skating surface 12 is ice.

The skate 10 comprises a skate boot 22 for receiving a foot 11 of the player and a skating device 28 disposed beneath the skate boot 22 to engage the skating surface 12. In this embodiment, the skating device 28 comprises a blade 26 for contacting the ice 12 and a blade holder 24 between the skate boot 22 and the blade 26. The skate 10 has a longitudinal direction, a widthwise direction, and a heightwise direction.

In this embodiment, as further discussed below, the skate 10, including at least part of the skate boot 22 and possibly at least part of one or more other components (e.g., the blade holder 24), may be constructed from one or more materials (e.g., foams) molded by flowing in molding equipment during a molding process (e.g., injection molding or casting). This may allow the skate 10 to have useful performance characteristics (e.g., reduced weight, proper fit and comfort, etc.) while being more cost-effectively manufactured. Also, the skate 10 may facilitate installation and removal of the blade 26 and/or the blade holder 24, such as for replacement of the blade 26 and/or the blade holder 24, assemblage of the skate 10, and/or other purposes. For example, in some embodiments, the skate boot 22 and the blade holder 24 may be at least partly formed integrally with one another (e.g., by injection molding or other material flow), while the blade 26 may be readily attachable to and detachable from the blade holder 24. In some embodiments, one or more parts of the skate boot 22 may be reinforced to enhance impact resistance, durability, and/or other aspects thereof. Furthermore, the skate boot 22 may be customized by being thermoformed on the player's foot 11 more efficiently.

The skate boot 22 is a foot-receiving structure defining a cavity 54 for receiving the player's foot 11. With additional reference to FIGS. 197 and 198, the player's foot 11 includes toes T, a ball B, an arch ARC, a plantar surface PS, a top surface TS, a medial side MS, and a lateral side LS. The top surface TS of the player's foot 11 is continuous with a lower portion of a shin S of the player. In addition, the player has a heel HL, an Achilles tendon AT, and an ankle A having a medial malleolus MM and a lateral malleolus LM that is at a lower position than the medial malleolus MM. The Achilles tendon AT has an upper part UP and a lower part LP projecting outwardly with relation to the upper part UP and merging with the heel HL. A forefoot of the player includes the toes T and the ball B, a hindfoot of the player includes the heel HL, and a midfoot of the player is between the forefoot and the hindfoot.

The skate boot 22 comprises a front portion 56 for receiving the toes T of the player, a rear portion 58 for receiving the heel HL and at least part of the Achilles tendon AT and the ankle A of the player, and an intermediate portion 60 between the front portion 56 and the rear portion 58.

More particularly, in this embodiment, the skate boot 22 comprises a body 30, a toe cap 32, a tongue 34, a tendon guard 35, a liner 36, a footbed 38, and an insole 40. The skate boot 22 also comprises a lacing system 43, which in this embodiment includes lacing members 44₁, 44₂ and eyelets 46₁-46_{E} extending through (e.g., punched into) the lacing members 44₁, 44₂, the body 30 and the liner 36 vis-à-vis apertures 48, in order to receive a lace for tying on the skate 10. In some embodiments, the skate boot 22 may not comprise any lacing members and the eyelets 46₁-46_{E} may extend directly through the body 30 and the liner 36 via the apertures 48.

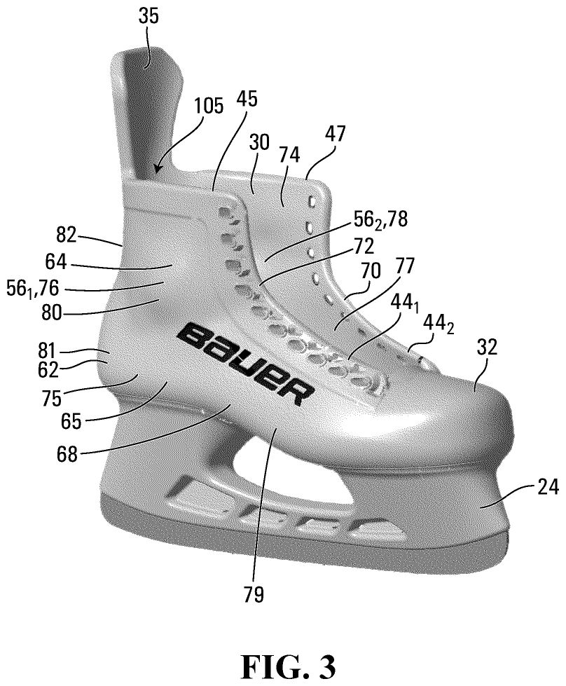

The body 30 of the skate boot 22 imparts strength and structural integrity to the skate 10 to support the player's foot 11. More particularly, in this embodiment, as shown in FIG. 3, the body 30 of the skate boot 22, which will be referred to as a “shell”, comprises a heel portion 62 for receiving the heel HL of the player, an ankle portion 64 for receiving the ankle A of the player, medial and lateral side portions 66, 68 for respectively facing the medial and lateral sides MS, LS of the player's foot 11, and a sole portion 69 for facing the plantar surface PS of the player's foot 11. The shell 30 thus includes a quarter 75 which comprises a medial quarter part 77, a lateral quarter part 79, and a heel counter 81. The medial and lateral side portions 66, 68 include upper edges 70, 72 which, in this embodiment, constitute upper edges of the lace members 44₁, 44₂ (i.e., the lace members 44₁, 44₂ are made integrally with the shell as will be described later). The heel portion 62 may be formed such that it is substantially cup-shaped for following the contour of the heel HL of the player. The ankle portion 64 comprises medial and lateral ankle portions 74, 76 to face medial and lateral sides of the player's ankle A. The medial ankle portion 74 has a medial depression 78 for receiving the medial malleolus MM of the player and the lateral ankle portion 76 has a lateral depression 80 for receiving the lateral malleolus LM of the player. The lateral depression 80 is located slightly lower than the medial depression 78 for conforming to the morphology of the player's foot 11. The ankle portion 64 further comprises a rear ankle portion 82 facing the lower part LP of the Achilles tendon AT of the player.

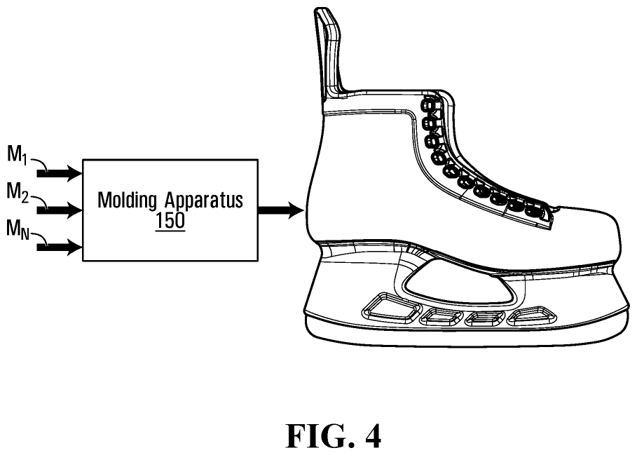

In this embodiment, with additional reference to FIG. 4, the shell 30 comprises one or more materials molded into a shape of the shell 30 by flowing in a molding apparatus 150 during a molding process (e.g., injection molding or casting). More particularly, in this embodiment, the shell 30 comprises a plurality of materials M₁-M_{N} that are molded into the shape of the shell 30 by flowing in the molding apparatus 150 during the molding process. The materials M₁-M_{N} are different from one another, such as by having different chemistries and/or exhibiting substantially different values of one or more material properties (e.g., density, modulus of elasticity, hardness, etc.). In this example, the materials M₁-M_{N} are arranged such that the shell 30 comprises a plurality of layers 85₁-85_{L} which are made of respective ones of the materials M₁-M_{N}. In that sense, in this case, the shell 30 may be referred to as a “multilayer” shell and the layers 85₁-85_{L} of the shell 30 may be referred to as “subshells”. This may allow the skate 10 to have useful performance characteristics (e.g., reduced weight, proper fit and comfort, etc.) while being more cost-effectively manufactured.

The materials M₁-M_{N} may be implemented in any suitable way. In this embodiment, each of the materials M₁-M_{N} is a polymeric material. For example, in this embodiment, each of the polymeric materials M₁-M_{N} is polyurethane (PU). Any other suitable polymer may be used in other embodiments (e.g., polypropylene, ethylene-vinyl acetate (EVA), nylon, polyester, vinyl, polyvinyl chloride, polycarbonate, polyethylene, an ionomer resin (e.g., Surlyn®), styrene-butadiene copolymer (e.g., K-Resin®) etc.), self-reinforced polypropylene composite (e.g., Curv®), or any other thermoplastic or thermosetting polymer).

In this example of implementation, each of the polymeric materials M₁-M_{N} is a foam. In this case, each of the polymeric materials M₁-M_{N} is a PU foam. This foamed aspect may allow the shell 30 to be relatively light while providing strength. For instance, in some embodiments, a density of each of the polymeric materials M₁-M_{N} may be no more than 40 kg/m³, in some cases no more than 30 kg/m³, in some cases no more than 20 kg/m³, in some cases no more than 15 kg/m³, in some cases no more 10 kg/m³ and in some cases even less. One or more of the polymeric materials M₁-M_{N} may not be foam in other examples of implementation.

In this embodiment, the materials M₁-M_{N} of the subshells 85₁-85_{L} of the shell 30 constitute at least part of the heel portion 62, the ankle portion 64, the medial and lateral side portions 66, 68, and the sole portion 69 of the shell 30. More particularly, in this embodiment, the materials M₁-M_{N} constitute at least a majority (i.e., a majority or an entirety) of the heel portion 62, the ankle portion 64, the medial and lateral side portions 66, 68, and the sole portion 69 of the shell 30. In this example, the materials M₁-M_{N} constitute the entirety of the heel portion 62, the ankle portion 64, the medial and lateral side portions 66, 68, and the sole portion 69 of the shell 30.

The subshells 85₁-85_{L} constituted by the polymeric materials M₁-M_{N} may have different properties for different purposes.

For instance, in some cases, a polymeric material Mₓ may be stiffer than a polymeric material M_{y} such that a subshell comprising the polymeric material Mₓ is stiffer than a subshell comprising the polymeric material M_{y}. For example, a ratio of a stiffness of the subshell comprising the polymeric material Mₓ over a stiffness of the subshell comprising the polymeric material M_{y} may be at least 1.5, in some cases at least 2, in some cases at least 2.5, in some cases 3, in some cases 4 and in some cases even more.

In some cases, a given one of the subshells 85₁-85_{L} may be configured to be harder than another one of the subshells 85₁-85_{L}. For instance, to provide a given subshell with more hardness than another subshell, the hardness of the polymeric materials M₁-M_{N} may vary. For example, a hardness of the polymeric material Mₓ may be greater than a hardness of the polymeric material M_{y}. For example, in some cases, a ratio of the hardness of the polymeric material Mₓ over the hardness of the polymeric material M_{y} may be at least 1.5, in some cases at least 2, in some cases at least 2.5, in some cases at least 3, in some cases at least 4, in some cases at least 5 and in some cases even more.

To observe the stiffness of a subshell 85ₓ, as shown in FIG. 117, a part of the subshell 85ₓ can be isolated from the remainder of the subshell 85ₓ (e.g., by cutting, or otherwise removing the part from the subshell 85ₓ, or by producing the part without the remainder of the subshell 85ₓ) and a three-point bending test can be performed on the part to subject it to loading tending to bend the part in specified ways (along a defined direction of the part if the part is anisotropic) to observe the rigidity of the part and measure parameters indicative of the rigidity of the part. For instance in some embodiments, the three-point bending test may be based on conditions defined in a standard test (e.g., ISO 178(2010)).

For example, to observe the rigidity of the subshell 85ₓ, the three-point bending test may be performed to subject the subshell 85ₓ to loading tending to bend the subshell 85ₓ until a predetermined deflection of the subshell 85ₓ is reached and measure a bending load at that predetermined deflection of the subshell 85ₓ. The predetermined deflection of the subshell 85ₓ may be selected such as to correspond to a predetermined strain of the subshell 85ₓ at a specified point of the subshell 85ₓ (e.g., a point of an inner surface of the subshell 85ₓ). For instance, in some embodiments, the predetermined strain of the subshell 85ₓ may be between 3% and 5%. The bending load at the predetermined deflection of the subshell 85ₓ may be used to calculate a bending stress at the specified point of the subshell 85ₓ. The bending stress at the specified point of the subshell 85ₓ may be calculated as σ=My/l, where M is the moment about a neutral axis of the subshell 85ₓ caused by the bending load, y is the perpendicular distance from the specified point of the subshell 85ₓ to the neutral axis of the subshell 85ₓ, and I is the second moment of area about the neutral axis of the subshell 85ₓ. The rigidity of the subshell 85ₓ can be taken as the bending stress at the predetermined strain (i.e., at the predetermined deflection) of the subshell 85ₓ. Alternatively, the rigidity of the subshell 85ₓ may be taken as the bending load at the predetermined deflection of the subshell 85ₓ.

A stiffness of the subshells 85₁-85_{L} may be related to a modulus of elasticity (i.e., Young's modulus) of the polymeric materials M₁-M_{N} associated therewith. For example, to provide a given subshell with more stiffness than another subshell, the modulus of elasticity of the polymeric materials M₁-M_{N} may vary. For instance, in some embodiments, the modulus of elasticity of the polymeric material Mₓ may be greater than the modulus of elasticity of the polymeric material M_{y}. For example, in some cases, a ratio of the modulus of elasticity of the polymeric material Mₓ over the modulus of elasticity of the polymeric material M_{y} may be at least 1.5, in some cases at least 2, in some cases at least 2.5, in some cases at least 3, in some cases at least 4, in some cases at least 5 and in some cases even more. This ratio may have any other suitable value in other embodiments.

In some cases, a given one of the subshells 85₁-85_{L} may be configured to be denser than another one of the subshells 85₁-85_{L}. For instance, to provide a given subshell with more density than another subshell, the density of the polymeric materials M₁-M_{N} may vary. For instance, in some embodiments, the polymeric material Mₓ may have a density that is greater than a density of the polymeric material M_{y}. For example, in some cases, a ratio of the density of the material Mₓ over the density of the material M_{y} may be at least 1.1, in some cases at least 1.5, in some cases at least 2, in some cases at least 2.5, in some cases at least 3 and in some cases even more.

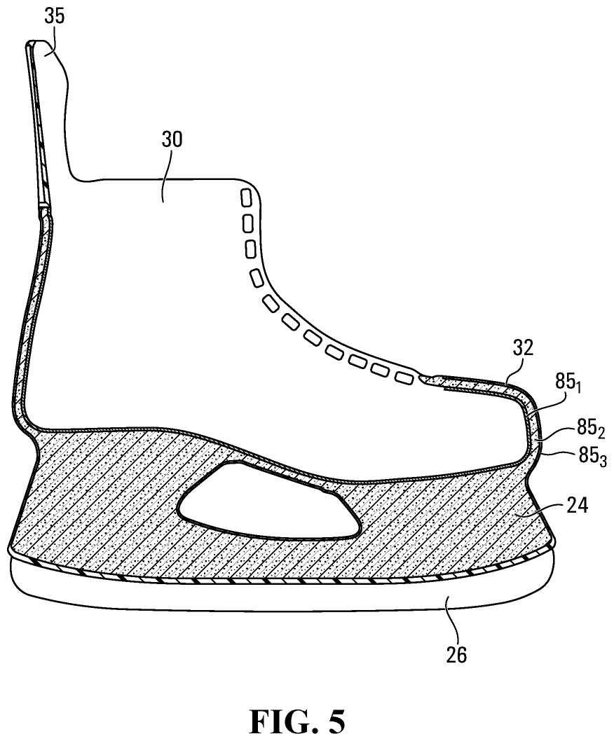

In this embodiment, as shown in FIG. 5, the subshells 85₁-85_{L} comprise an internal subshell 85₁, an intermediate subshell 85₂ and an external subshell 85₃. The internal subshell 85₁ is “internal” in that it is an innermost one of the subshells 85₁-85_{L}. That is, the internal subshell 85₁ is closest to the player's foot 11 when the player dons the skate 10. In a similar manner, the external subshell 85₃ is “external” in that is an outermost one of the subshells 85₁-85_{L}. That is, the external subshell 85₃ is furthest from the player's foot 11 when the player dons the skate 10. The intermediate subshell 85₂ is disposed between the internal and external subshells 85₁, 85₃.

The internal, intermediate and external subshells 85₁, 85₂, 85₃ comprise respective polymeric materials M₁, M₂, M₃. In this embodiment, the polymeric materials M₁, M₂, M₃ have different material properties that impart different characteristics to the internal, intermediate and external subshells 85₁, 85₂, 85₃. As a result, in certain cases, a given one of the subshells 85₁, 85₂, 85₃ may be more resistant to impact than another one of the subshells 85₁, 85₂, 85₃, a given one of the subshells 85₁, 85₂, 85₃ may be more resistant to wear than another one of the subshells 85₁, 85₂, 85₃, and/or a given one of the subshells 85₁, 85₂, 85₃ may be denser than another one of the subshells 85₁, 85₂, 85₃.

For instance, a density of each of the internal, intermediate and external subshells 85₁, 85₂, 85₃ may vary. For example, in this embodiment, the densities of the internal, intermediate and external subshells 85₁, 85₂, 85₃ increase inwardly such that the density of the internal subshell 85₁ is greater than the density of the intermediate subshell 85₂ which in turn is greater than the density of the external subshell 85₃. For example, the density of the internal subshell 85₁ may be approximately 30 kg/m³, while the density of the intermediate subshell 85₂ may be approximately 20 kg/m³, and the density of the external subshell 85₃ may be approximately 10 kg/m³. The densities of the internal, intermediate and external subshells 85₁, 85₂, 85₃ may have any other suitable values in other embodiments. In other embodiments, the densities of the internal, intermediate and external subshells 85₁, 85₂, 85₃ may increase outwardly such that the external subshell 85₃ is the densest of the subshells 85₁-85_{L}. In yet other embodiments, the densities of the internal, intermediate and external subshells 85₁, 85₂, 85₃ may not be arranged in order of ascending or descending density.

Moreover, in this embodiment, a stiffness of the internal, intermediate and external subshells 85₁, 85₂, 85₃ may vary. For example, in this embodiment, the stiffness of the internal subshell 85₁ is greater than the respective stiffness of each of the intermediate subshell 85₂ and the external subshell 85₃.

In addition, in this embodiment, a thickness of the internal, intermediate and external subshells 85₁, 85₂, 85₃ may vary. For example, in this embodiment, the intermediate subshell 85₂ has a thickness that is greater than a respective thickness of each of the internal and external subshells 85₁, 85₃. For example, in some cases, the thickness of each of the internal, intermediate and external subshells 85₁, 85₂, 85₃ may be between 0.1 mm to 25 mm, and in some cases between 0.5 mm to 10 mm. For instance, the thickness of each of the internal, intermediate and external subshells 85₁, 85₂, 85₃ may be no more than 30 mm, in some cases no more than 25 mm, in some cases no more than 15 mm, in some cases no more than 10 mm, in some cases no more than 5 mm, in some cases no more than 1 mm, in some cases no more than 0.5 mm, in some cases no more than 0.1 mm and in some cases even less.

In order to provide the internal, intermediate and external subshells 85₁, 85₂, 85₃ with their different characteristics, the polymeric materials M₁, M₂, M₃ of the internal, intermediate and external subshells 85₁, 85₂, 85₃ may comprise different types of polymeric materials. For instance, in this example, the polymeric material M₁ comprises a generally soft and dense foam, the polymeric material M₂ comprises a structural foam that is more rigid than the foam of the polymeric material M₁ and less dense than the polymeric material M₁, and the polymeric material M₃ is a material other than foam. For example, the polymeric material M₃ of the external subshell 85₃ may consist of a clear polymeric coating.

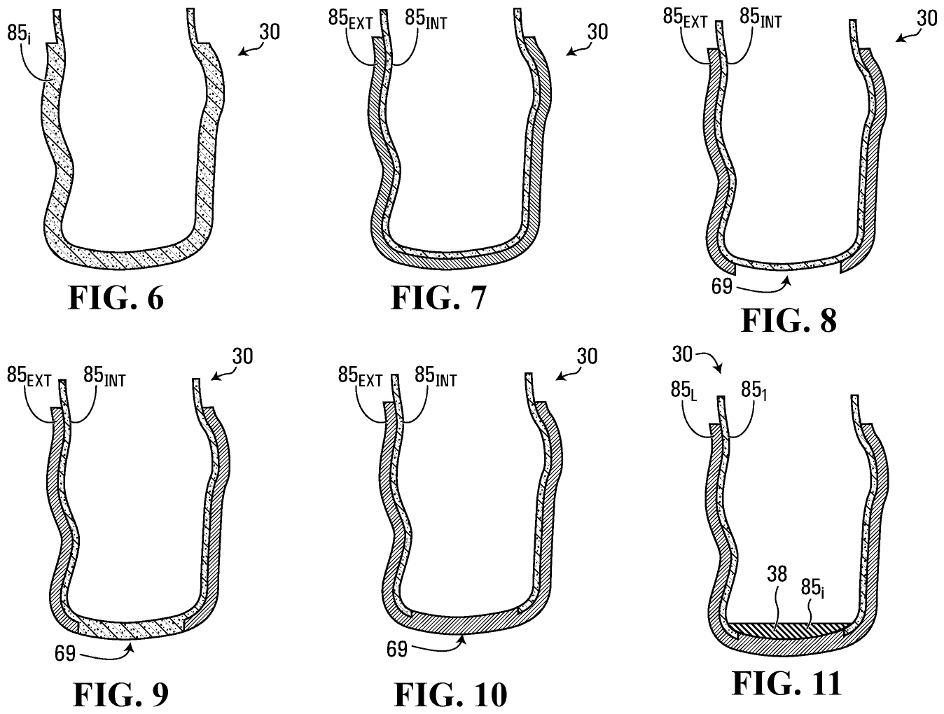

The subshells 85₁-85_{L} may be configured in various other ways in other embodiments. For instance, in other embodiments, the shell 30 may comprise a different number of subshells or no subshells. For example, in some embodiments, as shown in FIG. 6, the shell 30 may be a single shell and therefore does not comprise any subshells. In other embodiments, as shown in FIG. 7, the shell 30 may comprise two subshells 85₁-85_{L}.

Moreover, as shown in FIGS. 8 to 10, when the shell 30 comprises two subshells, notably interior and exterior subshells 85_{INT}, 85_{EXT}, if the exterior subshell 85_{EXT} has a density that is greater than a density of the interior subshell 85_{INT}, a given one of the subshells 85_{INT}, 85_{EXT} may have an opening, which can be referred to as a gap, along at least part of the sole portion 69 of the shell 30 (e.g., along a majority of the sole portion 69 of the shell 30). For example, as shown in FIG. 8, in some embodiments, the exterior subshell 85_{EXT} may comprise a gap G at the sole portion 69 of the shell 30 such that the interior and exterior subshells 85_{INT}, 85_{EXT} do not overlie one another at the sole portion 69 of the shell 30 (i.e., the interior subshell 85_{INT} may be the only subshell present at the sole portion 69 of the shell 30). As shown in FIG. 9, in an embodiment in which the exterior subshell 85_{EXT} has a gap at the sole portion 69 of the shell 30, the interior subshell 85_{INT} may project outwardly toward the exterior subshell 85_{EXT} at the sole portion 69 of the shell 30 and fill in the gap of the exterior subshell 85_{EXT} such that a thickness of the interior subshell 85_{INT} is greater at the sole portion 69 of the shell 30. As another example, as shown in FIG. 10, in an embodiment in which the interior subshell 85_{INT} has a gap at the sole portion 69 of the shell 30, the exterior subshell 85_{EXT} may project inwardly toward the interior subshell 85_{INT} at the sole portion 69 of the shell 30 and fill in the gap of the interior subshell 85_{INT} such that a thickness of the exterior subshell 85_{EXT} is greater at the sole portion 69 of the shell 30. As shown in FIG. 11, the footbed 38 may be formed integrally with the shell 30 such as to cover at least partially an inner surface of the innermost subshell (in this case, the interior subshell 85_{INT}) and overlie the sole portion 69 of the shell 30. In other cases, the footbed 38 may be inserted separately after the molding process of the shell 30 has been completed.

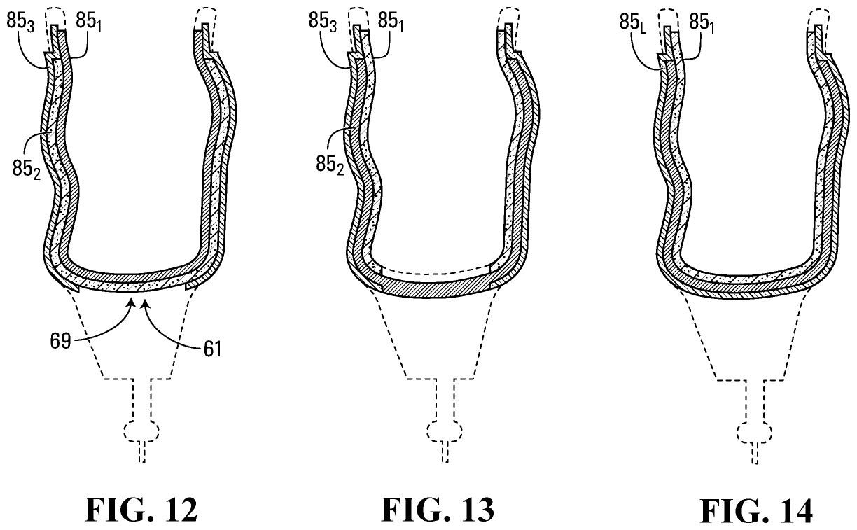

In some embodiments, as shown in FIGS. 12 and 13, when the shell 30 comprises three subshells, notably the internal, intermediate and external subshells 85₁, 85₂, 85₃, and the external subshell 85₃ has a density that is greater than a density of the intermediate subshell 85₂, the external subshell 85₃ may comprise a gap 61 at the sole portion 69 of the shell 30 and the intermediate subshell 85₂ may project into the external subshell 85₃ at the sole portion 69 of the shell 30 such as to fill in the gap 61 of the external subshell 85₃. In such embodiments, the intermediate subshell 85₂ may have a greater thickness at the sole portion 69 of the shell 30.

In some embodiments, as shown in FIG. 14, the subshells 85₁-85_{L} of the shell 30 may include four subshells 85₁, 85₂, 85₃, 85₄.

In this embodiment, the subshells 85₁-85_{L} constituted by the polymeric materials M₁-M_{N} are integral with one another such that they constitute a monolithic one-piece structure. That is, the subshells 85₁-85_{L} constituted by the polymeric materials M₁-M_{N} are integrally connected to one another such that the shell 30 is a one-piece shell. In this example of implementation, this is achieved by the subshells 85₁-85_{L} bonding to one another in the molding apparatus 150 during the molding process by virtue of chemical bonding of the polymeric materials M₁-M_{N}.

The subshells 85₁-85_{L} constituted by the polymeric materials M₁-M_{N} are molded into the shape of the shell 30 by flowing into the molding apparatus 150 during the molding process. In this embodiment, the molding process comprises causing the polymeric materials M₁-M_{N} to flow (i.e., in liquid or other fluid form) in the molding apparatus 150 so as to form the subshells 85₁-85_{L} and thus the shell 30 within the molding apparatus 150 and recovering the shell 30 from the molding apparatus 150 once its molding is completed.

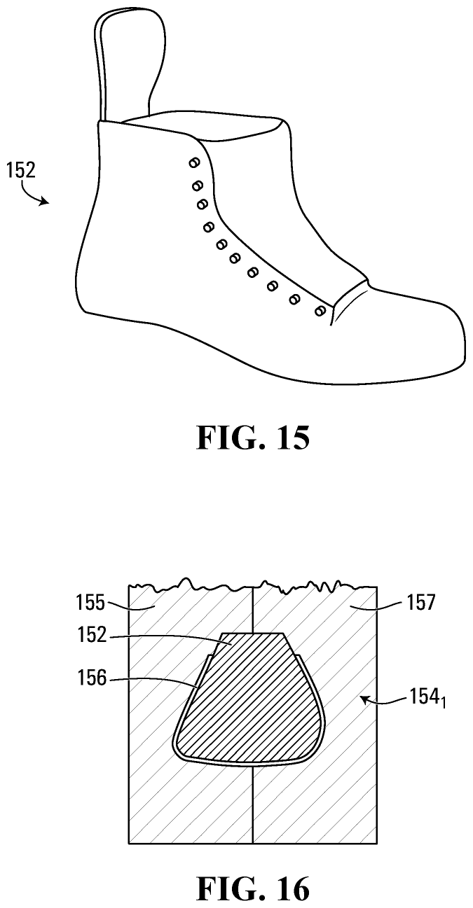

In this embodiment, the molding process of the shell 30 is injection molding and the molding apparatus 150 comprises a male mold 152 (also commonly referred to as a “last”) with which all the polymeric materials M₁-M_{N} are molded into shape, as shown in FIG. 15. That is, in this example, the last 152 is a single last with which all of the subshells 85₁-85_{L} of the shell 30 are formed. The molding apparatus 150 also comprises a plurality of female molds 154₁-154_{N}, each female mold 154i being configured to contain the last 152 at different stages of the molding process. In this embodiment, each female mold 154ᵢ comprises first and second portions 155, 157 that are secured together to contain the last 152.

An example of a method for molding the shell 30 comprising the internal, intermediate and external subshells 85₁, 85₂, 85₃ will be described in more detail below with reference to FIGS. 16 to 18.

With additional reference to FIG. 16, in order to mold the internal subshell 85₁, the last 152 is secured within a first female mold 154₁ to form a mold cavity 156 between the last 152 and the first female mold 154₁. The mold cavity 156 has a shape of the desired internal subshell 85₁. The mold cavity 156 is then filled with a desired polymeric material M₁ via a sprue, runner and gate system (not shown) of the first female mold 154₁ and left to cure. Once the polymeric material M₁ has cured for a sufficient amount of time to form the internal subshell 85₁, the first female mold 154₁ is opened (i.e., its first and second portions 155, 157 are separated from one another) and removed from the molding apparatus 150 while the last 152 remains on the molding apparatus 150 with the internal subshell 85₁ still on it.

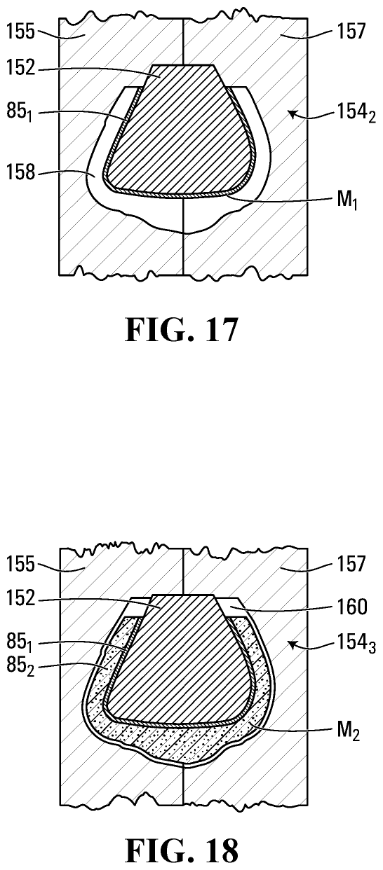

At this stage, with additional reference to FIG. 17, in order to form the intermediate subshell 85₂, a second female mold 154₂ is installed on the molding apparatus 150. The last 152 is secured within the second female mold 154₂ to form a mold cavity 158 between the internal subshell 85₁ (and in some cases at least part of the last 152) and the second female mold 154₂. The mold cavity 158 has a shape of the desired intermediate subshell 85₂. The mold cavity 158 is then filled with a desired polymeric material M₂ via a sprue, runner and gate system (not shown) of the second female mold 154₂ and left to cure. Once the polymeric material M₂ has cured for a sufficient amount of time to form the intermediate subshell 85₂, the second female mold 154₂ is opened (i.e., its first and second portions 155, 157 are separated from one another) and removed from the molding apparatus 150 while the last 152 remains on the molding apparatus 150 with the internal subshell 85₁ and the intermediate subshell 85₂ still on it.

With additional reference to FIG. 18, in order to form the external subshell 85₃, a third female mold 154₃ is installed on the molding apparatus 150. The last 152 is secured within the third female mold 154₃ to form a mold cavity 160 between the intermediate subshell 85₂ (and in some cases at least part of the last 152, and in some cases at least part of the internal subshell 85₁) and the third female mold 154₃. The mold cavity 160 has a shape of the desired external subshell 85₃. The mold cavity 160 is then filled with a desired polymeric material M₃ via a sprue, runner and gate system (not shown) of the third female mold 154₃ and left to cure.

Once the polymeric material M₃ has cured for a sufficient amount of time to form the external subshell 85₃, the shell 30, including its now formed internal, intermediate and external subshells 85₁, 85₂, 85₃, is demolded from (i.e., removed from) the last 152. This may be achieved in various ways.

For instance, in some embodiments, the polymeric materials M₁, M₂, M₃ which constitute the internal, intermediate and external subshells 85₁, 85₂, 85₃ may have sufficient elasticity to allow an operator of the molding apparatus 150 to remove the shell 30 from the last 152 by flexing the internal, intermediate and external subshells 85₁, 85₂, 85₃ of the shell 30. In some cases, the shell 30 may be removed from the last 152 while at least a given one of the internal, intermediate and external subshells 85₁, 85₂, 85₃ has not fully cured such that the shell 30 has some flexibility that it would not have if the at least one given one of the internal, intermediate and external subshells 85₁, 85₂, 85₃ had fully cured.

Moreover, in some embodiments, the last 152 may be reconfigurable to facilitate demolding (i.e., removal) of the shell 30 from the last 152. That is, a configuration (e.g., shape) of the last 152 may be changeable between a “molding” configuration to mold the shell 30 on the last 152 and a “demolding” configuration to demold the shell 30 from the last 152. The demolding configuration of the last 152 differs from the molding configuration of the last 152, notably in that demolding of the shell 30 from the last 152 is easier in the demolding configuration of the last 152 than in the molding configuration of the last 152 (e.g., less effort has to be exerted on the shell 30 to remove the shell 30 from the last 152 in its demolding configuration than in its molding configuration, or removal of the shell 30 from the last 152 in its demolding configuration is readily allowed while removal of the shell 30 from the last 152 in its molding configuration is precluded without damaging the shell 30). For example, the last 152 may contract (i.e., be reduced in size) in its demolding configuration relative to its molding configuration. Removal of the shell 30 from the last 152, which may be by holding the shell 30 to move it away from the last 152 and/or holding and moving at least part of the last 152 away from the shell 30, is thus facilitated. Further information about the last 152 which may be reconfigurable can be obtained from U.S. Patent Application Publication No. 2021/0206130A1, which is incorporated by reference herein.

While the molding process has been described as being performed on a single molding apparatus 150, in some embodiments, the molding process may utilize various molding apparatuses (e.g., molding stations), each apparatus comprising a different female mold 154ᵢ. In such embodiments, the last 152, still mounted with at least one subshell 85ᵢ, can be moved from one molding station to the next without requiring removal of the female molds installed on the various molding apparatuses. In some embodiments, molding stations may be horizontally distributed (e.g., linearly and/or in a carrousel or other rotary or otherwise curved arrangement). In other embodiments, molding stations may be vertically distributed such as being stacked vertically over one another, which may be more efficient space-wise.

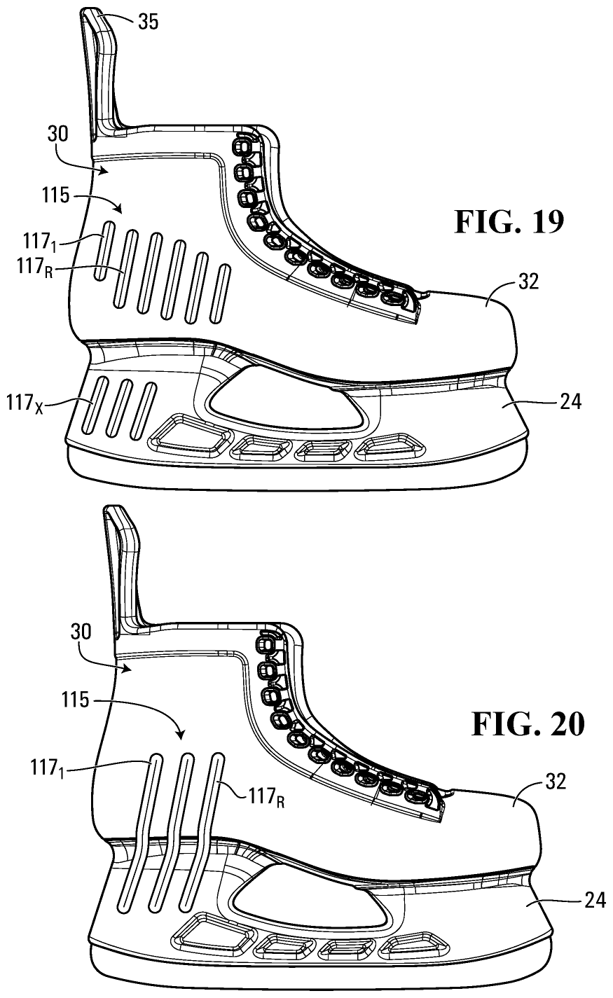

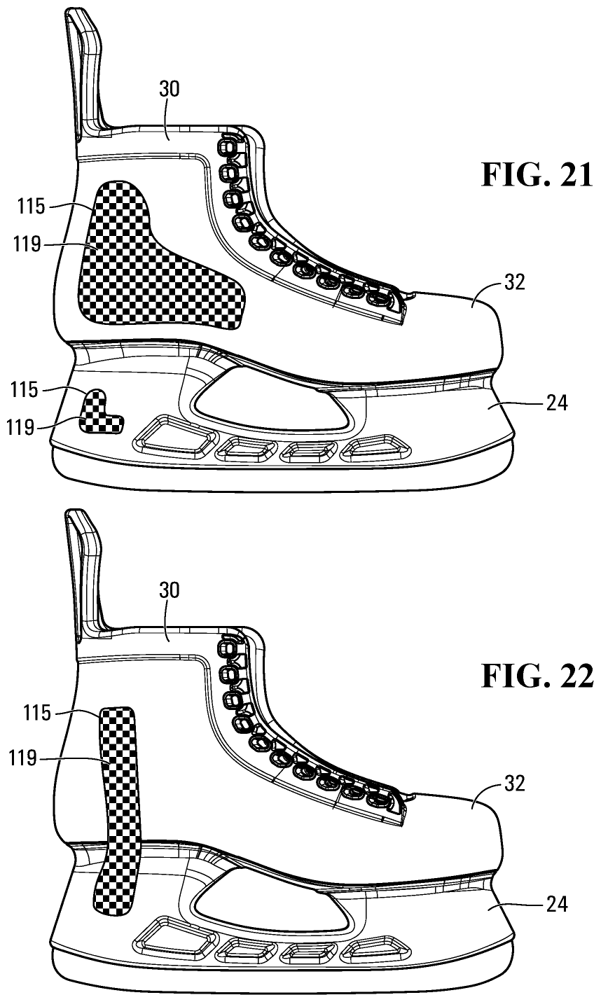

With additional reference to FIGS. 19 and 20, in some embodiments, the shell 30 may comprise a reinforcement 115 disposed between certain ones of the subshells 85₁-85_{L} of the shell 30 such as, for example, between the intermediate and external subshells 85₂, 85₃. The reinforcement 115 is produced separately from the shell 30 and is configured to reinforce selected areas of the shell 30 (e.g., the medial and/or lateral side portions 66, 68 of the shell 30) such as, for example, to make it stronger or stiffer (e.g., increase resistance to deflection or impacts). In order to include the reinforcement 115 between the intermediate and external subshells 85₂, 85₃, the reinforcement 115 is affixed to an exterior surface of the intermediate subshell 85₂ after forming the intermediate subshell 85₂ and prior to forming the external subshell 85₃. For instance, the reinforcement 115 may be mechanically affixed (e.g., stapled, stitched, etc.), glued (e.g., via an adhesive), ultrasonically bonded, or affixed in any other suitable way to the exterior surface of the intermediate subshell 85₂.

The reinforcement 115 may be configured in any suitable way. For instance, as shown in FIG. 19, the reinforcement 115 may comprise a plurality of ribs 117₁-117_{R} (or a single rib 117ᵢ) which project outwardly from the exterior surface of the intermediate subshell 85₂ when the reinforcement 115 is affixed to the intermediate subshell 85₂. Moreover, the ribs 117₁-117_{R} may extend on the shell 30 and/or on the blade holder 24. As shown in FIG. 20, in some embodiments, the ribs 117₁-117_{R} may extend from the shell 30 to the blade holder 24. That is, the ribs 117₁-117_{R} have a vertical extent that spans the blade holder 24 and the shell 30. In other examples, the ribs 117₁-117_{R} may span the blade holder 24, the shell 30 and the lace members 44₁, 44₂. Furthermore, in some cases, the ribs 117₁-117_{R} may not all be disposed between the same subshells. For example, in some cases, a first rib 117ᵢ may be disposed between the intermediate and external subshells 85₂, 85₃ while a second rib 117ⱼ is disposed between the internal and intermediate subshells 85₁, 85₂.

Alternatively, the reinforcement 115 may comprise a reinforcing sheet 119 that is similarly affixed to the exterior surface of the intermediate subshell 85₂ (e.g., glued thereto). In this embodiment, the reinforcing sheet 119 comprises a material that is stiffer and/or harder than the polymeric material M₂ of the intermediate subshell 85₂. For instance, the reinforcing sheet 119 may comprise a composite material comprising thermoset material, thermoplastic material, carbon fibers and/or fiberglass fibers. For example, the composite material may be a fiber-matrix composite material that comprises a matrix in which fibers are embedded. The matrix may include any suitable polymeric resin, such as a thermosetting polymeric material (e.g., polyester, vinyl ester, vinyl ether, polyurethane, epoxy, cyanate ester, etc.), a thermoplastic polymeric material (e.g., polyethylene, polypropylene, acrylic resin, polyether ether ketone, polyethylene terephthalate, polyvinyl chloride, polymethyl methacrylate, polycarbonate, acrylonitrile butadiene styrene, nylon, polyimide, polysulfone, polyamide-imide, self-reinforcing polyphenylene, etc.), or a hybrid thermosetting-thermoplastic polymeric material. The fibers may be made of any suitable material such as carbon fibers, polymeric fibers such as aramid fibers, boron fibers, glass fibers, ceramic fibers, etc.

Furthermore, in some embodiments, the reinforcing sheet 119 may comprise a fabric or textile material. For example, the reinforcing sheet 119 may comprise a fabric mesh such as a nylon mesh or any other suitable fabric material. For example, the reinforcing sheet 119 may envelop the subshell 85ₓ over which it is disposed such as to cover at least a majority (i.e., a majority or an entirety) of an outer surface of that subshell 85ₓ. Moreover, the reinforcing sheet 119 may also cover at least a majority of an internal surface of a subsequent subshell 85_{y} overlying the subshell 85ₓ. Thus, the reinforcing sheet 119 may extend from the lateral side portion 66 to the medial side portion 68 of the shell 30. In other cases, the reinforcing sheet 119 may be disposed at limited portions of the shell 30 (e.g., only the ankle portion 64 of the shell 30).

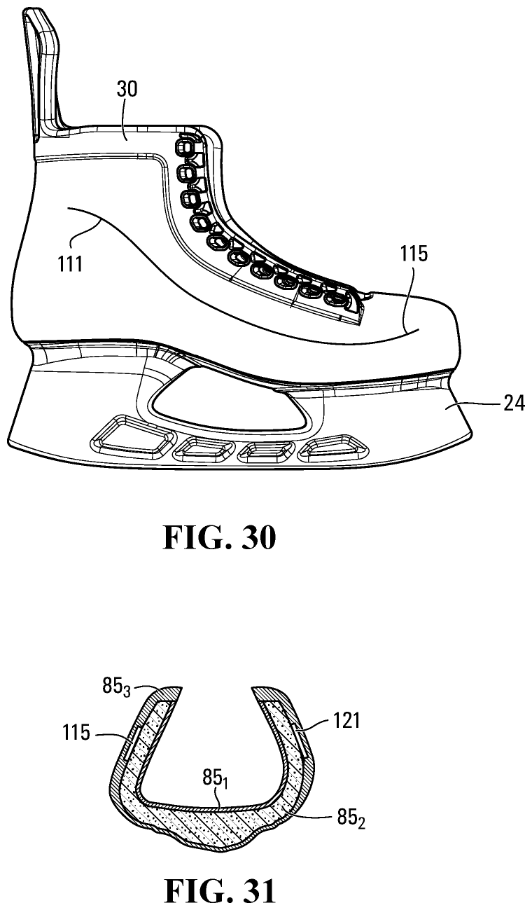

In another example, as shown in FIG. 30, the reinforcement 115 may comprise a single fiber 111 rather than a fabric mesh. The single fiber 111 is configured to apply tension forces on the shell 30 and/or other components of the skate boot 22. In particular, the tension of the single fiber 111 is transmitted onto the shell 30 and thus may allow controlling its performance.

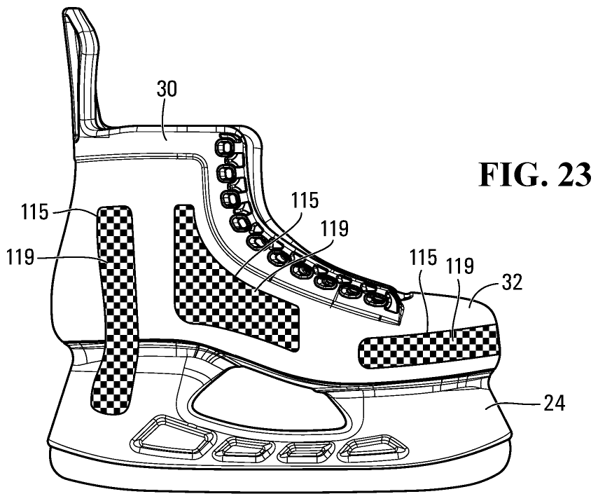

In another example, as shown in FIG. 23, the shell 30 may comprise more than one reinforcements 115₁-115ᵣ disposed between certain ones of the subshells 85₁-85_{L} of the shell 30 and each one of the reinforcements 115₁-115ᵣ may comprise a material that is different from the material of another one of the reinforcements 115₁-115ᵣ. For instance, the materials of different ones of the reinforcements 115₁-115ᵣ may differ in rigidity, in density, etc., such as to provide desired properties to different parts of the skate boot 22 and blade holder 24.

In some embodiments, multiple reinforcements 115 may be included between the subshells 85₁-85_{L} of the shell 30. For instance, a rib 117ᵢ may be disposed at a selected area of the shell 30 while a reinforcing sheet 119 may be disposed at another selected area of the shell 30.

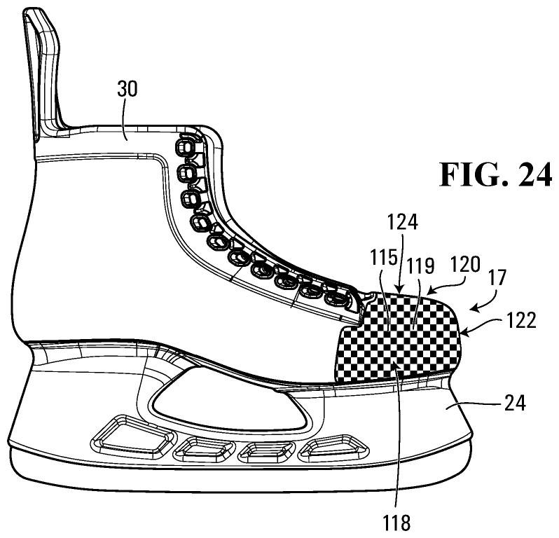

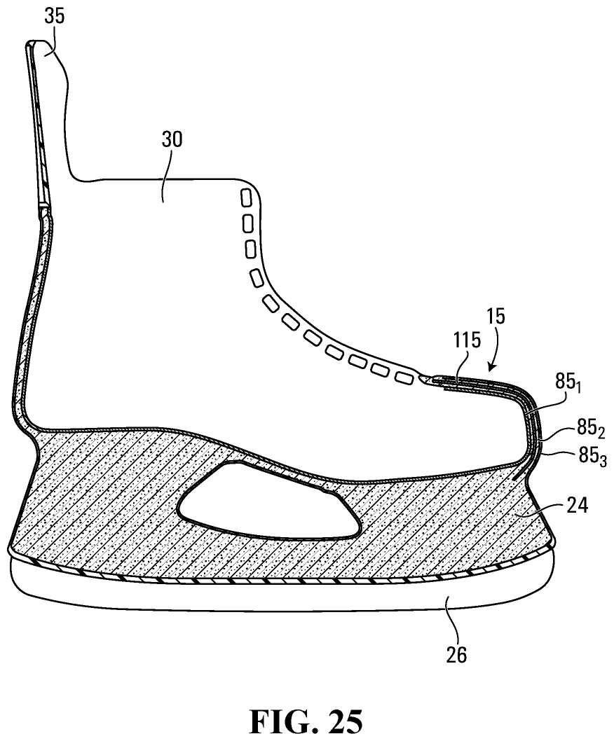

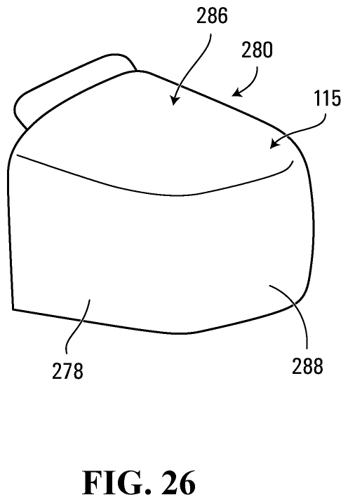

With additional reference to FIGS. 24 to 26, in some embodiments, the reinforcement 115 may be a toe reinforcement affixed to the toe portion 17 of the shell 30 of the skate boot 22 and comprising a lateral side portion 278 configured to face the small toe of the player's foot, a medial side portion 280 configured to face the big toe of the player's foot, an upper portion 286 configured to face the top of the player's toes, and an end portion 288 disposed between the lateral side portion 278 and the medial side portion 280 of the toe reinforcement 115 and extending downwardly from the upper portion 286 of the toe reinforcement 115. Thus, in this embodiment, the lateral side portion 278, the medial side portion 280, the upper portion 286, and the end portion 288 of the toe reinforcement 115 are respectively mounted to the lateral side portion 118, the medial side portion 120, the upper portion 124, and the end portion 122 of the toe portion 17 of the shell 30 of the skate boot 22. This may help to enhance impact resistance of the skate boot 22 where the player's toes are located.

In this embodiment, the toe reinforcement 115 is within the toe portion 15 of the shell 30 of the skate boot 22. That is, the toe reinforcement 115 is located inside or beneath the toe portion 15 of the shell 30 of the skate boot 22. More particularly, in this embodiment, the toe reinforcement 115 is disposed within at least one of the subshells 85₁-85_{L} of the shell 30 of the skate boot 22. Thus, the toe reinforcement 115 is located inside or beneath at least one of the subshells 85₁-85_{L} of the shell 30 of the skate boot 22.

For example, in this embodiment, the toe reinforcement 115 is disposed within a foam one of the subshells 85₁-85_{L} of the shell 30. Notably, in this embodiment, the toe reinforcement 115 is embedded in the foam one of the subshells 85₁-85_{L} as it is injection molded.

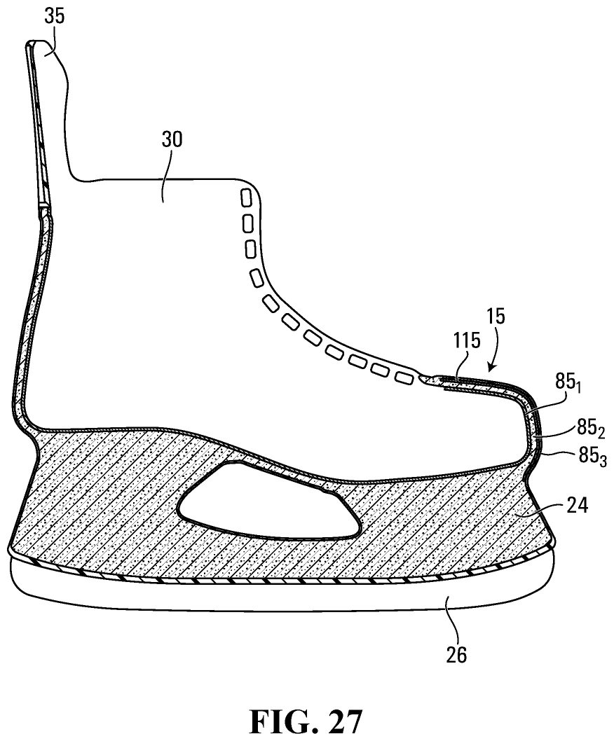

As another example, in some embodiments, as shown in FIG. 27, the toe reinforcement 115 is disposed between respective ones of subshells 85₁-85_{L} of the shell of the skate boot 22. For instance, in this embodiment, the toe reinforcement 115 is disposed between an external one of the subshells 85₁-85_{L} (e.g., the external subshell 85₃) and an inner one of the subshells 85₁-85_{L} (e.g., the internal subshell 85₁ or the intermediate subshell 85₂) that is under the external one of the subshells 85₁-85_{L}. In cases where the external one of the subshells 85₁-85_{L} is clear one of the subshells 85₁-85_{L}, the toe reinforcement 115 may thus be visible through the clear one of the subshells 85₁-85_{L} from outside the skate boot 22.

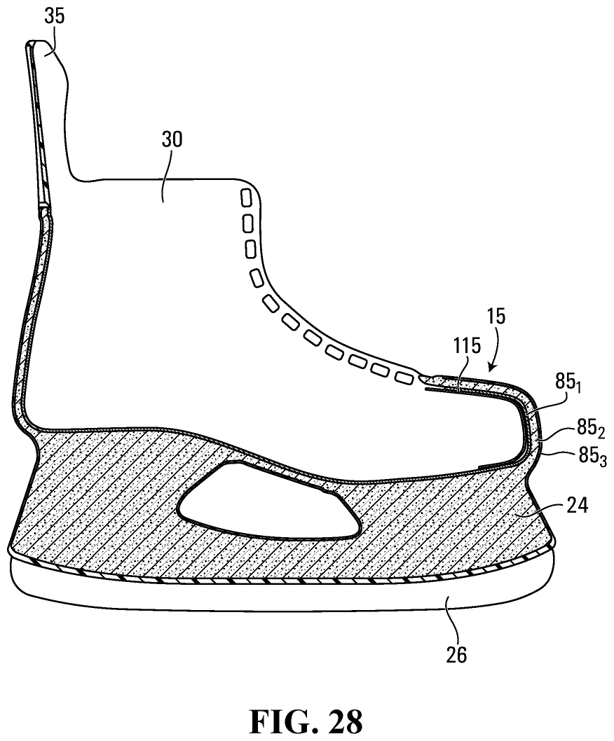

As yet another example, in some embodiments, as shown in FIG. 28, the toe reinforcement 115 is disposed inwardly of the toe portion 15 of the shell 30 of the skate boot 22. In this example, the toe reinforcement 115 is therefore disposed inwardly of all the subshells 85₁-85_{L} of the shell 30. For instance, the toe reinforcement 115 may be disposed between an innermost of the subshells 85₁-85_{L} (e.g., the internal subshell 85₁) and the liner 36 of the skate boot 22. Alternatively, the toe reinforcement 115 may be disposed inwardly of the innermost of the subshells 85₁-85_{L} (e.g., the internal subshell 85₁) and constitute part of the liner 36 of the skate boot 22.

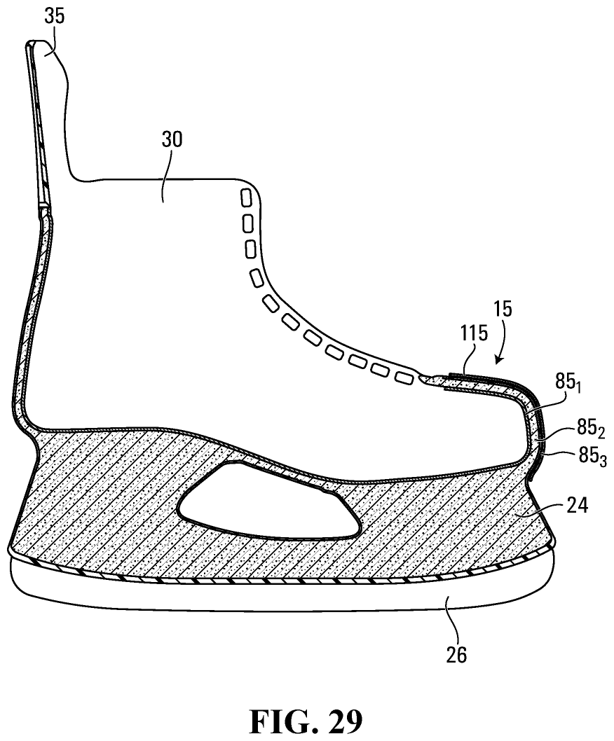

In other embodiments, as shown in FIG. 29, the toe reinforcement 115 may be disposed outwardly of the toe portion 15 of the shell 30 of the skate boot 22. Therefore, in these embodiments, the toe reinforcement 115 is disposed outwardly of the external one of the subshells 85₁-85_{L} (e.g., the external subshell 85₃) of the shell 30 of the skate boot 22.

The toe reinforcement 115 may be implemented in various ways as described herein. For example, as discussed, in various embodiments, the toe reinforcement 115 may comprise: a reinforcing sheet 119, which may include fiber-reinforced composite material, fabric (e.g., mesh, woven, nonwoven, etc.) or any other pliable material that may be bent to form the toe reinforcement 115; a rigid member that may include rigid polymeric material (e.g., that may be fiber-reinforced) that is molded (e.g., thermoformed, injection molded, etc.) to form the toe reinforcement 115 before the toe reinforcement 115 is integrated with the toe portion 15 of the shell 30 of the skate boot 22; etc.

Moreover, in some embodiments, rather than or in addition of the reinforcement 115, the shell 30 may comprise a decoration 121, which can be referred to as a graphical element or design element, disposed between certain ones of the subshells 85₁-85_{L} of the shell 30 such as, for instance, between the intermediate and external subshells 85₂, 85₃ as shown in FIG. 31. The design element 121 constitutes an aesthetic element that is produced separately from the shell 30 and may be included in the shell 30 in order to affect its aesthetic look. For instance, the design element 121 may comprise a piece of material including a graphical representation of: one or more alphanumeric characters that may form text (e.g., a word, a message, etc.); one or more symbols (e.g., a logo, a sign, an emblem, etc.); one or more shapes or patterns; and/or one or more real or imaginary objects (e.g., a person, an animal, a vehicle, an imaginary or fictional character, or any other real or imaginary thing). The design element 121 is affixed to an exterior surface of the intermediate subshell 85₂ after forming the intermediate subshell 85₂ and prior to forming the external subshell 85₃. For instance, the design element 121 may be mechanically affixed (e.g., stapled, stitched, etc.), glued (e.g., via an adhesive), ultrasonically bonded, or affixed in any other suitable way to the exterior surface of the intermediate subshell 85₂. While a single design element 121 is depicted in FIG. 31, the shell 30 may comprise a plurality of such design elements which may be spaced apart from one another.

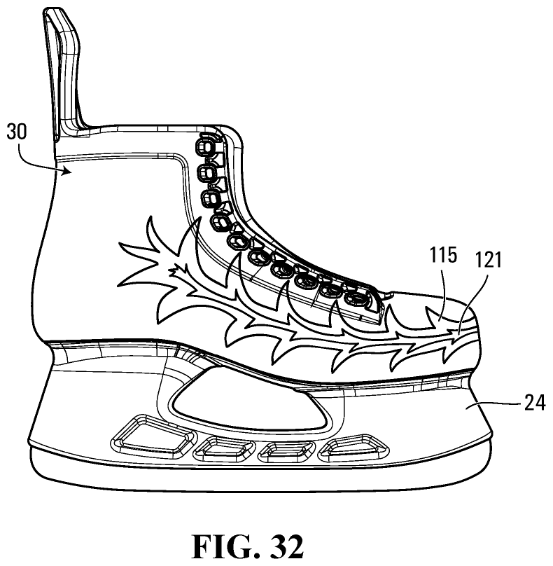

The one or more design elements 121 may be disposed over various portions of the shell 30 and/or over various other portions of the skate boot 22, for instance over the medial side portion 68, over the lateral side portion 66, over a top portion and/or over the toe portion 32 of the shell 30, and may also be disposed over the tongue 34, over the tendon guard 35, over the liner 36, over the footbed 38, over the insole 40, over the lace members 44₁, 44₂, over the eyelets 46₁-46_{E}, and so on, as shown in FIG. 32. For instance, the design elements 121 may be disposed at least on a side of the toe portion 32. In this example, the design elements 121 are disposed on a medial side, on a lateral side and on a top side of the toe portion 32.

The design elements 121 may cover at least a substantial part (i.e., a substantial part or an entirety) of a surface area of the portion of the skate boot 22 (e.g., the toe portion 32) over which they are disposed and that is externally visible (i.e., visible from outside of the skate boot 22). For instance, in some embodiments, the design elements 121 covers at least a quarter (i.e., 25%), in some embodiments at least a third (i.e., 33%), in some embodiments at least a majority (i.e., at least 50%), in some embodiments at least 75%, and in some embodiments an entirety of the toe portion 32.

Some of the design elements 121 may also be continuous with other design elements 121 of adjacent portions of the skate boot 22. That is, there may be a continuity of the design element 121 between the toe portion 32 and a given one of the medial side portion 68 and the lateral side portion 66 of the shell 30, thus providing an impression that the design elements 121 extend from a given one of the toe portion 32, the medial side portion 68 and the lateral side portion 66 to another one of the toe portion 32, the medial side portion 68 and the lateral side portion 66. In this embodiment, there is continuity of design elements 121 between the toe portion 32, the medial side portion 68 and the lateral side portion 66 of the shell 30.

In this embodiment, an external one of the layers 85₁-85_{L} of the shell 30 may be a clear layer overlying the design elements 121 such that the design elements 121 are visible through the clear layer and such that the clear layer protects the design elements 121 from flying pucks, sticks, etc.

The design elements 121 may include a design pattern, a printed image, and so on. In this embodiment, the design element is a graphic element which includes one or many different colors.

In this embodiment, at least some of (e.g., some of, a majority of, or an entirety of) the design elements 121 of the shell 30 may comprise graphical ink 632 implementing graphics 635. These graphics 635 may include any desired color(s), shape(s), pattern(s), character(s), image(s), etc.

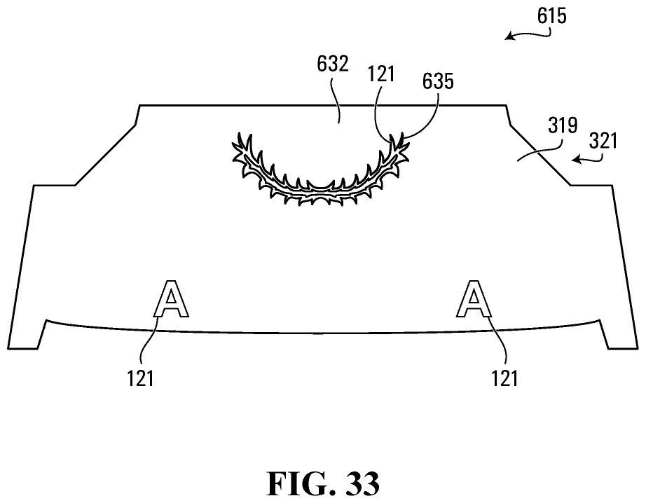

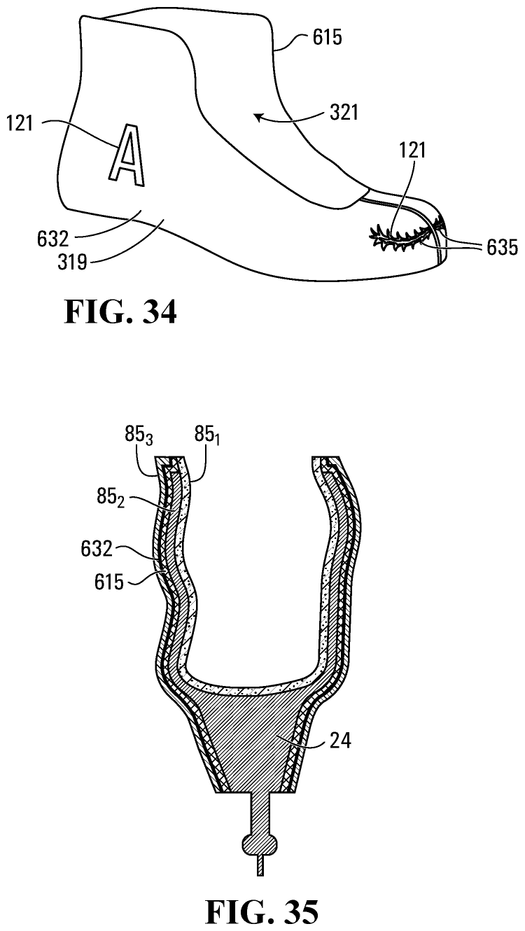

More specifically, in this embodiment, as shown in FIGS. 33 to 35, the graphical ink 632 may be provided by a film 615. In this embodiment, the film 615 is a sheet comprising a polymeric material such as a polycarbonate, polypropylene, polyethylene or any other suitable polymeric material. The film 615 may comprise an ink-providing side 319 that provides the graphical ink 632 and a plain side 321 opposite the ink-providing side 319. In this embodiment, the ink-providing side 319 is an outer side of the film 615 and the plain side 321 is an inner side of the film 615.

The graphical ink 632 may cover a substantial part of a surface area of the ink-providing side 319 of the film 615. For example, in some embodiments, the graphical ink 632 may cover a majority, in some embodiments at least 60%, in some embodiments at least 80%, and in some embodiments substantially an entirety of the surface area of the ink-providing side 319 of the film 615.

In some cases, the film 615 may be a clear film (e.g., transparent or translucid) through which a person can see. For instance, in some cases, it may be clear at areas free of the graphical ink 632. In other examples, the film 615 may be opaque, colored (e.g., black, white or any other color), partially transparent, homogenous, and/or different at different areas.

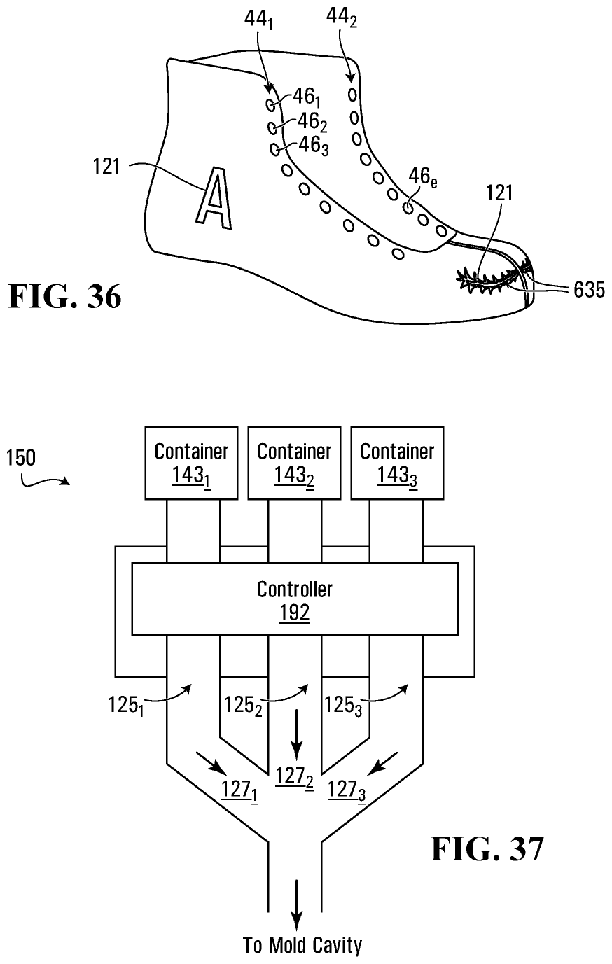

In this embodiment, the film 615 is configured to be positioned on at least part of (i.e. part of, a majority of or an entirety of) the shell 30 to provide the design elements 121 of the shell 30. For instance, in this embodiment, the film 615 is configured to cover the medial side portion, the lateral side portion, the heel portion, and the ankle portion of the shell 30 of the skate boot 22 and the graphical ink 632 is configured to cover the medial side portion, the lateral side portion, the heel portion, and the ankle portion of the shell 30 of the skate boot 22 when the film 615 is positioned on the shell 30 to provide the design elements 121 of the shell 30. The film 615 may also be configured to cover various other portions of the skate boot 22, including the toe cap 32, the lace members 44₁, 44₂, the eyelets 46₁-46ₑ, and so on, as shown in FIG. 36.

In particular, in this embodiment, the film 615 is configured to be positioned between consecutive layers 85₁-85_{L} of the shell 30. Specifically, the film 615 may be configured to be positioned over a layer 85ₓ prior to, during or after molding of that layer 85ₓ, and the layer 85_{y} external to the layer 85ₓ may be molded over the layer 85ₓ and over the graphical ink 632 of the design elements 121. In this embodiment, the layer 85_{y} may be an external layer of the shell 30 and may be a clear layer.

In some embodiments, the film 615 may be configured to remain on the shell 30 after molding of the layer 85ₓ and during molding of the layer 85_{y}, such that the skate boot 20, as an end product, comprises the film 615.

The graphical ink 632 may be provided on the film 615 in any suitable way. For example, the graphical ink 632 may be provided on the film 615 via silk-screening, pad printing, flexo printing or offset printing, or any other printing (e.g., jet print, water decal, sublimation, ink transfer, laser, airbrushing, etc.).

The graphical ink 632 may be any suitable graphical ink. For instance, in some embodiments, the graphical ink 632 may be solventless (i.e., may not comprise and may have been provided without any solvent). In some embodiments, a surface energy of the graphical ink 632 may be less than 32 dynes/cm, in some embodiments less than 28 dynes/cm, in some embodiments less than 24 dynes/cm, and in some embodiments even less. Furthermore, in this embodiment, graphical ink 632 may have any suitable elongation to rupture (elasticity), opacity, opacity when stretched. In particular, in this embodiment, the graphical ink 632 may be configured to have a relatively high elongation to rupture at room temperature on a relatively thin substrate. The graphical ink 632 may be substantially free of volatile solvents and may be configured to prevent inhibiting chemical reaction with polyurethane, in particular with one or more isocyanate components of the polyurethane, while having a good bonding and a good chemical affinity with polyurethane.

In some embodiments, an entirety of the graphical ink 632 may comprise a relatively flexible ink (e.g. configured to have a relatively high elongation to rupture at room temperature on a relatively thin substrate). In some embodiments, the graphical ink 632 may comprise inks of different elasticities: for instance, in this example, a majority of the graphical ink 632 may comprise a relatively flexible ink and the graphical ink 632 may comprise a relatively stiff ink in areas where stretch is minimal.

For example, in some embodiments, the graphical ink 632 comprises one or more of a latex-based ink, a UV/LED cured ink, a flexography ink, a silkscreen ink, etc. In variants, the graphical ink 932 may comprise a water-and-solvent-based ink (e.g., a dried water-and-solvent-based ink free of residual water and solvents).

Moreover, in some cases, the reinforcement 115, which is depicted in FIG. 31 spaced apart from the decoration 121, itself may act as a decoration in addition to its reinforcing functionality.

Once the reinforcement 115 (or multiple reinforcements 115) and/or the design element 121 (or multiple design elements 121) has been affixed to the exterior surface of the intermediate subshell 85₂, the molding process proceeds as described above. Notably, the next subshell, in this case the external subshell 85₃, is formed such that it covers the reinforcement 115 and/or the design element 121 thus trapping the reinforcement 115 and/or the design element 121 between the intermediate subshell 85₂ and the external subshell 85₃. In some embodiments, the external subshell 85₃ may be clear (i.e., translucent) and may thus allow displaying the reinforcement 115 and/or the design element 121 through the external subshell 85₃. This may be particularly useful to display the design element 121 but may also be useful to display the reinforcement 115 for aesthetic purposes.

In some embodiments, the reinforcement 115 may be pre-shaped before being placed in the molding apparatus 150 with the subshells 85₁-85_{L} of the skate boot 22. For example, in some embodiments, the reinforcement 115 may be thermoformed before being placed in the molding apparatus 150 with the subshells 85₁-85_{L} of the skate boot 22.

In this embodiment, the molding process employed to form the shell 30 is low-pressure injection molding. That is, the polymeric materials M₁-M_{N} that constitute the subshells 85₁-85_{L} are injected into the mold cavity formed by each mold 154ᵢ at a relatively low pressure. In addition, the molding process employed to form the shell 30 may be characterized as a co-injection molding process since the polymeric materials M₁-M_{N} are injected into a same mold.

In this embodiment, as shown in FIG. 37, the molding apparatus 150 comprises a plurality of ports 125₁-125_{P} for receiving constituents 127₁-127_{C} that are different from one another to injection mold a given one of the layers 85₁-85_{L}, referred-to as layer 85ₓ hereinbelow. In particular, in this example, the molding apparatus 150 may comprise at least three ports 125₁-125₃ for receiving three different constituents 127₁-127₃, such as from containers 143₁-143₃ containing supplies of the constituents 127₁-127₃. A desired property (e.g., stiffness) of the polymeric material Mₓ of the layer 85ₓ of the shell 30 of the skate boot 22 may be determined (e.g., based on input received from a user or from a component of a computer system). Respective ones of the constituents 127₁-127₃ may be injected to produce the polymeric material Mₓ while proportions of these respective ones of the constituents 127₁-127₃ (e.g., relative to one another and/or to their total) are controlled to impart the desired property of the polymeric material Mₓ of the layer 85ₓ of the shell 30 of the skate boot 22.

In this embodiment, the molding apparatus 150 may be configured to allow customization of the shell 30 of the skate boot 22 by controlling the proportions of the respective ones of the constituents 127₁-127_{C} of the layer 85ₓ according to the desired property of the polymeric material Mₓ. Thus, in some embodiments, the shells 30 of a plurality of similar skate boots 22 manufactured by the molding apparatus 150 may have different proportions of the respective ones of the constituents 127₁-127_{C} of their layer 85ₓ. In particular, without changing in its configuration, the molding apparatus 150 may be configured to control the proportions of the respective ones of the constituents 127₁-127_{C} such that these proportions for the layer 85ₓ of the shell 30 of a first skate boot 22 manufactured by the molding apparatus 150 are different from these proportions for the layer 85ₓ of the shell 30 of a second skate boot 22 manufactured by the molding apparatus 150 immediately after the first skate boot 22 without changing the physical configuration of the molding apparatus 150. Further information about customization of the shell 30 of the skate boot 22 can be obtained from PCT Patent Application Publication No. WO2021237365A1, which is incorporated by reference herein.

In this embodiment, the layer 85_{y} of the shell 30 of the skate boot 22 may be disposed outwardly of the layer 85ₓ of the shell 30 of the skate boot 22. Specifically, in this embodiment, the layer 85_{y} of the shell 30 of the skate boot 22 is an outermost layer of the shell 30 of the skate boot 22.

The material M_{y} of the layer 85_{y} of the shell 30 of the skate boot 22 may be a second polyurethane. More specifically, the material M_{y} of the layer 85_{y} of the shell 30 of the skate boot 22 may be foamless. Also, in this embodiment, the material M_{y} of the layer 85_{y} of the shell 30 of the skate boot 22 may be clear. For instance, in this embodiment, the material M_{y} of the layer 85_{y} of the shell 30 may effectively constitute a clear coating.

In this embodiment, no external heat is applied to the polymeric materials M₁-M_{N} of the shell 30. Rather, in this embodiment, in order to form a subshell 85ᵢ, the constituents of a given polymeric material Mₓ chemically react when combined to release heat. In other words, the two or more constituents have an exothermic reaction when combined. Thus, in this embodiment, a layer 85ᵢ of the shell 30 is formed by reaction injection molding of respective ones of the constituents 127₁-127_{C}. The exothermic chemical reaction that characterizes the molding process of the shell 30 contrasts the conventional method of forming a skate boot shell which involves thermoforming whereby heat is applied to a thermoformable sheet of material in a mold such that the thermoformable sheet of material acquires the shape of the mold.

In other embodiments, external heat may be applied to one or more of the polymeric materials M₁-M_{N} of the shell 30, such as, for instance, to facilitate a chemical reaction of the constituents of a given polymeric material Mₓ. Heat may be applied by radiation, by air convection, by steam convection, by heating the last 152 and/or the associated female mold 154ᵢ prior to molding and/or by any other suitable means. The constituents may have an exothermic reaction or an endothermic reaction when combined and sufficiently heated. In this example, the external heat may furnish triggering energy to initiate the reaction of the two or more constituents and optionally catalyzing energy to catalyze the reaction. Although in this embodiment heat is applied, this manufacturing process still contrasts the conventional method of forming a skate boot shell which involves thermoforming whereby heat is applied to a thermoformable sheet of material in a mold such that the thermoformable sheet of material acquires the shape of the mold.

In other embodiments, no external heat is applied to some of the polymeric materials M₁-M_{N} of the shell 30 (e.g., the polymeric material M₂ of the intermediate subshell 85₂, which may be injected and blown into its final form without external heat), while external heat is applied to other ones of the polymeric materials M₁-M_{N} of the shell 30 (e.g., the polymeric material M₃ of the external subshell 85₃, the polymeric material Mᵢ of an insert 315_{M} between the intermediate subshell 85₂ and the external subshell 85₃, etc.).

In other embodiments, energy in a different form from heat may be applied to the polymeric materials M₁-M_{N} of the shell 30 in addition to or in replacement to heat. For instance, the polymeric materials M₁-M_{N} may be radiated using electromagnetic radiation (e.g., UV, x-rays, microwaves) and/or acoustic radiation (e.g., ultrasound).

The molding process of the shell 30 may be implemented in any suitable way in other embodiments. For example, in some embodiments, injection molding at higher pressure may be used. As another example, in some embodiments, two or more lasts such as the last 152 may be used (e.g., different lasts for molding respective ones of the subshells 85₁-85_{L}). Moreover, the last 152 may be configured differently than the last shown in FIG. 15. For instance, the last 152 may not comprise projections for forming the apertures 48 and rather one or more of the female molds 154₁-154_{N} may comprise such projections for forming the apertures 48. In other cases, the projections on the last 152 for forming the apertures 48 may be retractable. As another example, in some embodiments, the molding process of the shell 30 may be casting in which the polymeric materials M₁-M_{N} are poured into one or more molds. In some embodiments, the last 152 may be customizable and/or otherwise configurable such as by adding or removing last attachments (e.g. shims), which may be created by additive manufacturing (e.g., 3D-printed), as described in U.S. patent application Ser. No. 16/448,622, which is incorporated herein.

The skate boot 22 may comprise an overlay 102 on an external surface 65 of the shell 30 for aesthetic or functional purposes.

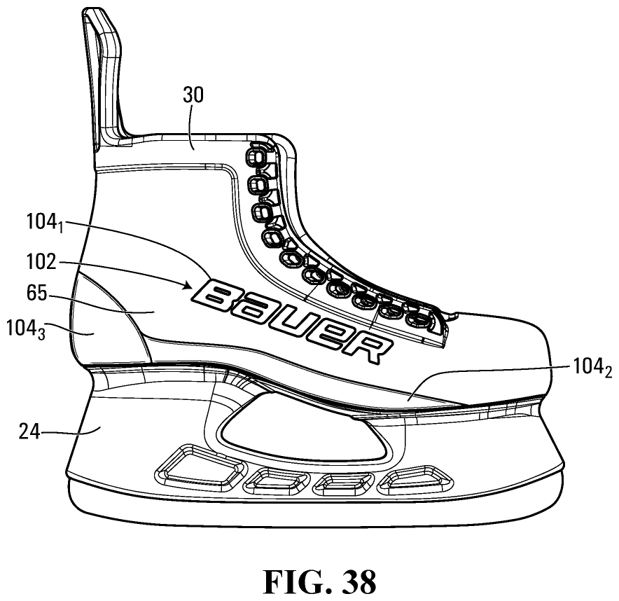

With additional reference to FIG. 38, in this embodiment, the overlay 102 comprises a plurality of overlay elements 104₁-104_{O} that can be disposed at any suitable part of the shell 30. For example, in some cases, the overlay elements 104₁-104_{O} may be a graphic (e.g., a logo), a brand name, a pattern, a word, etc. While the overlay elements 104₁-104_{O} may improve an aesthetic appearance of the skate 10, in some cases, certain overlay elements 104₁-104_{O} may also serve functional purposes. For instance, in some cases, the overlay elements 104₁-104_{O} may be configured to minimize wear of at least a portion of the external surface 65 of the shell 30. For example, an overlay element 104x may be located close to a bottom portion of the medial and/or lateral sides of the shell 30 in order to prevent contact between the playing surface 12 and the shell 30 of the skate boot 22. This may help in reducing undue wear of the skate 10.

The overlay 102 may be affixed to the external surface 65 of the shell 30 in various ways. For instance, each of the overlay elements 104₁-104_{O} may be mechanically fastened to the external surface 65 of the shell 30 (e.g., via stitching, staples, etc.), glued thereto via an adhesive, or ultrasonically bonded. The overlay elements 104₁-104_{O} may be affixed to the external surface 65 of the shell 30 in any other suitable way, such as by means of air brushing, by means of water printing (e.g., water dripping), using a flexible membrane comprising the overlay, the flexible membrane being placed in the mold prior to molding, etc.

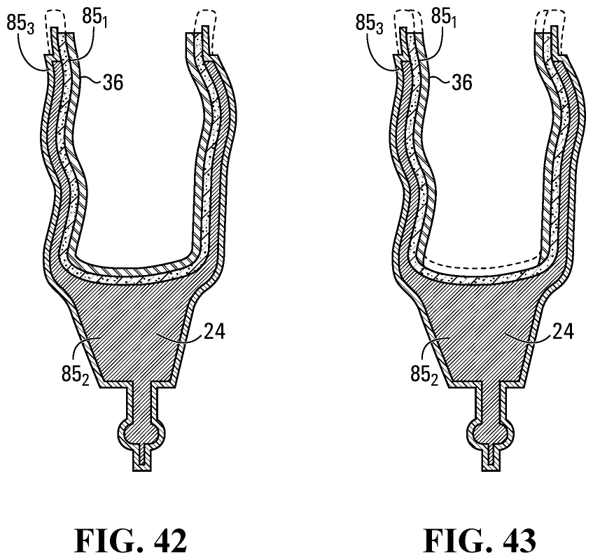

The inner liner 36 of the skate boot 22 is affixed to an inner surface of the shell 30 and comprises an inner surface 96 for facing the heel HL and medial and lateral sides MS, LS of the player's foot 11 and ankle A in use. In some embodiments, as shown in FIG. 42, the inner liner 36 may comprise a sole portion for facing the plantar surface of the user's foot 11, while in other embodiments the inner liner 36 does not comprise a sole portion, as shown in FIG. 43. The inner liner 36 may be made of a soft material (e.g., a fabric made of NYLON® fibers or any other suitable fabric). The footbed 38 is mounted inside the shell 30 and comprises an upper surface 106 for receiving the plantar surface PS of the player's foot 11 and a wall 108 projecting upwardly from the upper surface 106 to partially cup the heel HL and extend up to a medial line of the player's foot 11.

The insole 40 has an upper surface 25 for facing the plantar surface PS of the player's foot 11 and a lower surface 23 on which the shell 30 may be affixed.

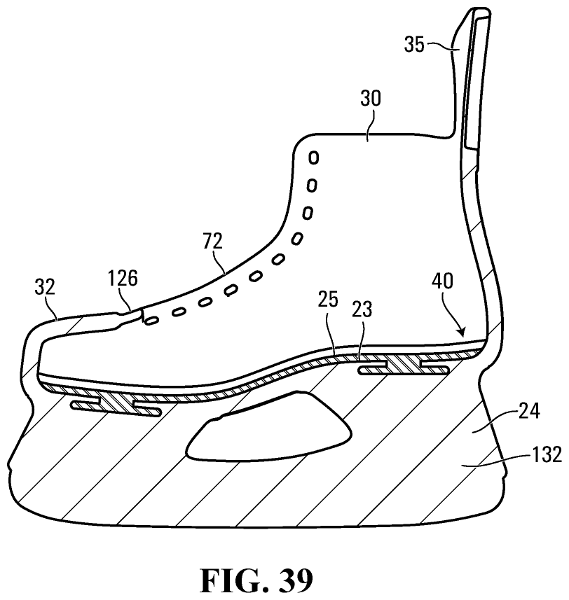

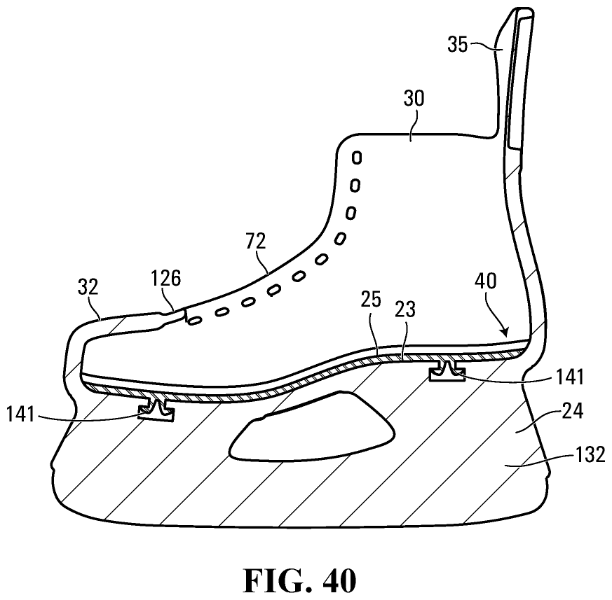

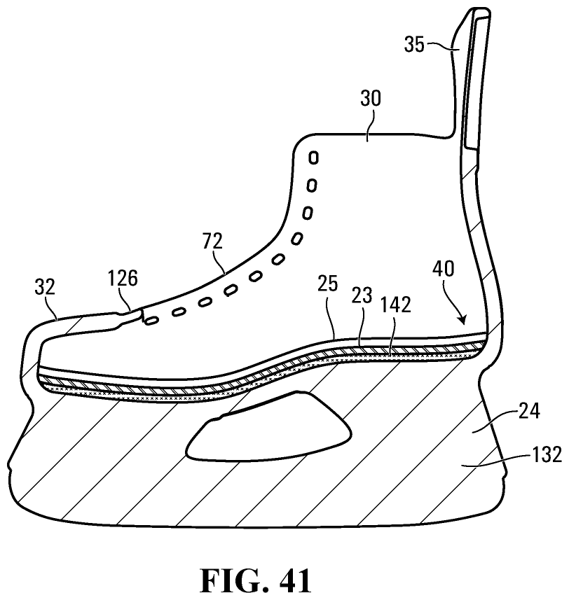

In some embodiments, the insole 40 may be affixed to the shell 30 of the skate boot 22. For instance, in some embodiments, as shown in FIG. 39, the lower surface 23 of the insole 40 may be overmolded to the shell 30 of the skate boot 22. In other embodiments, as shown in FIG. 40, the insole 40 may be joined mechanically to the shell 30 of the skate boot 22 by a mechanical fastener 141 (e.g., a clip, a rivet, or any suitable fastener). In other embodiments, as shown in FIG. 41, the insole 40 may be adhesively bonded to the shell 30 of the skate boot 22 via an adhesive 142.

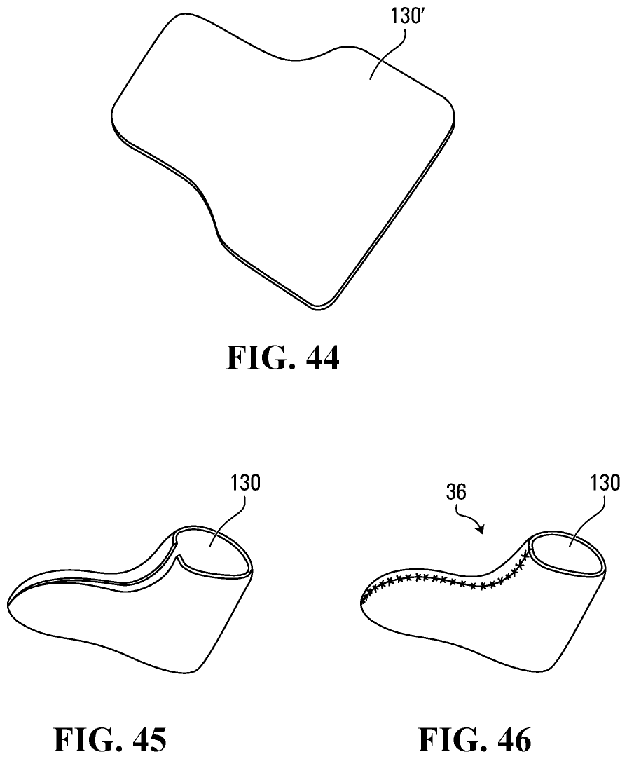

In some embodiments, as shown in FIGS. 44 to 46, the inner liner 36 of the skate boot may be a “3D liner”, i.e., may be formed of a three-dimensional sheet 130 of material (e.g., fabric). This may allow reducing the use of stitching and tape for manufacturing the inner liner 36, thereby reducing weight, improving comfort and reducing manufacturing cost of the inner liner 36. The 3D inner liner 36 may be manufactured in any suitable way. For instance, in some embodiments, the 3D inner liner 36 may be formed using a standard 2D sheet 130′ of fabric that is thermoformed over a 3D last such that the 3D last imparts its shape to the sheet of fabric. The sheet of fabric, now having the 3D shape of the 3D last, may then be cut to pre-determined dimensions and finalized by affixing (e.g., by stitching, taping, etc.) portions of its edges to one another. As a result, a ratio of the amount of stiches and/or tape required for manufacturing the 3D inner liner 36 over the amount of stiches and/or tape required for manufacturing a standard inner liner 36 may be no more than 0.9, in some cases no more than 0.8, in some cases no more than 0.7, in some cases even less.

In some embodiments, the skate boot 22 may not comprise an inner liner 36. For instance, the internal subshell 85₁ of the shell 30 of the skate boot 22 may serve as an inner lining already and thus the addition of the inner liner 36 may be redundant. In other cases, the inner liner 36 may be inserted during the molding process using the molding apparatus 150. For example, a textile material may first be placed on the last 152 prior to forming the first subshell (i.e., the internal subshell 85₁) such as to serve as a pre-formed “sock” onto which the internal subshell 85₁ is formed.

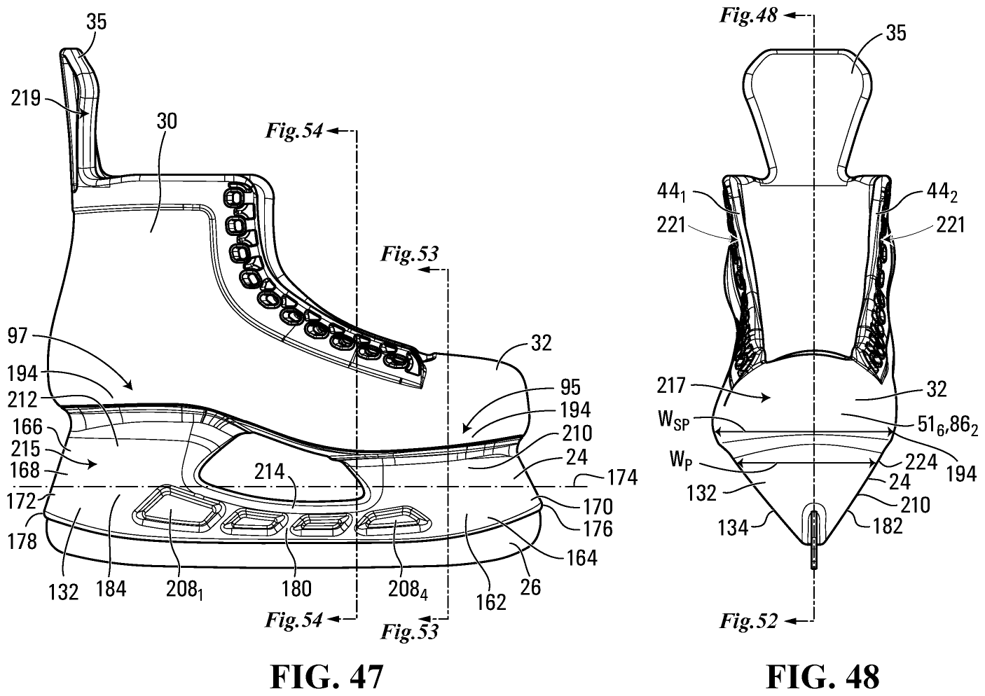

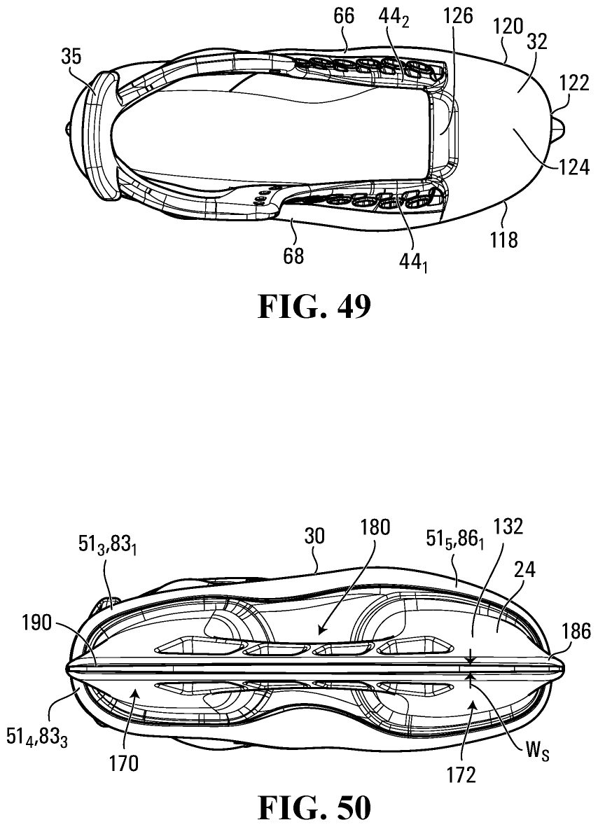

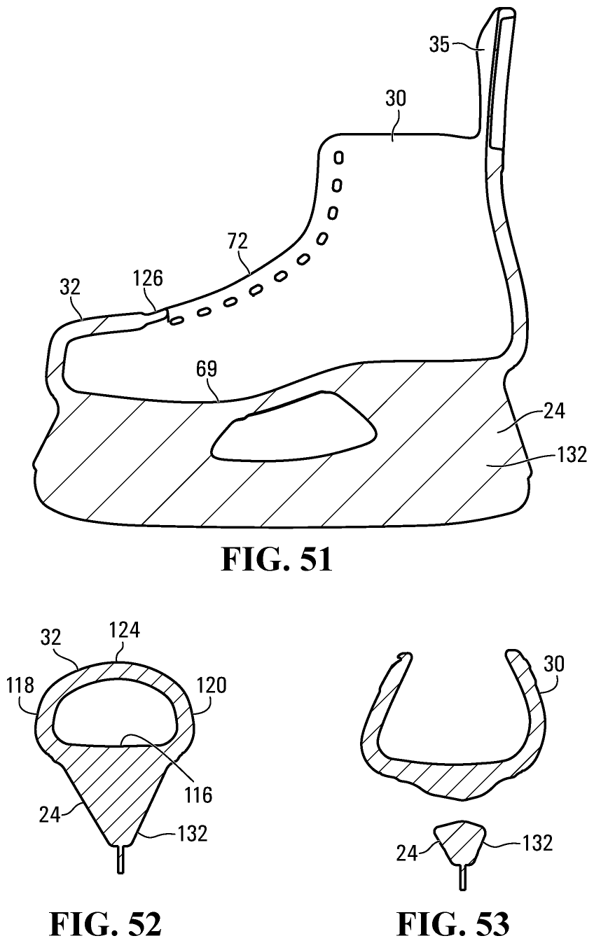

With additional reference to FIGS. 47 to 53, the toe cap 32 of the skate boot 22 is configured to face and protect the toes T of the player's foot 11. As will be described in more detail below, in this example, at least part (i.e., part or all) of the toe cap 32 is formed integrally with the shell 30 and can thus be referred to as a toe portion 17 of the shell 30. As shown in FIGS. 49, 51 and 52, the toe cap 32 (in this case the toe portion 17 of the shell 30) comprises a bottom portion 116 for at least partially covering a front portion of the lower surface 23 of the insole 40, a lateral side portion 118 for facing a small toe of the foot 11 of the player, a medial side portion 120 for facing a big toe of the foot 11 of the player, an end portion 122 between the lateral and medial side portions 118, 120, an upper portion 124 for facing a top of the toes T of the player's foot 11, and a top extension 126 for affixing the tongue 34 to the toe cap 32. The top extension 126 of the toe cap 32 may be affixed (e.g., glued and/or stitched) to a distal end portion of the tongue 34 in order to affix the tongue 34 to the toe cap 32.

The toe cap 32 may comprise a synthetic material 105 that imparts stiffness to the toe cap 32. For instance, in various embodiments, the synthetic material 105 of the toe cap 32 may comprise nylon, polycarbonate materials (e.g., Lexan®), polyurethane, thermoplastics, thermosetting resins, reinforced thermoplastics, reinforced thermosetting resins, polyethylene, polypropylene, high density polyethylene or any other suitable material. In some cases, the synthetic material 105 of the toe cap 32 may be a composite material comprising thermoset material, thermoplastic material, carbon fibers and/or fiberglass fibers. For example, the composite material may be a fiber-matrix composite material that comprises a matrix in which fibers are embedded. The matrix may include any suitable polymeric resin, such as a thermosetting polymeric material (e.g., polyester, vinyl ester, vinyl ether, polyurethane, epoxy, cyanate ester, etc.), a thermoplastic polymeric material (e.g., polyethylene, polyurethane, polypropylene, acrylic resin, polyether ether ketone, polyethylene terephthalate, polyvinyl chloride, polymethyl methacrylate, polycarbonate, acrylonitrile butadiene styrene, nylon, polyimide, polysulfone, polyamide-imide, self-reinforcing polyphenylene, etc.), or a hybrid thermosetting-thermoplastic polymeric material. The fibers may be made of any suitable material such as carbon fibers, polymeric fibers such as aramid fibers, boron fibers, glass fibers, ceramic fibers, etc.

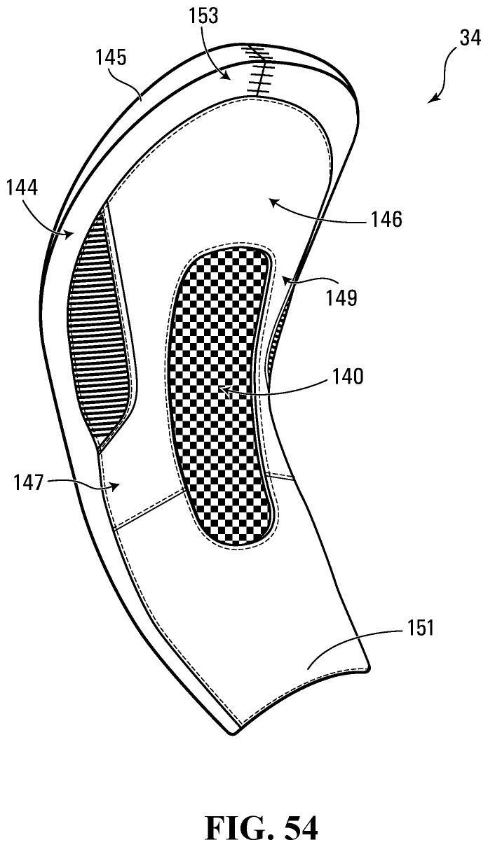

The tongue 34 extends upwardly and rearwardly from the toe cap 32 for overlapping the top surface TS of the player's foot 11. In this embodiment, as shown in FIG. 54, the tongue 34 comprises a core 140 defining a section of the tongue 34 with increased rigidity, a padding member (not shown) for absorbing impacts to the tongue 34, a peripheral member 144 for at least partially defining a periphery 145 of the tongue 34, and a cover member 146 configured to at least partially define a front surface of the tongue 34. The tongue 34 defines a lateral portion 147 overlying a lateral portion of the player's foot 11 and a medial portion 149 overlying a medial portion of the player's foot 11. The tongue 34 also defines a distal end portion 151 for affixing to the toe cap 32 (e.g., via stitching) and a proximal end portion 153 that is nearest to the player's shin S.

The tendon guard 35 extends upwardly from the rear portion 82 of the ankle portion 64 of the shell 30 in order to protect the player's Achilles tendon AT. As will be described in more detail below, in this embodiment, at least part (i.e., part or all) of the tendon guard 35 is integrally formed with the shell 30 of the skate boot 22. In other embodiments, the tendon guard 35 may be a separate component from the shell 30 such that the tendon guard 35 is fastened to the shell 30 via a mechanical fastener (e.g., via stitching, stapling, a screw, etc.) or in any other suitable way.

The skate boot 22 may be constructed in any other suitable way in other embodiments. For example, in other embodiments, various components of the skate boot 22 mentioned above may be configured differently or omitted and/or the skate boot 22 may comprise any other components that may be made of any other suitable materials and/or using any other suitable processes.

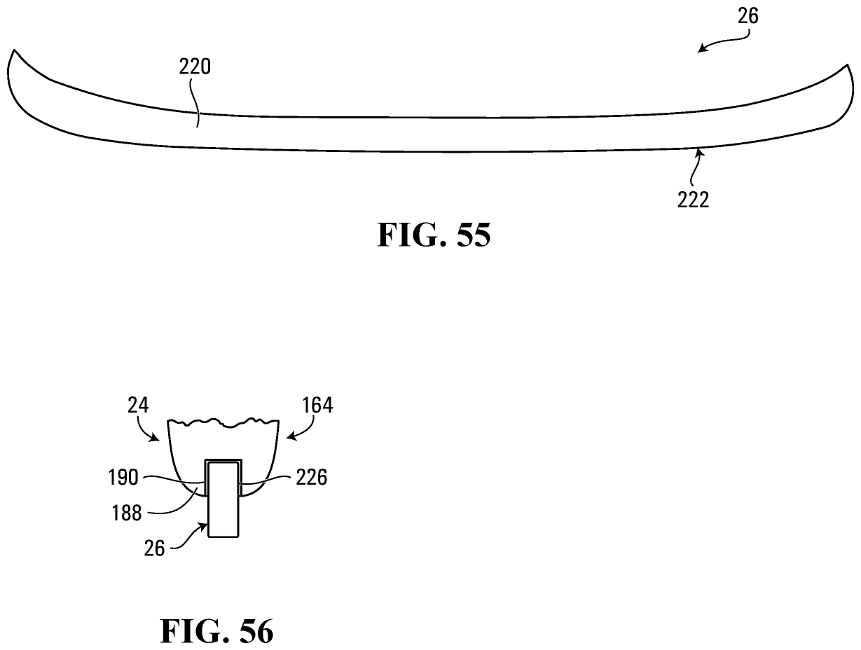

As shown in FIG. 55, the blade 26 comprises an ice-contacting material 220 including an ice-contacting surface 222 for sliding on the ice surface while the player skates. In this embodiment, the ice-contacting material 220 is a metallic material (e.g., stainless steel). The ice-contacting material 220 may be any other suitable material in other embodiments.

As shown in FIGS. 47, 48 and 50, the blade holder 24 comprises a body 132 including a lower portion 162 comprising a blade-retaining base 164 that retains the blade 26 and an upper portion 166 comprising a support 168 that extends upwardly from the blade-retaining base 164 towards the skate boot 22 to interconnect the blade holder 24 and the skate boot 22. A front portion 170 of the blade holder 24 and a rear portion 172 of the blade holder 24 define a longitudinal axis 174 of the blade holder 24. The front portion 170 of the blade holder 24 includes a frontmost point 176 of the blade holder 24 and extends beneath and along the player's forefoot in use, while the rear portion 172 of the blade holder 24 includes a rearmost point 178 of the blade holder 24 and extends beneath and along the player's hindfoot in use. An intermediate portion 180 of the blade holder 24 is between the front and rear portions 170, 172 of the blade holder 24 and extends beneath and along the player's midfoot in use. The blade holder 24 comprises a medial side 182 and a lateral side 184 that are opposite one another.

The blade-retaining base 164 is elongated in the longitudinal direction of the blade holder 24 and is configured to retain the blade 26 such that the blade 26 extends along a bottom portion 186 of the blade-retaining base 164 to contact the ice surface 12. To that end, the blade-retaining base 164 comprises a blade-retention portion 188 to face and retain the blade 26. In this embodiment, as shown in FIG. 56, the blade-retention portion 188 comprises a recess 190, which can be referred to as a “blade-receiving slot”, extending from the front portion 170 to the rear portion 172 of the blade holder 24 in which an upper portion of the blade 26 is disposed. The blade-retaining base 164 may be configured in any other suitable way in other embodiments.

The support 168 is configured for supporting the skate boot 22 above the blade-retaining base 164 and transmit forces to and from the blade-retaining base 164 during skating. In this embodiment, the support 168 comprises a front pillar 210 and a rear pillar 212 which extend upwardly from the blade-retaining base 164 respectively towards a front sole part 95 and a rear sole part 97 of the skate boot 22. The front pillar 210, which can be referred to as a front “pedestal”, extends towards the front portion 56 of the skate boot 22 and the rear pillar 212, which can be referred to as a rear “pedestal”, extends towards the rear portion 58 of the skate boot 22. The blade-retaining base 164 extends from the front pillar 210 to the rear pillar 212. More particularly, in this embodiment, the blade-retaining base 164 comprises a bridge 214 interconnecting the front and rear pillars 210, 212.

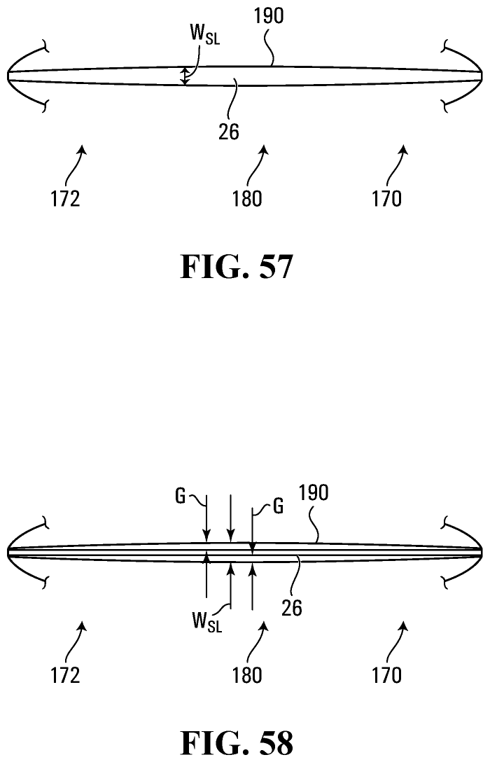

In this embodiment, as shown in FIGS. 50, 57 and 58, the blade-receiving slot 190 may be wider in the intermediate portion 180 of the blade-retaining base 164 between the front portion 170 of the blade-retaining base 164 and the rear portion 172 of the blade-retaining base 164 than in the front portion 170 of the blade-retaining base 164 and in the rear portion 172 of the blade-retaining base 164. In particular, in this embodiment, the blade-receiving slot 190 may be wider between the front pillar 210 and the rear pillar 212 than beneath the front pillar 210 and beneath the rear pillar 212.

In this embodiment, at least part (i.e., part or all) of the body 132 of the blade holder 24 is integrally formed with the shell 30 of the skate boot 22. That is, at least part of the body 132 of the blade holder 24 and the shell 30 of the skate boot 22 constitute a monolithic one-piece structure. The body 132 of the blade holder 24 thus comprises an integrally-formed portion 215 that is integrally formed with the shell 30 of the skate boot 22 such that the portion 215 of the body 132 of the blade holder 34 and the shell 30 of the skate boot 22 are formed together as one-piece in the molding apparatus 150 during the molding process.

In this embodiment, the integrally-formed portion 215 of the body 132 of the blade holder 24 includes one or more of the polymeric materials M₁-M_{N} of the subshells 85₁-85_{L} of the shell 30 of the skate boot 22. For instance, in this example, the portion 215 of the body 132 of the blade holder 24 includes the intermediate and external subshells 85₂, 85₃ and therefore comprises the polymeric materials M₂, M₃ associated therewith. In particular, in this example, a majority of the body 132 of the blade holder 24 is constituted by the polymeric material M₂ of the intermediate subshell 85₂ such that the body 132 of the blade holder 24 consists primarily of a structural foam material. Alternatively, the portion 215 of the body 132 of the blade holder 24 may include one or more different materials.

In this embodiment, at least a majority (i.e., a majority or an entirety) of the body 132 of the blade holder 24 may be integrally formed with shell 30 of the skate boot 22. That is, the integrally-formed portion 215 of the body 132 of the blade holder 24 may be a major portion or the entirety of the body 132 of the blade holder 24. In this embodiment, an entirety of the body 132 of the blade holder 24 is integrally formed with the shell 30 of the skate boot 22.

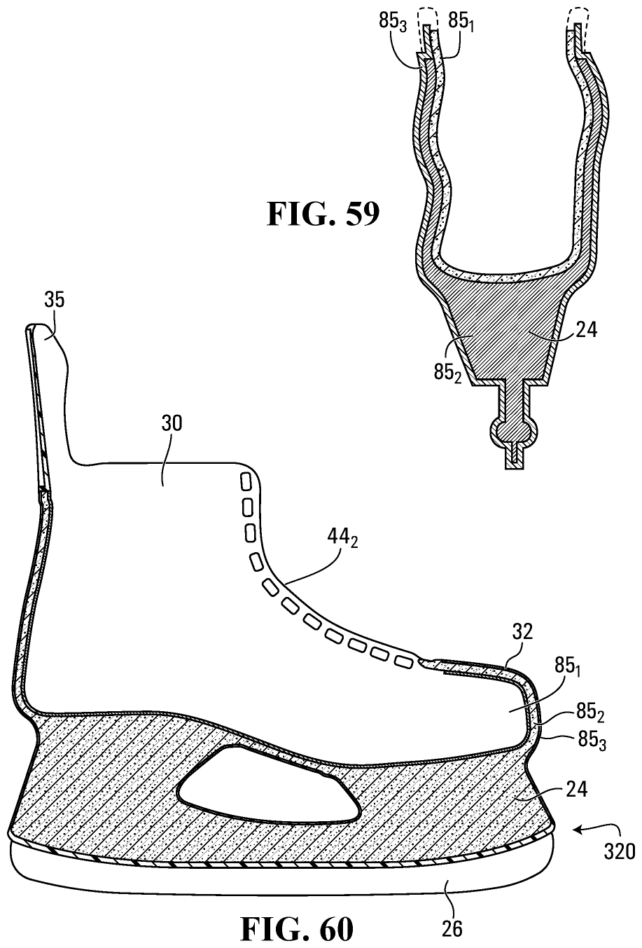

Therefore, in this embodiment, the body 132 of the blade holder 24 is formed with the shell 30 of the skate boot 22 in the molding apparatus 150 with the last 152. In particular, the body 132 of the blade holder 24 is initially formed during forming of the intermediate subshell 85₂ of the shell 30 of the skate boot 22 and is completed by the forming of the external subshell 85₃ of the shell 30 of the skate boot 22. That is, in this embodiment, as shown in FIGS. 59 and 60, the intermediate subshell 85₂ is the innermost subshell of the body 132 of the blade holder 24 while the external subshell 85₃ is the outermost subshell of the body 132 of the blade holder 24.

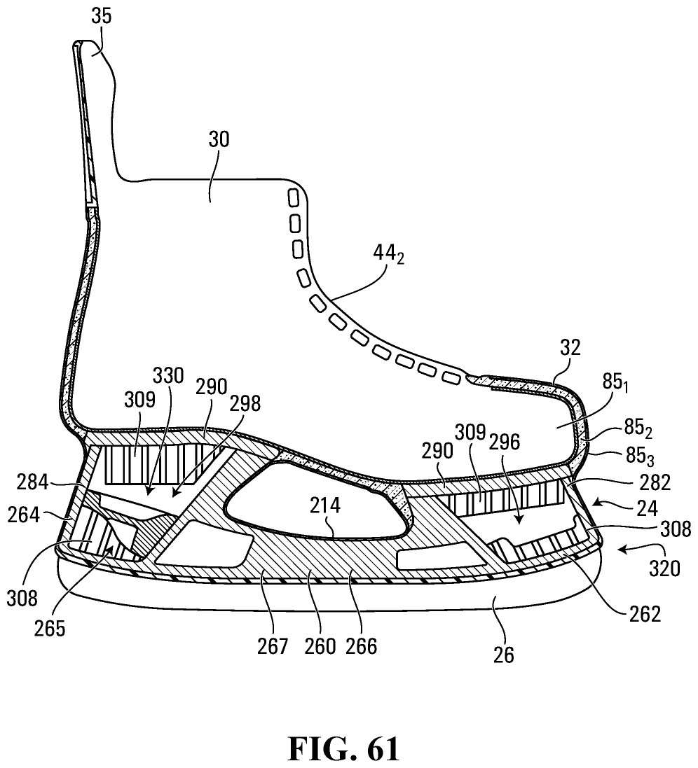

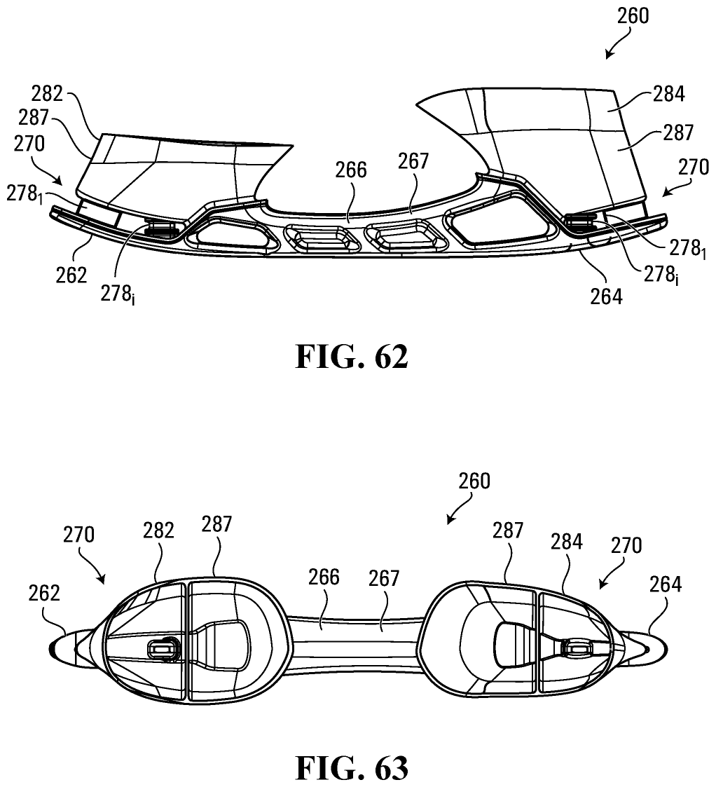

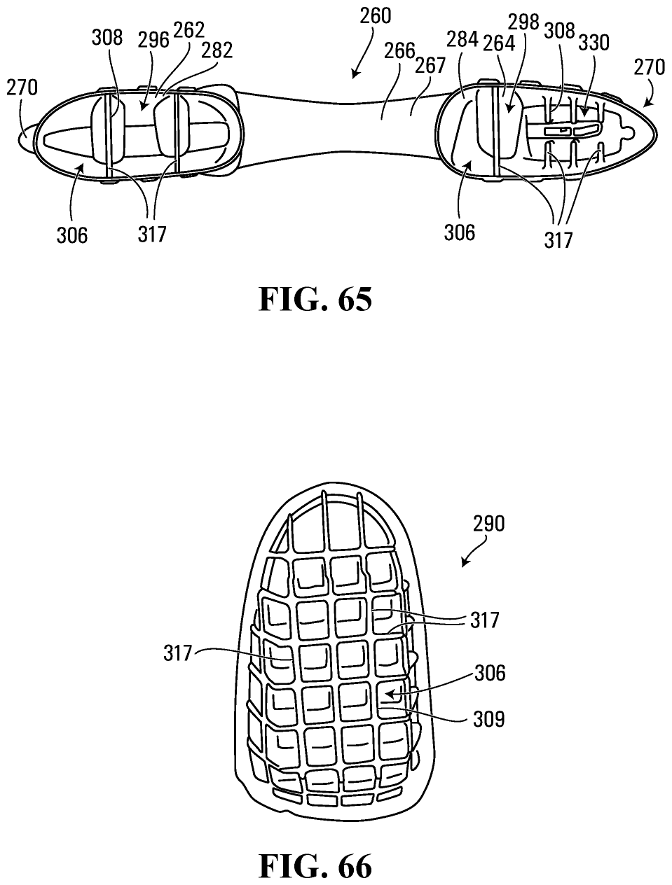

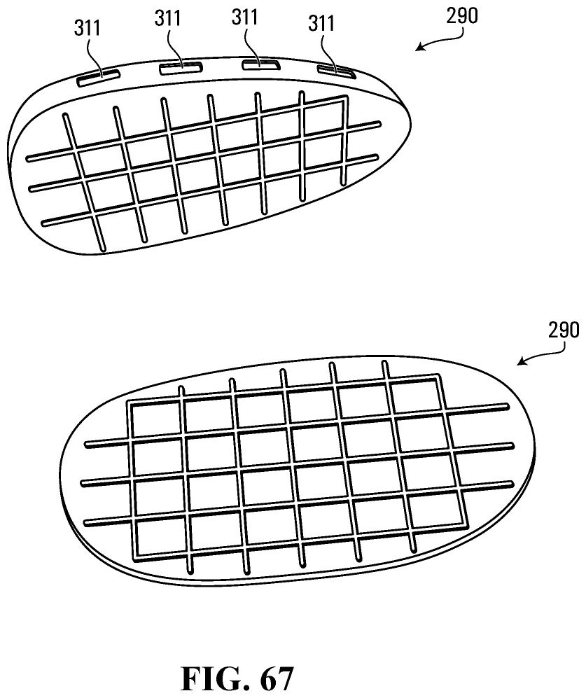

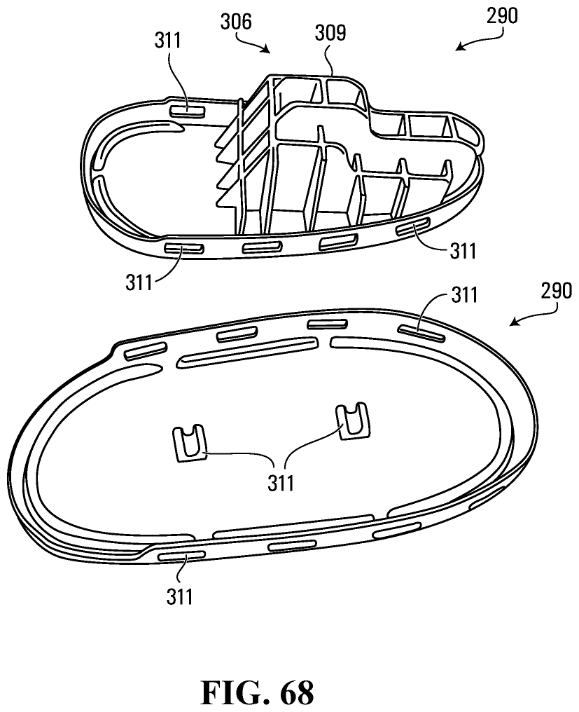

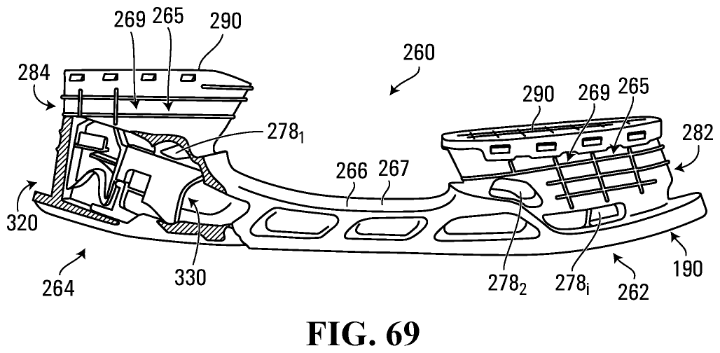

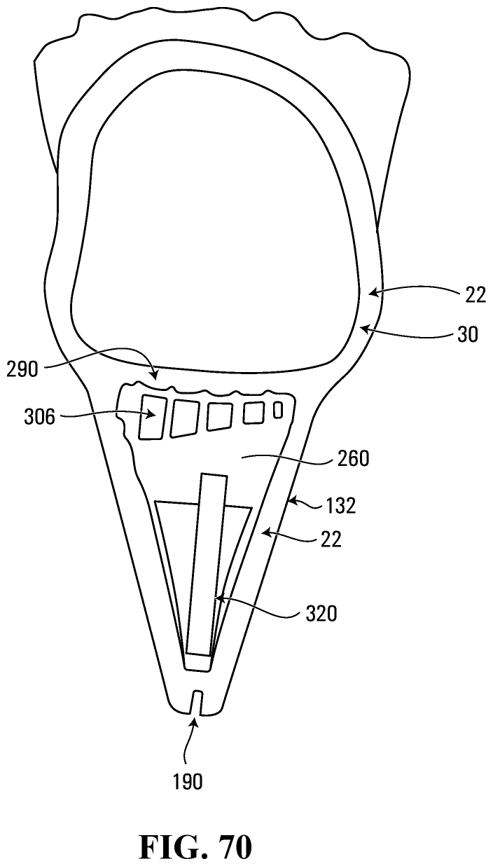

In some embodiments, with additional reference to FIGS. 61 to 70, the body 132 of the blade holder 24 comprises a core 260 which may be manufactured prior to the molding of the skate boot 22 and the integrally-formed portion 215 of the body 132 of the blade holder 24 and which may be placed in the mold used during the molding process of the skate boot 22 and the integrally-formed portion 215 of the body 132 of the blade holder 24, such that the skate boot 22 and the integrally-formed portion 215 of the body 132 of the blade holder 24 are overmolded onto the core 260. This may, for instance, allow use of materials that could not be used during the molding process of the skate boot 22; reduce geometric tolerances and increase standardisation of the skate boot 22, increase stiffness of the blade holder 24, reduce energy losses during skating, etc.

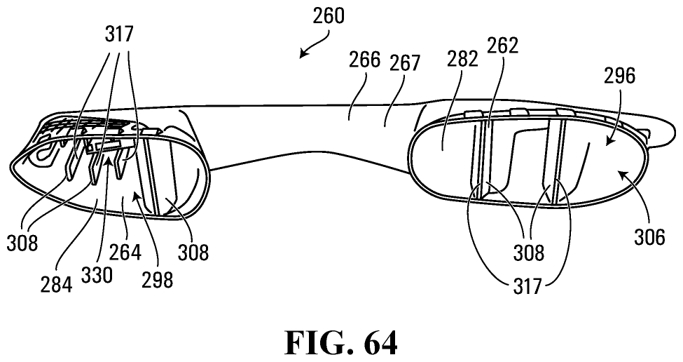

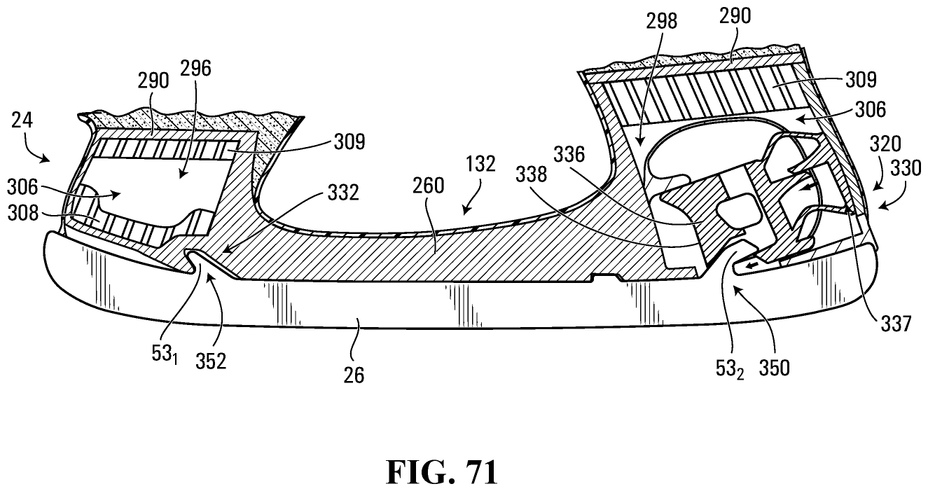

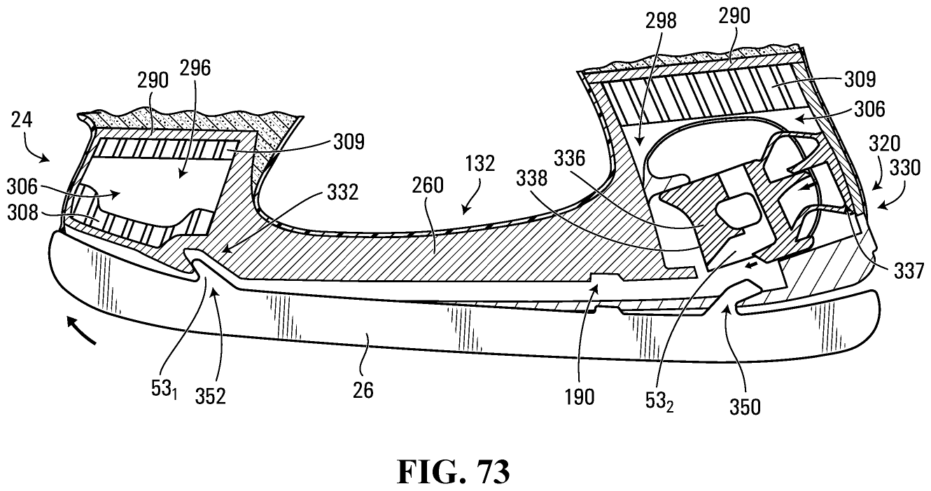

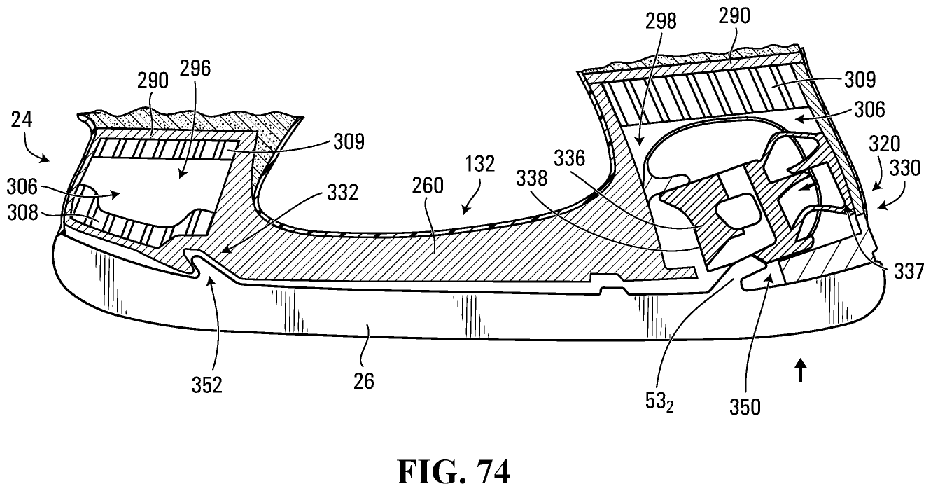

In this embodiment, with additional reference to FIGS. 64, 65, 69 to 74, the blade holder 24 may comprise a connection system 320 configured to attach the blade 26 to and detach the blade 26 from the blade holder 24. The connection system 320 facilitates installation and removal of the blade 26, such as for replacement of the blade 26, assemblage of the skate 10, and/or other purposes.

More particularly, in this embodiment, the connection system 320 of the blade holder 24 is a quick-connect system configured to attach the blade 26 to and detach the blade 26 from the blade holder 24 quickly and easily.

Notably, in this embodiment, the quick-connect system 320 of the blade holder 24 is configured to attach the blade 26 to and detach the blade 26 from the blade holder 24 without using a screwdriver when the blade 26 is positioned in the blade holder 24. In this example, the quick-connect system 320 is configured to attach the blade 26 to and detach the blade 26 from the blade holder 24 screwlessly (i.e., without using any screws) when the blade 26 is positioned in the blade holder 24. It is noted that although the quick-connect system 320 is configured to attach the blade 26 to and detach the blade 26 from the blade holder 24 screwlessly, the quick-connect system 320 may comprise screws that are not used (i.e. manipulated) for attachment or detachment of the blade 26. Thus, in this embodiment, the quick-connect system 320 is configured to attach the blade 26 to and detach the blade 26 from the blade holder 24 without using a screwdriver and screwlessly when the blade 26 is positioned in the longitudinal recess 190 of the blade holder 24.

In this example, the quick-connect system 320 of the blade holder 24 is configured to attach the blade 26 to and detach the blade 26 from the blade holder 24 toollessly (i.e., manually without using any tool) when the blade 26 is positioned in the blade holder 24. That is, the blade 24 is attachable to and detachable from the blade holder 24 manually without using any tool (i.e., a screwdriver or any other tool). Thus, in this example, the quick-connect system 320 is configured to attach the blade 26 to and detach the blade 26 from the blade holder 24 toollessly when the blade 26 is positioned in the longitudinal recess 190 of the blade holder 24.

In this embodiment, the quick-connect system 320 of the blade holder 24 comprises a plurality of connectors 330, 332 to attach the blade 26 to and detach the blade 26 from the blade holder 24. The blade 26 comprises a plurality of connectors 350, 352 configured to engage respective ones of the connectors 330, 332 of the quick-connect system 320 of the blade holder 24 to be attached to and detached from the blade holder 24. The connectors 330, 332 of the quick-connect system 320 of the blade holder 24 are spaced apart in the longitudinal direction of the skate 10, and so are the connectors 350, 352 of the blade 26.

In this embodiment, the connectors 350, 352 comprise hooks 53₁, 53₂ that project upwardly from a top edge of the blade 26, with the hook 53₁ being a front hook and the hook 53₂ being a rear hook. The connector 330 of the quick-connect system 320 may include an actuator 336 and a biasing element 337 which biases the actuator 36 in a direction towards the front portion 170 of the blade holder 24. To attach the blade 26 to the blade holder 24, the front hook 53₁ is first positioned within a hollow space 342 (e.g., a recess or hole) of the blade holder 24. The rear hook 53₂ can then be pushed upwardly into a hollow space 344 (e.g., a recess or hole) of the blade holder 24, thereby causing the biasing element 337 to bend and the actuator 336 to move in a rearward direction. The rear hook 53₂ will eventually reach a position which will allow the biasing element 337 to force the actuator 336 towards the front portion 66 of the blade holder 24, thereby locking the blade 52 in place. The blade 52 can then be removed by pushing against a finger-actuating surface 338 of the actuator 336 to release the rear hook 53₂ from the hollow space 344 of the blade holder 24. The quick-connect system 320 may be configured in any other suitable way in other embodiments.

The quick-connect system 320 of the blade holder 24 may be connected to the body 132 of the blade holder 24 in any suitable way. In particular, in this embodiment, the connector 330 of the quick-connect system 320 of the blade holder 24 may be received in the rear cavity 298 of the core 260 of the body 132 of the blade holder 24. In particular, in this embodiment, the connector 330 of the quick-connect system 320 may be installed in the rear cavity 298 of the core 260 of the body 132 of the blade holder 24 prior to molding of the skate boot 22 such that molded material of the shell 30 covers the cavities 296, 298, thereby protecting the connector 330 of the quick-connect system 320.

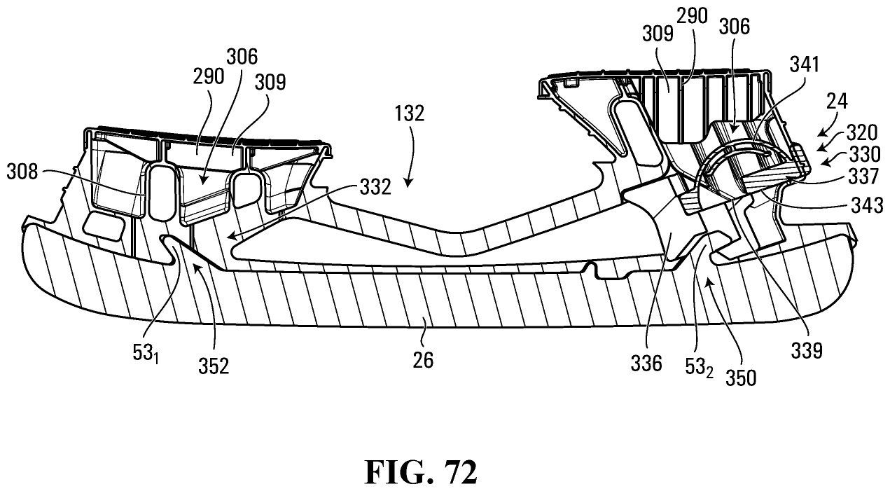

The quick-connect system 320 of the blade holder 24 may be implemented in various other ways in other embodiments. For example, in some embodiments, the quick-connect system 320 of the blade holder 24 may be implemented as described in International Patent Application No. PCT/CA2019/051531 filed on Oct. 29, 2019 and incorporated by reference herein. As another example, in some embodiments, as shown in FIG. 72, the biasing element may comprise a spring part 341 and a sliding surface 343 configured to slide onto a sliding surface 339 of the actuator 336.

In this embodiment, one or more other components (e.g., the toe cap 32, the tendon guard 35, the lace members 44₁, 44₂, the tongue 34, the footbed 38, etc.) of the skate boot 22 may be molded integrally with the shell 30 in the molding apparatus 150 during the molding process. The shell 30 and these one or more other components of the skate boot 22 may thus constitute a monolithic one-piece structure.

For example, in this embodiment, the toe cap 32, the tendon guard 35, and the lace members 44₁, 44₂ are molded integrally with the shell 30 in the molding apparatus 150 during the molding process.

For instance, in this embodiment, the toe cap 32 comprises a portion 217 that is integrally formed with the shell 30 such that the portion 217 of the toe cap 32 of the skate boot 22 and the shell 30 of the skate boot 22 are formed together as one-piece in the molding apparatus 150 during the molding process. As such, the portion 217 of the toe cap 32 of the skate boot 22 may include one or more of the polymeric materials M₁-M_{N} of the subshells 85₁-85_{L} of the shell 30 of the skate boot 22.

In this embodiment, the portion 217 of the toe cap 32 includes one or more of the polymeric materials M₁-M_{N} of the subshells 85₁-85_{L} of the shell 30 of the skate boot 22. For instance, in this example, the portion 217 of the toe cap 32 includes the internal, intermediate and external subshells 85₁, 85₂, 85₃ and therefore comprises the polymeric materials M₁, M₂, M₃ associated therewith. Alternatively, the portion 217 of the toe cap 32 may include one or more different materials.

Moreover, in this embodiment, the tendon guard 35 comprises a portion 219 that is integrally formed with the shell 30 such that the portion 219 of the tendon guard 35 of the skate boot 22 and the shell 30 of the skate boot 22 are formed together as one-piece in the molding apparatus 150 during the molding process. As such, the portion 219 of the tendon guard 35 of the skate boot 22 may include one or more of the polymeric materials M₁-M_{N} of the subshells 85₁-85_{L} of the shell 30 of the skate boot 22. For instance, in this example, the portion 219 of the tendon guard 35 includes solely the external subshell 85₃ and therefore comprises the polymeric material M₃ associated therewith. Alternatively, the portion 219 of the tendon guard 35 may include one or more different materials. For example, in some embodiments, the portion 219 of the tendon guard 219 may also comprise the internal subshell 85₁ and/or the intermediate subshell 85₂ such that the portion 219 of the tendon guard 35 also comprises the polymeric material M₁ and/or the polymeric material M₂ associated therewith.

Moreover, in this embodiment, each of the lace members 44₁, 44₂ comprises a portion 221 that is integrally formed with the shell 30 such that the portion 221 of each of the lace members 44₁, 44₂ of the skate boot 22 and the shell 30 of the skate boot 22 are formed together as one-piece in the molding apparatus 150 during the molding process. As such, the portion 221 of each lace member 44ᵢ of the skate boot 22 may include one or more of the polymeric materials M₁-M_{N} of the subshells 85₁-85_{L} of the shell 30 of the skate boot 22. For instance, in this example, the portion 221 of the lace member 44ᵢ includes solely the external subshell 85₃ and therefore comprises the polymeric material M₃ associated therewith. Alternatively, the portion 221 of the lace member 44ᵢ may include one or more different materials. For example, in some embodiments, the portion 221 of the lace member 44ᵢ may also comprise the internal subshell 85₁ and/or the intermediate subshell 85₂ such that the portion 221 of the lace member 44ᵢ also comprises the polymeric material M₁ and/or the polymeric material M₂ associated therewith. Moreover, in this embodiment, the apertures 48 that extend through the lace members 44₁, 44₂ are formed during the molding process by appropriate structures (e.g., projections) of the last 152 and an associated female mold 154ᵢ.

The skate 10 may be implemented in any other suitable manner in other embodiments.

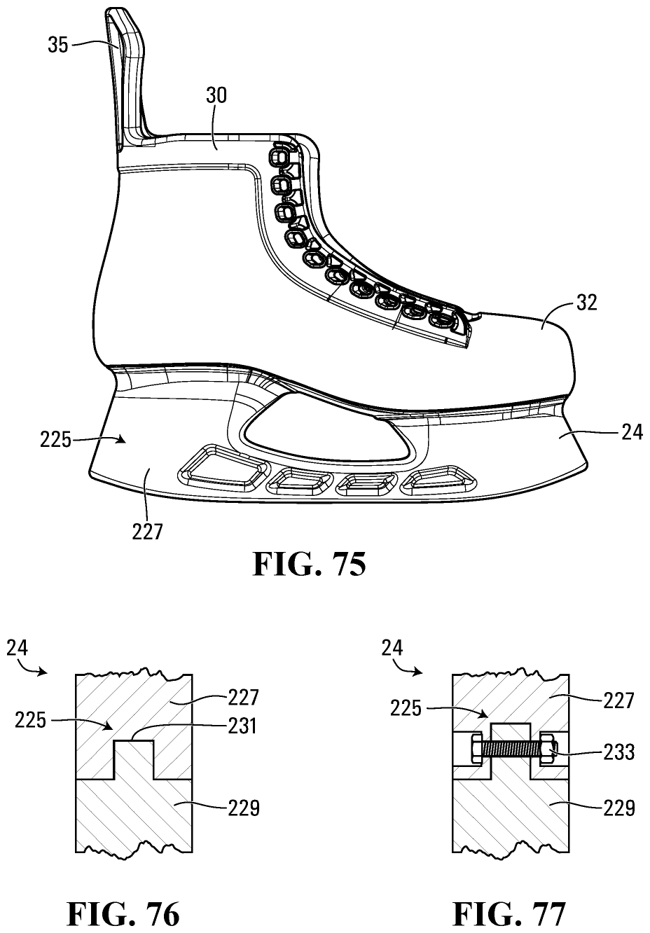

For example, in some embodiments, as shown in FIGS. 75 to 77, only a limited part 225 of the blade holder 24 may be integrally formed with the shell 30. For instance, in some embodiments, the part 225 of the blade holder 24 may comprise a projection 227 projecting from an underside of the shell 30 to which another part 229 of the blade holder 24 may be secured. As shown in FIGS. 76 and 77, the projection 227 of the part 225 of the blade holder 24 may be secured to the other part 229 of the blade holder 24 via an adhesive 231 that is applied between the two parts 225, 229 or in some cases via mechanical fasteners such as a nut and bolt assembly 233 that traverses the parts 225, 229 to secure them together. The parts 225, 229 of the blade holder 24 may be secured to one another in any other suitable way in other embodiments. In other embodiments, a substantial part of the blade holder 24 may be molded integrally with the shell 30. For example, in some cases, at least a majority of the blade holder 24 may be molded together with the shell 30. In some case, substantially an entirety of the blade holder 24 may be molded integrally with the shell 30.

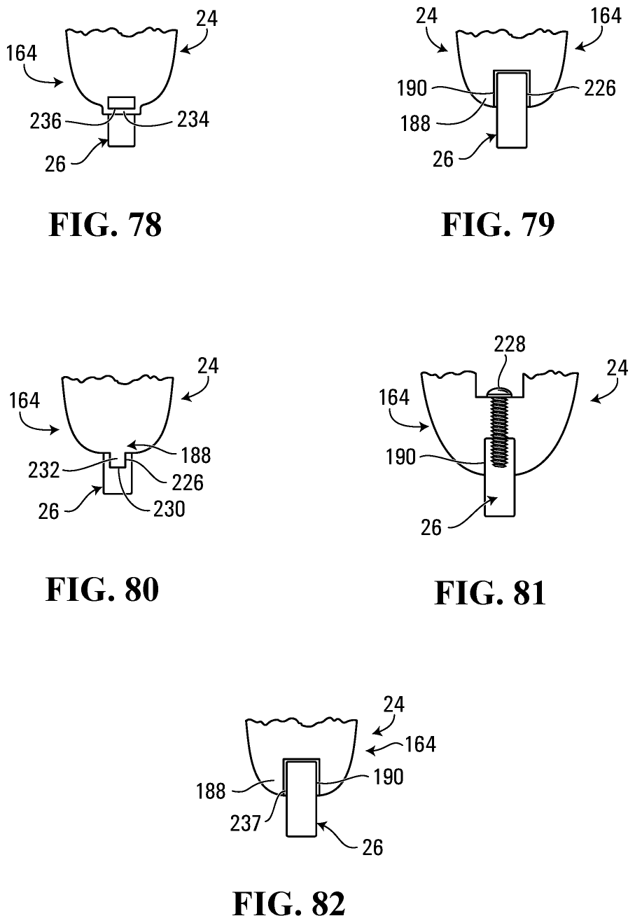

As another example, in some embodiments, the blade holder 24 may retain the blade 26 in any other suitable way. For instance, in some embodiments, the blade 26 may be permanently affixed to the blade holder 24 (i.e., not intended to be detached and removed from the blade holder 24). For example, as shown in FIG. 78, the blade 26 and the blade-retaining base 164 of the blade holder 24 may be mechanically interlocked via an interlocking portion 234 of one of the blade-retaining base 164 and the blade 26 that extends into an interlocking void 236 of the other one of the blade-retaining base 164 and the blade 26. For instance, in some cases, the blade 26 can be positioned in a mold used for molding the blade holder 24 such that, during molding, the interlocking portion 234 of the blade-retaining base 164 flows into the interlocking void 236 of the blade 26 (i.e., the blade holder 24 is overmolded onto the blade 26). For example, in some embodiments, the blade 26 may be attached to the blade holder 24 during the molding process by including the blade 26 in a given mold 154; such that the blade holder 24 overmolds the blade 26 during the molding process. For instance, the mold 154ᵢ may be designed specifically to hold the blade 26 during the molding process prior to the forming of the intermediate subshell 85₂.

In some embodiments, as shown in FIGS. 79 and 80, the blade holder 24 may retain the blade 26 using an adhesive 226 and/or one or more fasteners 228. For instance, in some embodiments, as shown in FIG. 79, the recess 190 of the blade holder 24 may receive the upper portion of the blade 26 that is retained by the adhesive 226. The adhesive 226 may be an epoxy-based adhesive, a polyurethane-based adhesive, or any suitable adhesive. In some embodiments, instead of or in addition to using an adhesive, as shown in FIG. 81, the recess 190 of the blade holder 24 may receive the upper part of the blade 26 that is retained by the one or more fasteners 228. Each fastener 228 may be a rivet, a screw, a bolt, or any other suitable mechanical fastener. In some embodiment, the blade holder 24 may retain the blade 26 via a press fit. For example, as shown in FIG. 82, the recess 190 of the blade holder 24 may be configured (e.g., sized) such as to enter into a press fit with the blade 26. More particularly, in this example of implementation, the blade 26 comprises an elastomeric coating including an elastomeric material (e.g., polyurethane, rubber, or any other suitable elastomeric material) that forms at least part of an outer surface of the blade 26. The elastomeric coating has a greater friction coefficient than the ice-contacting material 220 of the blade 26 when interacting with the blade holder 24 such as to improve retention of the blade 26 by the blade holder 24 in a press fit. Alternatively or additionally, in some embodiments, as shown in FIG. 80, the blade-retention portion 188 of the blade holder 24 may extend into a recess 230 of the upper part of the blade 26 to retain the blade 26 using the adhesive 226 and/or the one or more fasteners 228. For instance, in some cases, the blade-retention portion 188 of the blade holder 24 may comprise a projection 232 extending into the recess 230 of the blade 26.

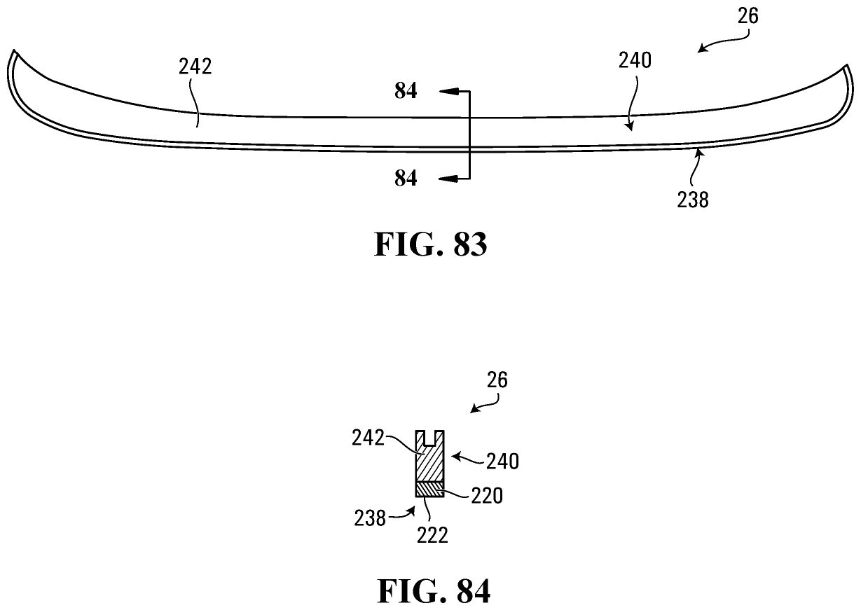

The blade 26 may be implemented in any other suitable way in other embodiments. For example, in some embodiments, as shown in FIGS. 83 and 84, the blade 26 may comprise a runner 238 that is made of the ice-contacting material 220 and includes the ice-contacting surface 222 and a body 240 connected to the runner 238 and made of a material 242 different from the ice-contacting material 220. The runner 238 and the body 240 of the blade 26 may be retained together in any suitable way. For example, in some cases, the runner 238 may be adhesively bonded to the body 240 using an adhesive. As another example, in addition to or instead of being adhesively bonded, the runner 238 and the body 240 may be fastened using one or more fasteners (e.g., rivets, screws, bolts, etc.). As yet another example, the runner 238 and the body 240 may be mechanically interlocked by an interlocking portion of one of the runner 238 and the body 240 that extends into an interlocking space (e.g., one or more holes, one or more recesses, and/or one or more other hollow areas) of the other one of the runner 238 and the body 240 (e.g., the body 240 may be overmolded onto the runner 238).

In some embodiments, one or more other components (e.g., the tongue 34, the footbed 38, etc.) of the skate boot 22 may be molded integrally with the shell 30 in the molding apparatus 150 during the molding process. The shell 30 and these one or more other components of the skate boot 22 may thus constitute a monolithic one-piece structure. A given component of the skate boot 22 may therefore comprise a portion 235 that is integrally formed with the shell 30 such that the portion 235 of the given component of the skate boot 22 and the shell 30 of the skate boot 22 are formed together as one-piece in the molding apparatus 150 during the molding process.

As such, the portion 235 of the given component of the skate boot 22 may include one or more of the polymeric materials M₁-M_{N} of the subshells 85₁-85_{L} of the shell 30 of the skate boot 22. For instance, the portion 235 of the given component may include one or more of the internal, intermediate and external subshells 85₁, 85₂, 85₃ and therefore may comprise one or more of the polymeric materials M₁, M₂, M₃ associated therewith. Alternatively, the portion 235 of the given component may include one or more different materials.

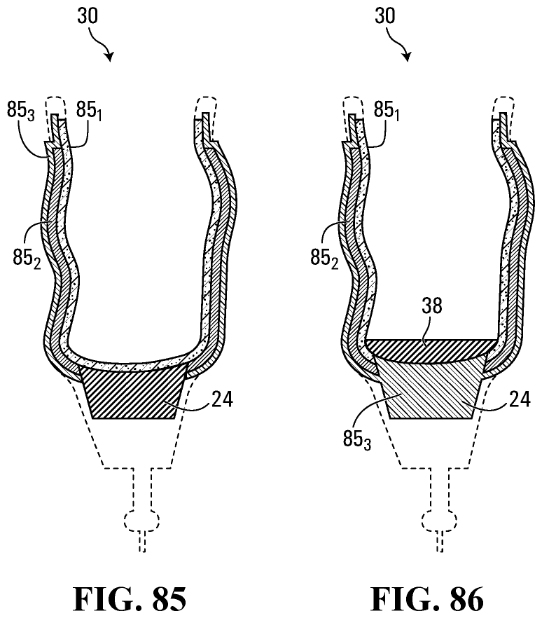

In some embodiments, at least a portion of (i.e., part or an entirety of) the blade holder 24 may be attached to a given one of the subshells 85₁-85_{L} of the shell 30. For instance, the portion of the blade holder 24 may be joined to the given one of the subshells 85₁-85_{L} during forming of the shell 30. For example, as shown in FIG. 85, the portion of the blade holder 24 may be affixed to an exterior surface of the internal subshell 85₁ and the intermediate and external subshells 85₂, 85₃ may be formed around the portion of the blade holder 24.

In other embodiments, as discussed above, the portion of the blade holder 24 may be formed during the molding process of the shell 30. For example, as shown in FIG. 86, a majority or an entirety of the portion of the blade holder 24 may be constituted by the external subshell 85₃. Moreover, the footbed 38 may be formed or affixed directly on the portion of the blade holder 24 (i.e., on the external subshell 85₃ that makes up a majority or an entirety of the portion of the blade holder 24).

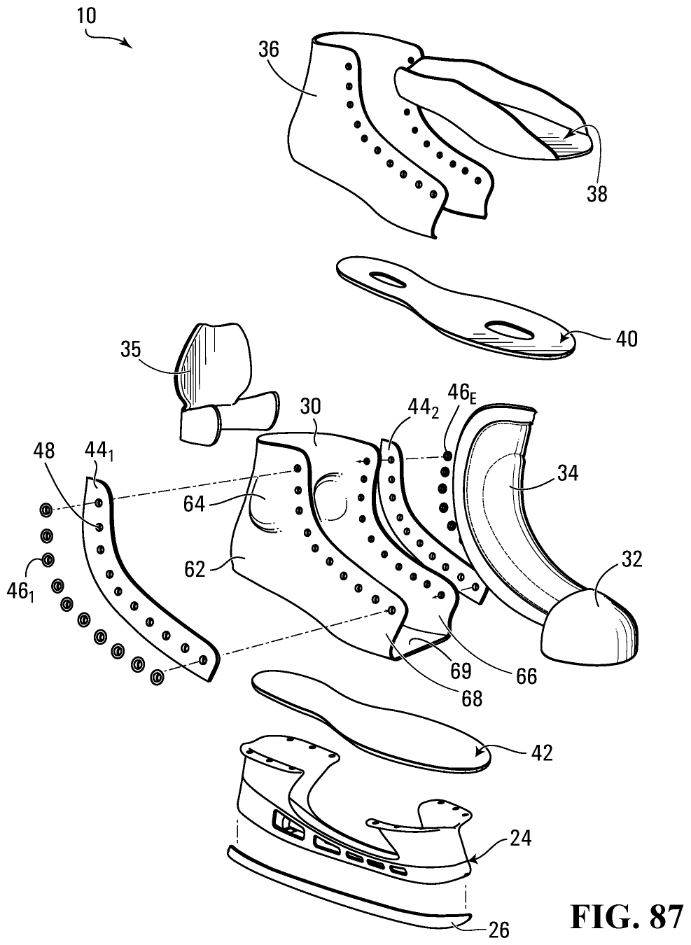

In some embodiments, with additional reference to FIG. 87, the shell 30 and possibly one or more other components of the skate boot 22 may be manufactured separately from the blade holder 24, which may be manufactured separately and attached to the skate boot 22.

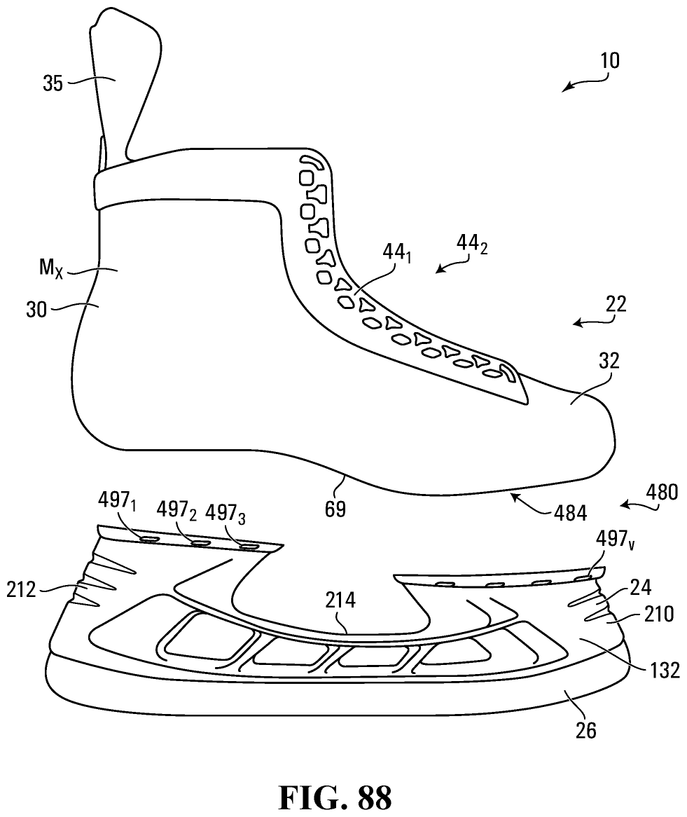

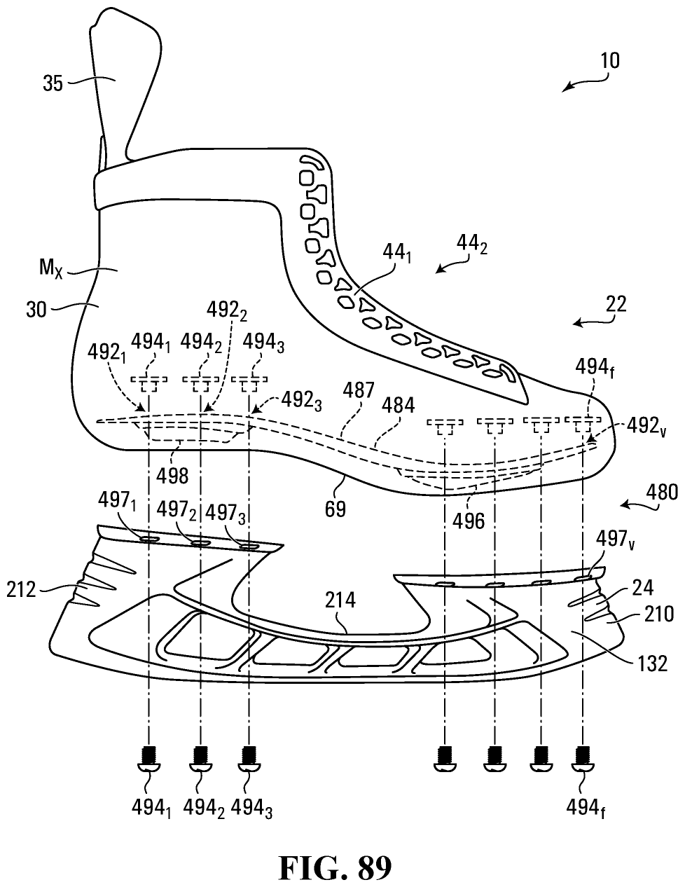

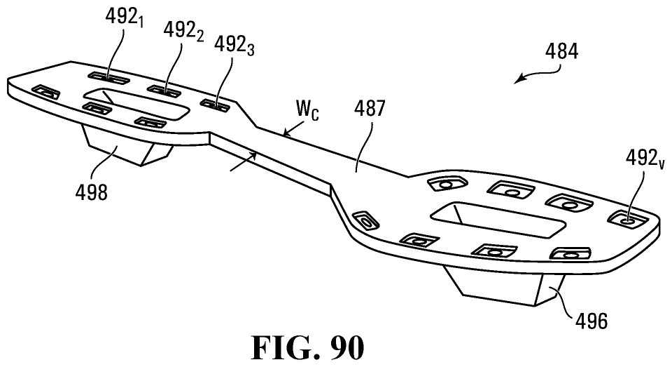

For example, in some embodiments, as shown in FIGS. 88 to 90, the shell 30 of the skate boot 22, the tendon guard 35, the lace members 44₁, 44₂, the toe cap 32 and the tongue 34 may be formed integrally with one another in the molding apparatus 150, while the blade holder 24 may be manufactured separately and connected to the skate boot 22 after the shell 30 of the skate boot 22 and these other components have been molded together in the molding apparatus 150. To that end, the skate boot 22 comprises a connection system 480 configured to attach the blade holder 24 to the skate boot 22.

In this embodiment, the connection system 480 comprises a connecting member 484 that is an insert placed in the molding apparatus 150 to mold the shell 30 of the skate boot 22 onto the connecting member 484 and configured to be fastened to the blade holder 24. The connecting member 484 is therefore retained in the skate boot 22 by molding of the shell 30 of the skate boot 22 over it, i.e., the shell 30 of the skate boot 22 is overmolded on the connecting member 484. More specifically, in this example, the sole portion 69 of the skate boot 22 is molded on the connecting member 484. In this case, the connecting member 484 extends from a heel region of the skate boot 22 to a toe region of the skate boot 22.

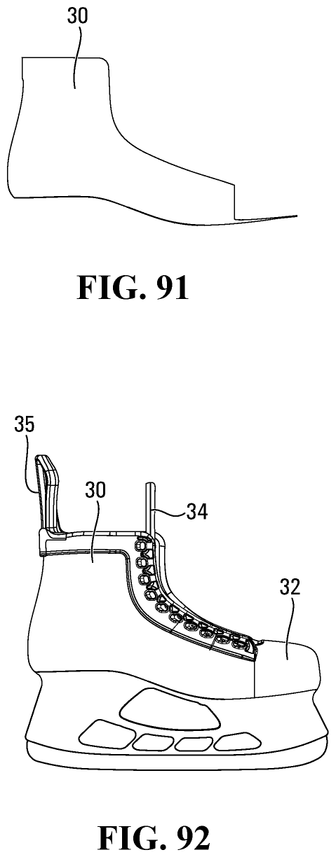

As another example, in some embodiments, as shown in FIG. 91, the shell 30 of the skate boot 22 may be formed alone in the molding apparatus 150, i.e., separately from the toe cap 32, the tongue 34, the tendon guard 35, the footbed 38 and the lace members 44₁, 44₂. As shown in FIG. 92, the toe cap 32, the tongue 34, the tendon guard 35, the footbed 38 and the lace members 44₁, 44₂ may be attached to the shell 30 after the shell 30 has been formed. For instance, any given one of the toe cap 32, the tongue 34, the tendon guard 35, the footbed 38 and the lace members 44₁, 44₂ may be formed on the shell 30 in a separate molding process similar to the one described above in respect of the shell 30. For example, the given one of the toe cap 32, the tongue 34, the tendon guard 35, the footbed 38 and the lace members 44₁, 44₂ may be overmolded onto the shell 30. In some cases, the given one of the toe cap 32, the tongue 34, the tendon guard 35, the footbed 38 and the lace members 44₁, 44₂ may be formed separately from the shell 30 during another molding process (e.g., a thermoforming process) and attached to the shell 30 via a fastener (e.g., stitching, stapling, etc.) or via gluing (e.g., using an adhesive).

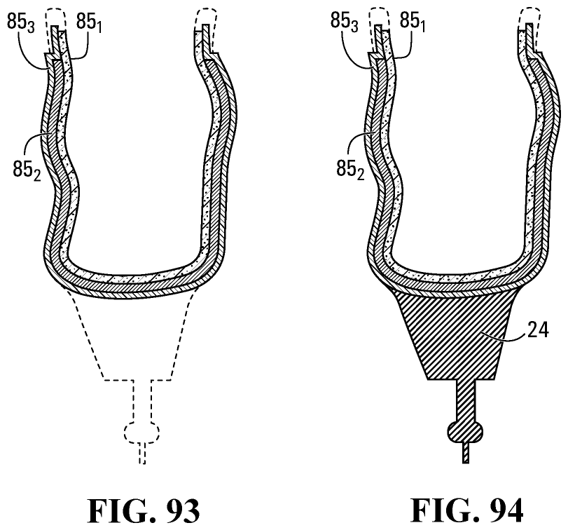

As shown in FIGS. 93 and 94, in some embodiments, the blade holder 24 may be formed separately from the internal, intermediate and external subshells 85₁, 85₂, 85₃ of the shell 30.

In such embodiments where the shell 30 and possibly one or more other components of the skate boot 22 are manufactured separately from the blade holder 24, the skate boot 22 may comprise an outsole 42. The outsole 42 is affixed to an underside of the shell 30 for forming the skate boot 22. The outsole 42 comprises a rigid material for imparting rigidity to the outsole 42. More particularly, in this embodiment, the rigid material of the outsole 42 comprises a composite material. For example, the composite material may be a fiber-matrix composite material that comprises a matrix in which fibers are embedded. The matrix may include any suitable polymeric resin, such as a thermosetting polymeric material (e.g., polyester, vinyl ester, vinyl ether, polyurethane, epoxy, cyanate ester, etc.), a thermoplastic polymeric material (e.g., polyethylene, polypropylene, acrylic resin, polyether ether ketone, polyethylene terephthalate, polyvinyl chloride, polymethyl methacrylate, polycarbonate, acrylonitrile butadiene styrene, nylon, polyimide, polysulfone, polyamide-imide, self-reinforcing polyphenylene, etc.), or a hybrid thermosetting-thermoplastic polymeric material. The fibers may be made of any suitable material such as carbon fibers, polymeric fibers such as aramid fibers, boron fibers, glass fibers, ceramic fibers, etc. In other embodiments, the rigid material may comprise any other suitable material (e.g., nylon, polycarbonate materials, polyurethane, thermoplastics, thermosetting resins, reinforced thermoplastics, reinforced thermosetting resins, polyethylene, polypropylene, high density polyethylene).

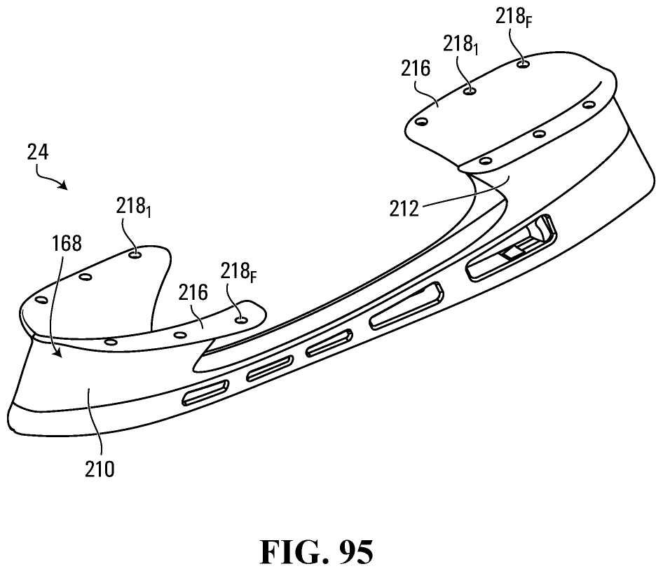

Moreover, in such embodiments where the skate boot 22 and the blade holder 24 are manufactured separately, the support 168 of the blade holder 24 and the skate boot 22 may be affixed to one another in any suitable way. For example, in some embodiments, as shown in FIG. 95, the front and rear pillars 210, 212 are fastened to the skate boot 22 by fasteners (e.g., rivets, screws, bolts). In this example, each of the front and rear pillars 210, 212 comprises a flange 216 including a plurality of apertures 218₁-218_{F} to receive respective ones of the fasteners that fasten the blade holder 24 to the skate boot 22. The support 168 may be affixed to the skate boot 22 in any other suitable manner in other embodiments (e.g., by an adhesive).

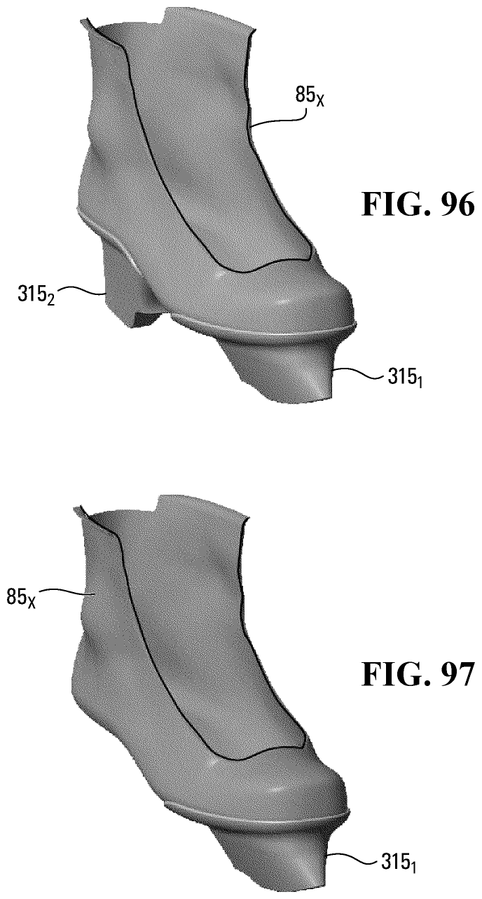

In another variant, the shell 30 and/or the blade holder 24 and/or another component of the skate boot 22 that is made integrally with the shell 30 may comprise one or more inserts 315₁-315_{N} over which one or more of the subshells 85₁-85_{L} may be molded. For instance, as shown in FIG. 96, in this example, the blade holder 24 comprises a front insert 315₁ and a rear insert 315₂ which respectively make up a part of the front and rear pillars 210, 212. More particularly, in this example of implementation, the front and rear inserts 315₁, 315₂ make up at least a majority (i.e., a majority or an entirety) of the front and rear pillars 210, 212 of the support 168 of the blade holder 24. In this example, the front and rear inserts 315₁, 315₂ are affixed to the shell 30 during the molding process of the shell 30 in order to make the blade holder 24 integrally with the shell 30. For example, once a given number of the subshells 85₁-85_{L} are molded, the front and rear inserts 315₁, 315₂ are affixed to the formed subshells 85₁-85_{L} (e.g., by gluing, taping, or any other suitable way) and one or more other ones of the subshells 85₁-85_{L}, in this case the exterior subshell 85₃, is molded over the front and rear inserts 315₁, 315₂ and the formed subshells 85₁-85_{L} such as to form a continuous subshell 85₃ extending from the shell 30 to the blade holder 24. In other cases, as shown in FIG. 97, the blade holder 24 may comprise a single one of the inserts 315₁, 315₂ (e.g., only the front insert 315₁ or only the rear insert 315₂).

In this embodiment, the shell 30 of the skate boot 22 is overmolded onto the tendon guard 35. More specifically, in this embodiment, respective ones of the subshells 85₁-85₃ are overmolded onto the tendon guard 35. To that end, the tendon guard 35 comprises an anchor 89 overmolded by the shell 30 of the skate boot 22.

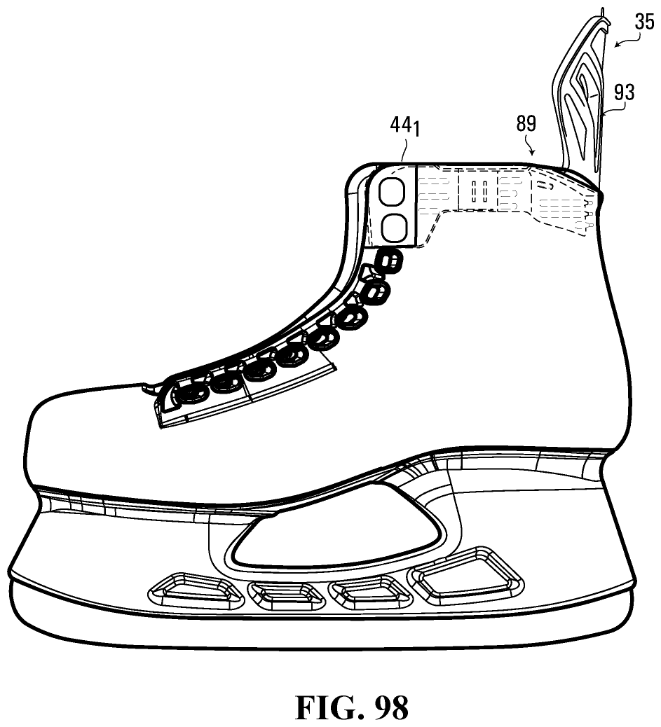

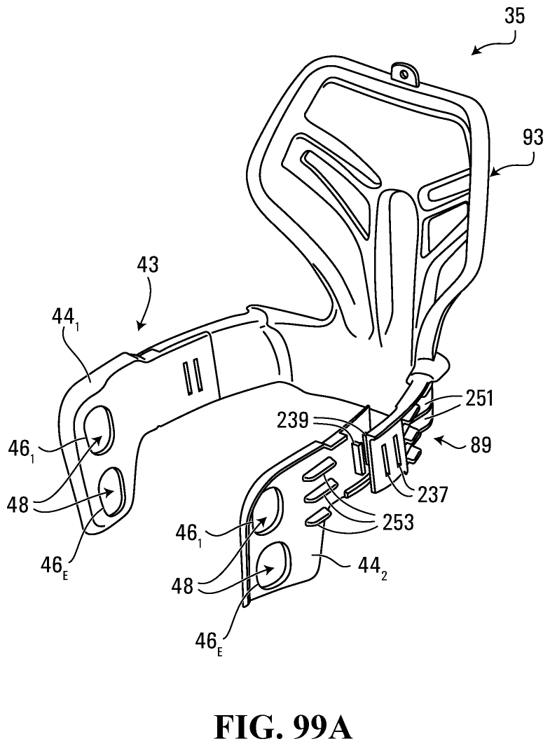

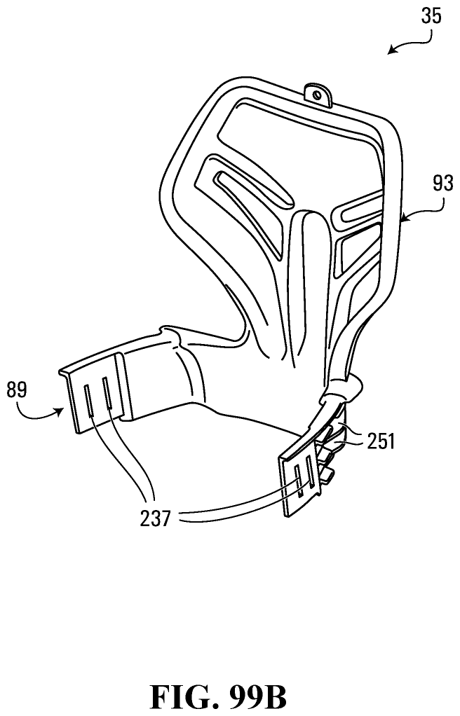

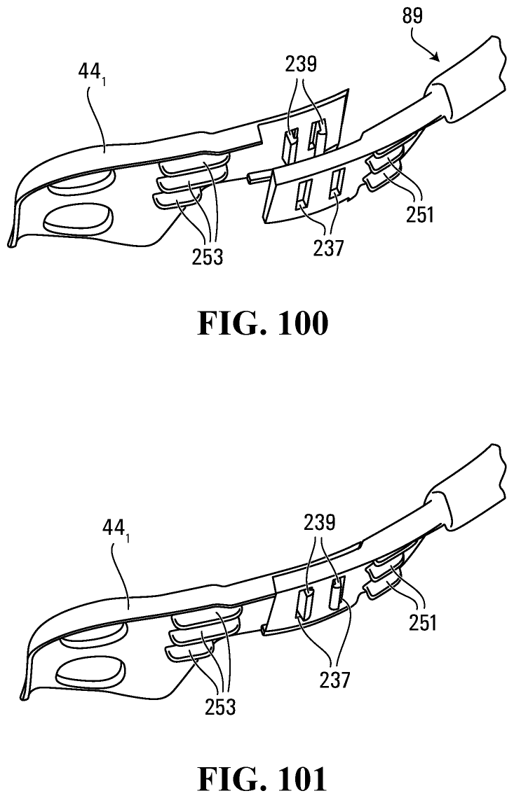

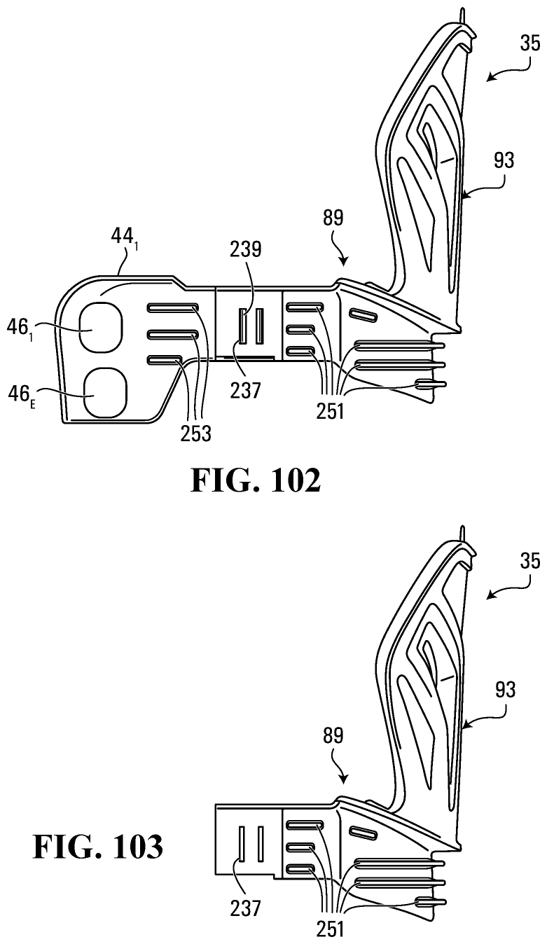

For instance, as shown in FIGS. 98 to 103, in various embodiments, the anchor 89 of the tendon guard 35 may have a shape facilitating overmolding by the shell 30 of the skate boot 22 such as by being configured for creating a mechanical interlock with the shell 30 of the skate boot 22 after overmolding. For example, the anchor 89 of the tendon guard 35 may comprise an interlocking hollow space and the shell 30 of the skate boot 22 may comprise an interlocking part extending in the interlocking hollow space to interlock the tendon guard 35 and the shell 30. In some embodiments, the anchor 89 of the tendon guard 35 may include projections 251 creating a mechanical interlock holding the tendon guard 35 and the shell 30 together after the respective ones of the subshells 85₁-85₃ of the shell 30 are overmolded on the tendon guard 35. For instance, in this embodiment, the projections 251 include ribs extending in the longitudinal direction of the skate 10. In some embodiments, the anchor 89 of the tendon guard 35 may include one or more voids (e.g., recesses, holes, or other openings) creating a mechanical interlock holding the tendon guard 35 and the shell 30 together after the respective ones of the subshells 85₁-85₃ of the shell 30 are overmolded on the tendon guard 35.

In this example, the anchor 89 of the tendon guard 35 is a lower portion affixed to the shell 30 by overmolding of the at least one of the subshells 85₁-85₃ and the tendon guard 35 also comprises an upper portion 93 free of overmolding.

In this embodiment, the anchor 89 of the tendon guard 35 extends forwardly and is overmolded by the ankle portion 64 of the shell 30 of the skate boot 22. By virtue of its forward extension, the anchor 89 of the tendon guard 35 may enhance retention of the tendon guard 35 on the shell 30 of the skate boot 22 and/or durability of the skate boot 22.

More particularly, in this embodiment, the anchor 89 of the tendon guard 35 extends forwardly and is overmolded by at least one of the medial and lateral ankle portions 74, 76 of the shell 30 of the skate boot 22 that face the medial and lateral sides of the player's ankle A. In this example, the anchor 89 of the tendon guard 35 extends forwardly and is overmolded by each of the medial and lateral ankle portions 74, 76 of the shell 30 of the skate boot 22.

In this embodiment, the anchor 89 of the tendon guard 35 extends above each of the medial and lateral depressions 78, 80 of the medial and lateral ankle portions 74, 76 of the shell 30 of the skate boot 22 and extends forwardly to overlap each of the medial and lateral depressions 78, 80 of the medial and lateral ankle portions 74, 76 of the shell 30 of the skate boot 22 in the longitudinal direction of the skate boot 22. That is, the anchor 89 of the tendon guard 35 extends forwardly so as to reach medial and lateral points that are located above the medial and lateral depressions 78, 80 of the medial and lateral ankle portions 74, 76 of the shell 30 of the skate boot 22 and that are located at positions of the medial and lateral depressions 78, 80 of the medial and lateral ankle portions 74, 76 of the shell 30 of the skate boot 22 in the longitudinal direction of the skate boot 22. In this example, the anchor 89 of the tendon guard 35 extends forwardly past these medial and lateral points that are located above the medial and lateral depressions 78, 80 of the medial and lateral ankle portions 74, 76 of the shell 30 of the skate boot 22 and that are located at the positions of the medial and lateral depressions 78, 80 of the medial and lateral ankle portions 74, 76 of the shell 30 of the skate boot 22 in the longitudinal direction of the skate boot 22

Furthermore, in this embodiment, the anchor 89 of the tendon guard 35 extends forwardly and reaches the lacing system 43. In this example, the anchor 89 of the tendon guard 35 extends forwardly and reaches each of the lacing members 44₁, 44₂.

More particularly, in this embodiment, the anchor 89 of the tendon guard 35 engages and is affixed to each of the lacing members 44₁, 44₂. In this example, a given one of (i) the anchor 89 of the tendon guard 35 and (ii) each of lacing members 44₁, 44₂ comprises one or more connecting void 237 and an other one of (i) the anchor 89 of the tendon guard 35 and (ii) each of the lacing members 44₁, 44₂ comprises one or more connecting projections 239 that project into the one or more connecting voids 237 for interconnecting the anchor 89 of the tendon guard 35 and each of the lacing members 44₁, 44₂.

In this example, the connecting voids 237 and projections 239 extend in the heightwise direction of the skate boot 22. In some embodiments, the connecting voids 237 and projections 239 may have any suitable shape. For instance, as shown in FIG. 105, in some embodiments, the connecting voids 237 and projections 239 may extend in the longitudinal direction of the skate boot 22.

In this example of implementation, the shell 30 of the skate boot 22 is overmolded onto each of the lacing members 44₁, 44₂ at least at an interface of each of the lacing members 44₁, 44₂ and the anchor 89 of the tendon guard 35. More particularly, in this case, an entirety of each of the lacing members 44₁, 44₂ is overmolded by the shell 30 of the skate boot 22. In some embodiments, the lacing members 44₁, 44₂ may include projections 253 creating a mechanical interlock holding the lacing members 44₁, 44₂ and the shell 30 together after the respective ones of the subshells 85₁-85₃ of the shell 30 are overmolded on the lacing members 44₁, 44₂. For instance, in this embodiment, the projections 253 include ribs extending in the longitudinal direction of the skate 10. In some embodiments, the lacing members 44₁, 44₂ may include one or more voids (e.g., recesses, holes, or other openings) creating a mechanical interlock holding the lacing members 44₁, 44₂ and the shell 30 together after the respective ones of the subshells 85₁-85₃ of the shell 30 are overmolded on the lacing members 44₁, 44₂.

In this embodiment, the anchor 89 of the tendon guard 35 engages and is affixed to each of the lacing members 44₁, 44₂ before the shell 30 is overmolded onto the lacing members 44₁, 44₂ and the anchor 89 of the tendon guard 35. More specifically, in this embodiment, the connecting projections 239 are placed into the connecting voids 237 to connect and affix the anchor 89 of the tendon guard 35 and each of the lacing members 44₁, 44₂ prior to the molding of the shell 30.

The anchor 89 of the tendon guard 35 and the lacing members 44₁, 44₂ may be dimensioned to fit a specific foot size and/or a specific ankle size. For instance, in some embodiments, dimensions of the anchor 89 of the tendon guard 35 and the lacing members 44₁, 44₂ may be smaller in the longitudinal direction of the skate boot 22 and in the widthwise direction of the skate boot 22 for lower foot sizes (e.g., US foot size 8) than for bigger foot sizes (e.g., US foot size 11). In some embodiments, the tendon guard 35 and/or lacing members 44₁, 44₂ having a specific set of pre-determined dimensions may be configured to be used in a skate boot 22 having a foot size that is within a range, e.g., between US foot size 8 and US foot size 9.5. As such, in this embodiment, there may be provided a set of skate boots 22 of different sizes, the set of skate boots 22 comprising: (i) a first subset of at least two different skate boots 22 having different foot sizes and having a tendon guard 35 and lacing members 44₁, 44₂ of the same dimensions; and (ii) a second subset of at least two different skate boots 22 having different foot sizes and having a tendon guard 35 and lacing members 44₁, 44₂ of different dimensions.

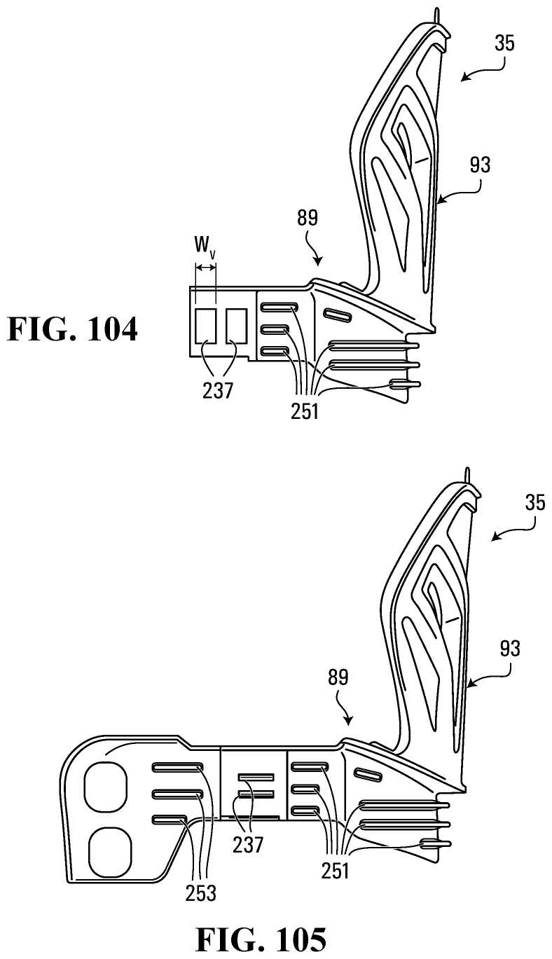

In some embodiments, as shown in FIG. 104, the connecting voids 237 may have a width Wv that is larger than a width of the connecting portions 239 and which may allow an adjustment of a length of the assembly of the tendon guard 35 with lacing members 44₁, 44₂, e.g., to fit a specific foot size and/or a specific ankle size. The enlarged width Wv of the connecting voids 237 may also allow an adjustment of an orientation of the tendon guard 35 relative to the lacing members 44₁, 44₂ and consequently relative to the longitudinal direction of the skate boot 22 after the shell 30 is formed.

In some embodiments, as shown in FIG. 108, the connecting voids 237 may comprise a specific number of voids 237, the connecting projections 239 may comprise a specific number of projections 239, and the specific number of voids 237 may be greater than the specific number of projections 239. This may allow different relative positions of the tendon guard 35 relative to the lacing members 44₁, 44₂, providing a length of the assembly of the tendon guard 35 with the lacing members 44₁, 44₂ that is adjustable before molding of the shell 30, and as such, this may allow the tendon guard 35 and the lacing members 44₁, 44₂, to fit a larger range of foot sizes and/or ankle sizes.

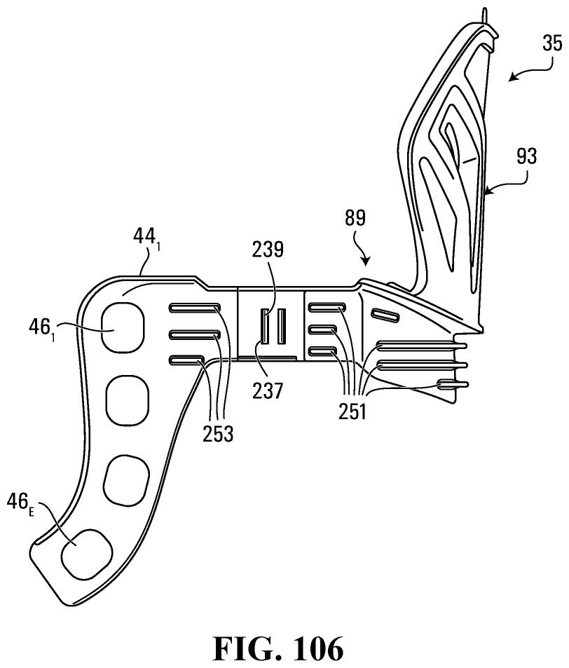

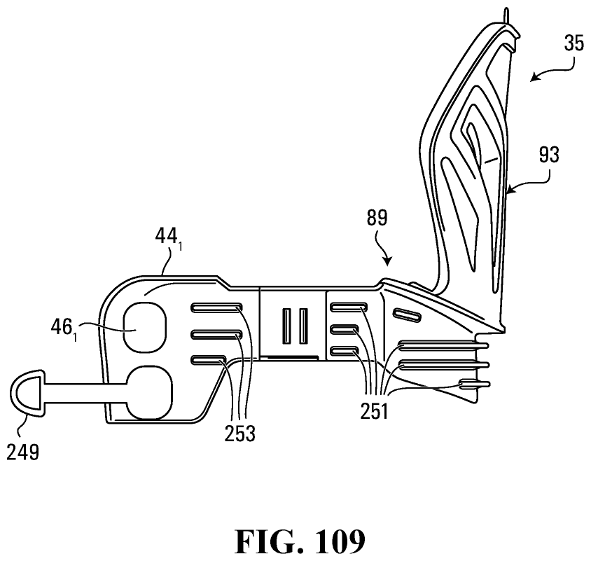

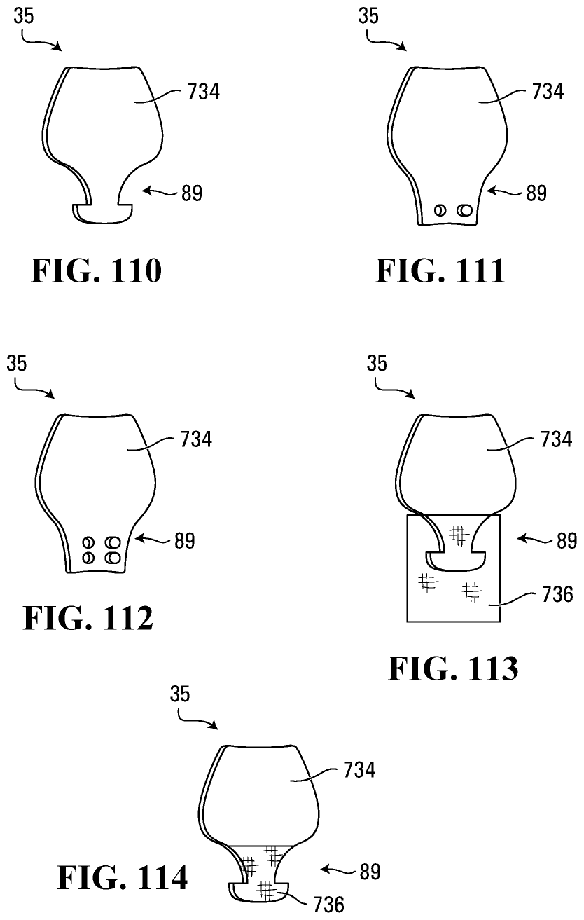

In this embodiment, the lacing member 44₁, 44 that are affixed to the anchor 89 of the tendon guard 35 may include only two, four (e.g., as shown in FIG. 106) or otherwise fewer than all the eyelets 46₁-46_{E} and the apertures 48 for the lace of the skate boot 22. In other embodiments, the lacing members 44₁, 44₂ together include all of the eyelets 46₁-46_{E} and the apertures 48. In some embodiments, as shown in FIG. 109, the lacing member 44₁, 44 that are affixed to the anchor 89 of the tendon guard 35 may also include one or more lace locks 249 comprising an aperture for the lace of the skate boot 22 and configured to lock the lace of the skate boot 22 once tighten.

In this embodiment, the tendon guard 35 comprises a material 734 that is different from the materials M₁-M_{L} of the shell 30 of the skate boot 22 at the overmold. The material 734 may be more flexible (i.e., less stiff) to adjust support to the user's foot 11 during a plantar flexion, to increase comfort of the skate boot 22 and to increase durability. For instance, in some embodiments, a ratio of a modulus of elasticity of the material 734 over a modulus of elasticity of a given one of the materials M₁-M_{L} of the shell 30 of the skate boot 22 may be no more than 0.9, in some embodiments no more than 0.7, in some embodiments no more than 0.5, in some embodiments even less. In other embodiments, the material 734 may be stiffer than the materials M₁-M_{L} of the shell 30 to adjust support to the user's foot 11 during a plantar flexion.

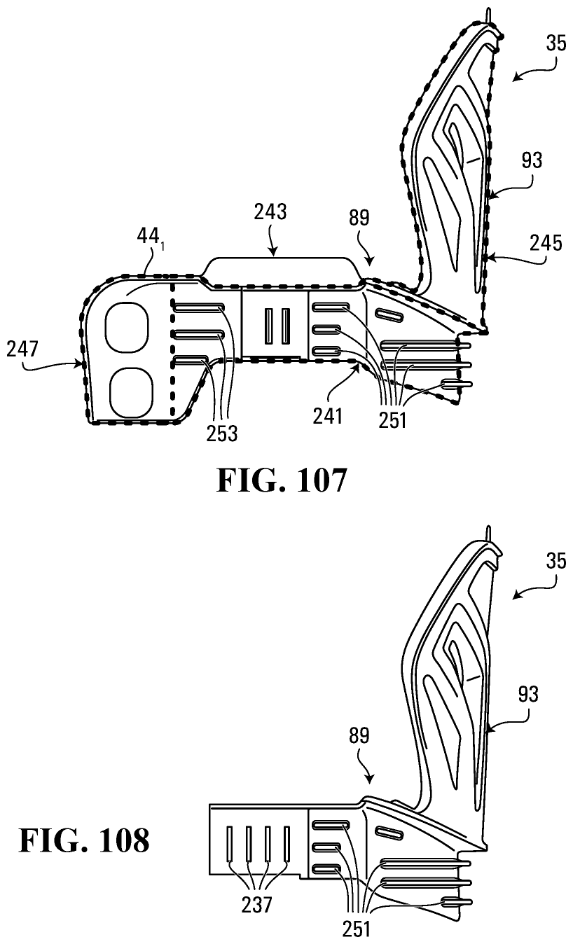

In some embodiments, as shown in FIG. 107, the tendon guard 35 and the lacing members 44₁, 44₂ may comprise a plurality of portions 241, 243, 245, 247 having different mechanical properties. For instance, the portions 241, 243, 245, 247 may have different stiffnesses. In some embodiments, this may be implemented by having different materials and/or dimensions in the different portions 241, 243, 245, 247. For instance, in this example, the portion 241 may be an anchor portion and may be configured to be relatively stiff, the portion 243 may be a comfort edge and may be configured to be more flexible than the anchor portion 241 to provide comfort to the wearer, the portion 245 may correspond to the upper portion 93 of the tendon guard and may be configured to protect the Achille's tendon of the wearer, and the portion 247 may be an exposed portion of the lacing members 44₁, 44₂ and may be configured to have a stiffness that is higher than the comfort edge 243 and different (e.g., lower) than the anchor portion 241.

The material 734 of the tendon guard 35 may be implemented in any suitable way. In this embodiment, the material 734 may be a polymeric material. For example, in this embodiment, the material 734 is a polyester elastomer including is a thermoplastic resin. Any other suitable polymer may be used in other embodiments (e.g., polypropylene, ethylene-vinyl acetate (EVA), nylon, polyurethane (PU), vinyl, polyvinyl chloride, polycarbonate, polyethylene, an ionomer resin (e.g., Surlyn®), styrene-butadiene copolymer (e.g., K-Resin®) etc.), self-reinforced polypropylene composite (e.g., Curv®), or any other thermoplastic or thermosetting polymer).

In some embodiments, as shown in FIGS. 113 and 114, the material 734 of the tendon guard 35 may comprise one or more layers 736 of fabric to enhance overmolding, such as by creating a relief on a surface of the portion 744 of the tendon guard 35. In some embodiments, the layer 736 may be a woven layer, while in other embodiments, the layer 736 may be a non-woven layer. For instance, the fabric of the layer of fabric 736 may comprise nylon, cotton, polyester, glass fibers, carbon fibers and/or any suitable material.

As another example, in some embodiments, instead of being injection molded in the molding apparatus 150 as discussed above, one or more of the subshells 85₁-85_{L} of the shell 30 of the skate boot 22 may be formed differently in the molding apparatus. For instance, one or more of the subshells 85₁-85_{L} of the shell 30 of the skate boot 22 may be molded in a mold of the molding apparatus 150 using pellets (e.g., beads) of polymeric material (e.g., polypropylene, polyethylene, etc.) that are expanded and cured in the mold to create foam. In order to form a subshell 85ᵢ, the beads may be combined with a blowing agent and/or comprise two or more constituents of a given polymeric material Mₓ which chemically react when combined to polymerize and optionally release heat. In some cases, to initiate and/or to maintain an expansion and/or polymerization reaction, heat, such as by steaming, electromagnetic radiation and/or acoustic radiation, may be applied to the beads to make them foam. After expansion and/or polymerization, the subshell 85ᵢ is formed and has a shape generally corresponding to the shape of the mold. In this example, the mold cavity is filled with a pre-determined quantity of beads and the mold may be closed prior to polymerisation, such that there is substantially no flow. In other examples, the beads may be injected into the mold through a mold injection gate, prior to or during polymerization of the beads.

As another example, in some embodiments, one or more of the subshells 85₁-85₃ may be formed differently than by molding by flowing. For instance, the one or more of the subshells 85₁-85₃ may be thermoformed. For example, one or more of the subshells 85₁-85₃ may be formed using a sheet of material that is heated and molded over (e.g., pressed onto) a last. The one or more of the subshells 85₁-85₃ may be affixed to underlying ones and/or overlying ones of the subshells 85₁-85₃ by any suitable means, such as may mechanical interlock, by fastening, etc. As another example, one or more of the subshells 85₁-85₃ may be formed using a sheet of material that is heated and molded over an underlying one of the subshells 85₁-85₃ that is already formed.

In some embodiments, the thermoformed subshell 85ᵢ may cover an entirety of the surface of the shell 30. In this case, the thermoformed subshell 85ᵢ substantially covers every portion of the user's foot 11 that is covered by the shell 30. In other embodiments, the thermoformed subshell 85ᵢ may cover a portion of the skate boot 22; that is, the thermoformed subshell 85ᵢ covers some, but not all, portions of the user's foot 11 that are covered by the shell 30. For instance, the thermoformed subshell 85ᵢ may comprise a toe cap that is thermoformed and incorporated in the shell 30 while the remainder of the shell 30 is molded by flowing.

The thermoformed subshell 85ᵢ may be provided at any stage of the manufacturing process of the skate boot 22. For instance, in some embodiments, the thermoformed subshell 85ᵢ is provided and attached to the last 152 (e.g., by fastening) before the internal subshell 85₁ is produced. In some embodiments, the thermoformed subshell 85ᵢ is provided and attached to the remainder of the shell 30 after the remainder of the shell 30 is produced (e.g., by a molding by flowing process) by any suitable means, such as by being stitched or fastened to an underlying subshell 85_{y}. In some embodiments, the thermoformed subshell 85ᵢ is provided after some, but not all, of the subshells 85₁-85_{L} are produced (e.g., by a molding by flowing process). In this example, the thermoformed subshell 85ᵢ may be attached to (e.g., by being stitched to, by being fastened to) an underlying one of the subshells 85₁-85_{L} already molded.

For instance, in some embodiments, the thermoformed subshell 85ᵢ may be the insole 40, as shown in FIGS. 39 to 41.

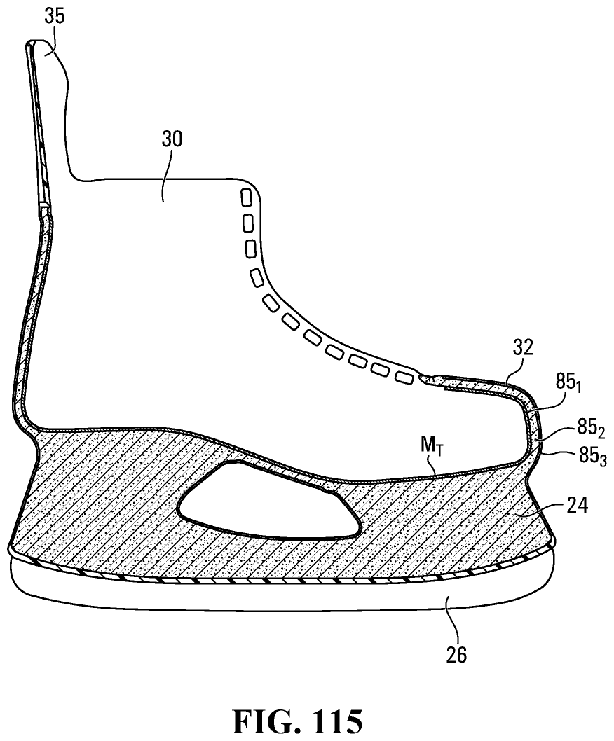

As another example, in some embodiments, as shown in FIG. 115 one or more of the subshells 85₁-85₃ may be thermoformable, as described in U.S. patent application Ser. No. 14/867,962, which is incorporated herein. For instance, one or more of the polymeric materials M₁-M_{N} of the shell 30 may be thermoformable such that, prior to use, the skate boot 22 may be heated to a first temperature T₁, the user may wear the heated skate boot 22 in a relatively tight manner such that the user's foot 11 compresses and impart its shape to the skate boot 22 and the polymeric materials M₁-M_{N} of the shell 30. This may allow, notably, a more customizable fit.

In this embodiment, the thermoformable material M_{T} might preserve physical properties such as rigidity after the thermoformable material M_{T} is thermoformed to conform to the user's foot 11. For instance, after the thermoformable material M_{T} is thermoformed to conform to the user's foot 11, the thermoformable material M_{T} may have a modulus of elasticity and a yield strength. The thermoformable material M_{T} may thus deform when subject to a load and may regain its shape imparted by the thermoforming process to conform to the user's foot 11 after load is removed.

In some embodiments, the thermoformable material M_{T} may be a shape-memory material. That is, after the thermoformable material M_{T} is thermoformed, the thermoformable material M_{T} may be heated to a temperature T₂ to expand and regain an original shape, i.e., the shape of the thermoformable material M_{T} before the thermoforming process having imparted the shape of the user's foot 11 to the skate boot 22 and to the material M_{T}.

In some embodiments, after the thermoformable material M_{T} is heated to a temperature T₂ to expand and regain an original shape, the thermoformable material M_{T} may again be thermoformed such that the user's foot 11 compresses and impart its shape to the skate boot 22 and the polymeric materials M₁-M_{N} of the shell 30.

The temperature T₂ may be equal or greater (i.e. hotter) than the temperature T₁. That is, in some embodiments, the temperature T₂ may be approximately equal to the temperature T₁. In some embodiments, the temperature T₂ may be at least 50° C. warmer than the temperature T₁, in some embodiments at least 100° C. warmer, in some embodiments at least 200° C., in some embodiments even more.

The temperature T₁ may be low enough to ensure that the user's foot 11 compressing the skate boot 22 during thermoforming does not get burnt. For example, in some embodiments, the temperature T₁ may be no more than 100° C., in some embodiments no more than 80° C., in some embodiments no more than 60° C., in some embodiments even less.

The thermoformable material M_{T} may be of any nature. For instance, in this embodiment, the thermoformable material M_{T} comprises a polymeric material. More specifically, in this embodiment, the thermoformable material M_{T} comprises a foam material.

In this embodiment, the thermoformable subshell comprising the thermoformable material M_{T} is the internal subshell 85₁. In some embodiments, the pads 760₁-760_{P} may comprise the thermoformable material M_{T}.

As another example, in some embodiments, the skate boot 22 may be made using any other manufacturing processes, including conventional ones (e.g., using a conventional lasting machine, thermoforming, etc.), while including one or more features discussed herein, such as, for example, the heel-locking member 756, the graphic elements 121 on the toe cap 32, an overmolded connection for the tendon guard 35, etc.

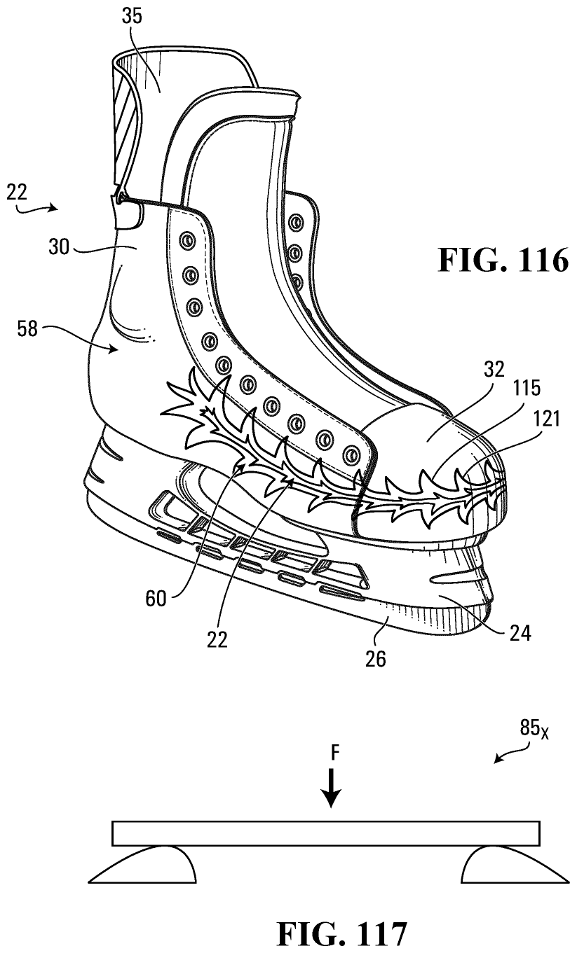

For instance, in some embodiments, as shown in FIG. 116, the skate boot 22 is made using a standard toe cap 32 which is not integrally made with the shell 30 of the skate boot 22. In this embodiment, the skate boot 22 comprises one or more design elements 121 which may be disposed over various portions of the shell 30 and/or over various other portions of the skate boot 22, for instance over the medial side portion 68 of the shell 30, over the lateral side portion 66 of the shell 30, over a top portion of the shell 30, and so on, and may also be disposed over the toe cap 32, over the tongue 34, over the tendon guard 35, over the liner 36, over the footbed 38, over the insole 40, over the lace members 44₁, 44₂, over the eyelets 46₁-46_{E}, and so on. For instance, the design elements 121 may be disposed at least on a side of the toe cap 32. In this example, the design elements 121 are disposed on a medial side, on a lateral side and on a top side of the toe cap 32.

The design elements 121 may cover at least a substantial part (i.e., a substantial part or an entirety) of a surface area of the toe cap 32 that is externally visible (i.e., visible from outside of the skate boot 22). For instance, in some embodiments, the design elements 121 covers at least a quarter (i.e., 25%), in some embodiments at least a third (i.e., 33%), in some embodiments at least a majority (i.e., at least 50%), in some embodiments at least 75%, and in some embodiments an entirety of the toe cap 32.

Some of the design elements 121 may also be continuous with other design elements 121 of adjacent portions of the skate boot 22. That is, there may be a continuity of the design element 121 between the toe cap 32 of the skate boot and a given one of the medial side portion 68 of the shell 30 and the lateral side portion 66 of the shell 30, thus providing an impression that the design elements 121 extend from a given one of the toe cap 32, the medial side portion 68 and the lateral side portion 66 to another one of the toe cap 32, the medial side portion 68 and the lateral side portion 66. In this embodiment, there is continuity of design elements 121 between the toe cap 32 of the skate boot 30, the medial side portion 68 of the shell 30 and the lateral side portion 66 of the shell 30.

In this embodiment, an external clear layer may be applied over the design elements 121 such that the design elements 121 are visible through the clear layer and such that the clear layer protects the design elements 121 from flying pucks, sticks, etc.

The design elements 121 may include a design pattern, a printed image, and so on. In this embodiment, the design element is a graphic element which includes one or many different colors.

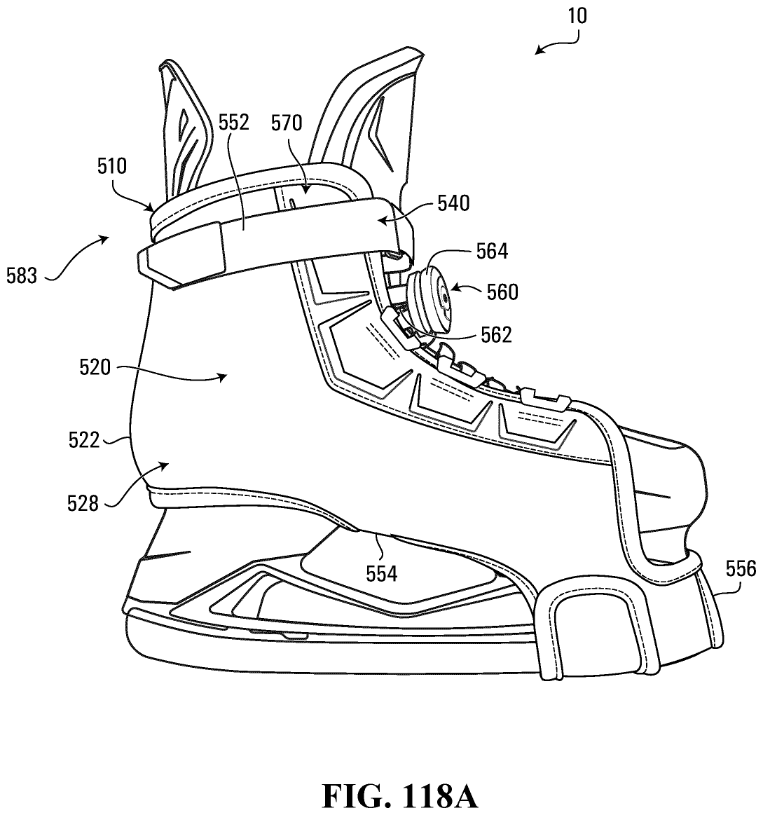

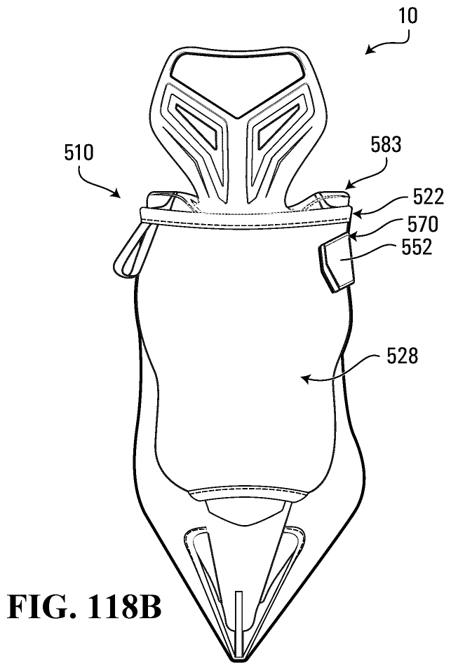

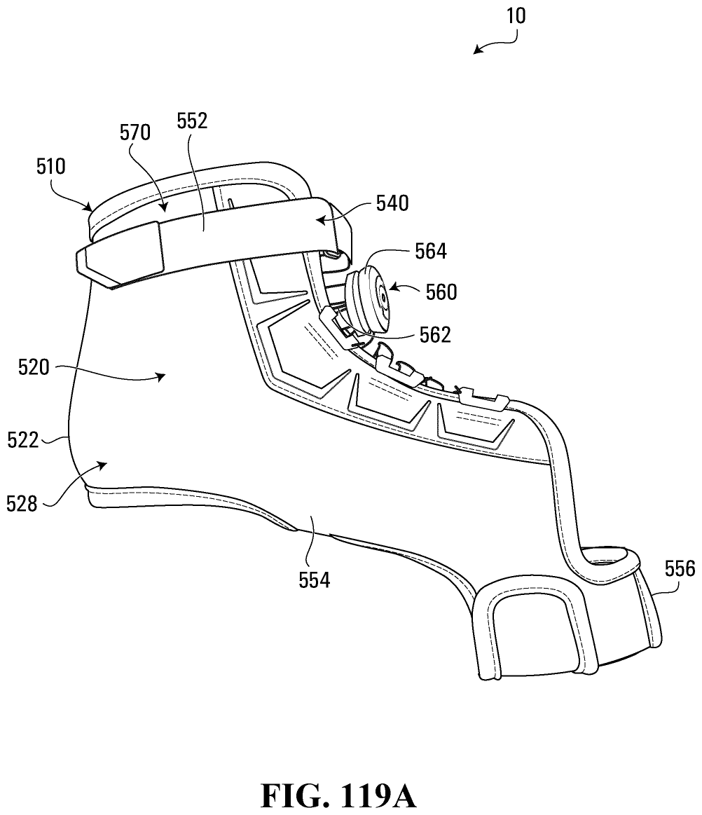

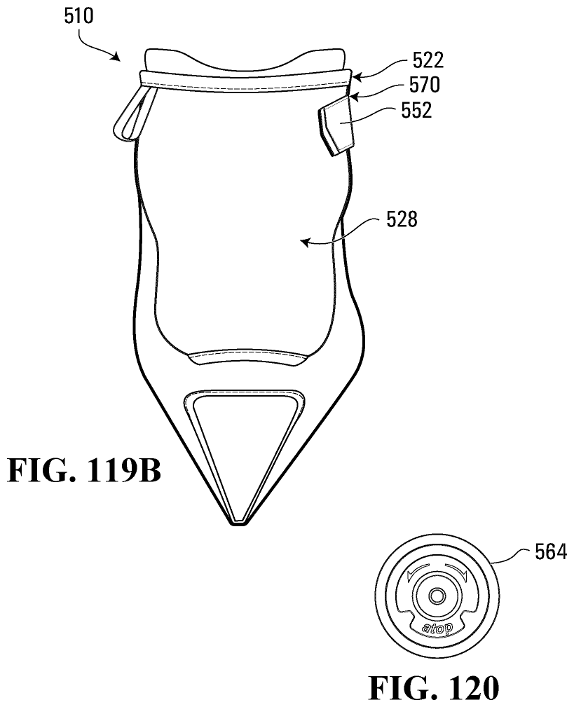

With additional reference to FIGS. 118A to 120, in some embodiments, a sleeve 510 for thermoforming the skate boot 22 on the player's foot can be provided. The skate boot 22 may be thermoformable on the player's foot to be more customized to the player's foot, as discussed above. The skate boot 22 may thus include thermoformable material. For example, in some cases, one or more of the subshells 85₁-85₃ may be thermoformable. In other cases, the shell 30 of the skate boot 22 may have only a single layer (i.e., does not have two or more layers such as the subshells 85₁-85₃). The skate boot 22 (e.g., the skate 10 including the skate boot 22) can be heated to a thermoforming temperature, such as by heating the skate boot 22 in an oven and/or with any other suitable heating device as is conventionally known. With the player's foot in the skate boot 22 once it has been heated to the thermoforming temperature, the skate boot 22 can deform under pressure of the player's foot to better conform to the player's foot.

The sleeve 510 is a jacket or other device that can be placed on and at least partially wrap the skate boot 22 to facilitate thermoforming of the skate boot 22 on the player's foot. Notably, the sleeve 510 may support the skate boot 22 while the player's foot is pressing against the skate boot 22 during thermoforming of the skate boot 22. This can allow a greater degree of thermoformability of the thermoformable material of the skate boot 22, as the sleeve 510 opposes excessive deformation of the skate boot 22 that could otherwise occur in some cases.

In this embodiment, the sleeve 510 comprises a covering 520 configured to cover at least part of the skate boot 22 and a fastening system 540 configured to fasten the covering 520 to the skate boot 22 and support the skate boot 22 while the skate boot 22 is being thermoformed with the player's foot in the skate boot 22.

More particularly, in this embodiment, the covering 520 of the sleeve 510 is configured to cover at least part of each of the medial and lateral side portions 66, 68, the ankle portion 64, and the heel portion 62 of the shell 30 of the skate boot 30. In this example, the covering 520 is also configured to cover at least part of the sole portion 69 of the shell 30 of the skate boot 22.

The covering 520 of the sleeve 510 can be implemented in any suitable way. For example, in this embodiment, the covering 520 comprises a plurality of materials that are different from one another, including, in this case, fabric 522 and molded material 528.

More specifically, in this embodiment, the fabric 522 includes woven fabric (e.g., mesh of nylon of other suitable polymeric material). In this case, the fabric 520 constitutes a majority of a volume of the covering 520. Also, in this embodiment, the molded material 528 is provided where greater stresses are sustained by the sleeve 510 during thermoforming of the skate boot 22 on the player's foot. In this example, the molded material 528 included molded polyurethane, although any other suitable polymeric material may be used in other examples. The different materials of the sleeve 510, including the fabric 522 and the molded material 528, may be affixed together by stitching, adhesive bonding, and/or other means.

In this embodiment, the fastening system 540 of the sleeve 510 comprises a plurality of fasteners 552, 554, 556, 560 spaced from one another. More particularly, in this embodiment, each of the fasteners 552, 554, 556 is a strap, while the fastener 560 is a lacing system comprising a lace 562.

In this example of implementation, each of the straps 552, 554 is configured to secure the covering 520 of the sleeve 510 against the skate boot 22, and the strap 556 is configured to secure the covering 520 against the blade holder 24. More specifically, in this case, the strap 552 is configured to secure an upper portion 570 of the covering 520 against an upper part 583 of the skate boot 22 that includes the ankle portion 64 of the shell 30 of the skate boot 22. The strap 554 is configured to secure a lower portion 572 of the covering 520 against a lower part 585 of the skate boot 22 that includes the medial and lateral side portions 66, 68 of the shell 30 of the skate boot 22. In this case, the strap 554 is configured to extend under the sole portion 69 of the shell 30 of the skate boot 22. The strap 556 is configured to extend under the blade holder 24 (and in this case under the blade 26) beneath the front pillar 210 of the blade holder 24. In this embodiment, the straps 552, 554, 556 include hook-and-loop connecting elements 575 to be closed and secured, but they may include any other suitable connecting elements (e.g., buttons, clips, etc.) in other embodiments.

The lacing system 560 is used to selectively tighten and untighten the lace 562 in an instep region of the skate boot 22 where the tongue 34 is located. In this embodiment, the lacing system 560 comprises an actuator 564 configured to selectively tighten and untighten the lace 462. More particularly, in this embodiment, the actuator 564 is a rotatable actuator configured to be rotated to selectively tighten and untighten the lace 562. For instance, in some embodiments, the lacing system 560 including the lace 562 and the actuator 564 may be a lacing mechanism commercially available from Atop (www.atop-team.com/) or Boa (www.boafit.com/) or any other suitable actuated lacing mechanism. In other embodiments, the lacing system 560 may not have any actuator and may rather be operated by a person manually pulling and otherwise moving the lace 562 to selectively tighten and untighten the lace 562.

In use, the straps 552, 554, 556 may be detached and loosed and the lace 562 may be untightened to allow the sleeve 510 to be placed on the skate boot 22. For instance, the sleeve 510 may be slipped on the skate boot 22 from over the skate boot 22. The straps 552, 554, 556 may then be attached firmly and the lace 562 may be tightened to secure the sleeve 510 on the skate boot 22. When the player's foot is in the skate boot 22 once the skate boot 22 has been heated to the thermoforming temperature, the sleeve 510 can support the skate boot 22 while the player's foot is pressing against the skate boot 22 during thermoforming of the skate boot 22.

In some embodiments, the sleeve 510 may be used to facilitate thermoforming of footwear other than the skate 10. For instance, in some embodiments, the sleeve 510 may be used to facilitate thermoforming of lasted skates, sports boots including alpine ski boots, cross-country ski boots, snowboard boots, cleats, work boots, etc. As such, in some embodiments, the sleeve 510 may be provided in combination with the skate 10, with lasted skates, with sports boots including alpine ski boots, cross-country ski boots, snowboard boots, cleats, etc., and/or with work boots. For instance, in the manner described above, the sleeve 510 may support the footwear while the player's foot is pressing against the footwear during thermoforming of the footwear.

Although in embodiments considered above the skate 10 is designed for playing ice hockey on the skating surface 14 which is ice, in other embodiments, the skate 10 may be constructed using principles described herein for playing roller hockey or another type of hockey (e.g., field or street hockey) on the skating surface 14 which is a dry surface (e.g., a polymeric, concrete, wooden, or turf playing surface or any other dry surface on which roller hockey or field or street hockey is played). Thus, in other embodiments, instead of comprising the blade 26, the skating device 28 may comprise a wheel holder holding a set of wheels to roll on the dry skating surface 14 (i.e., the skate 10 may be an inline skate or other roller skate). The wheel holder may be constructed using principles discussed herein in respect of the blade holder 24. Moreover, in other embodiments, the skate 10 may be a figure skate constructed using principles described herein for figure skating.

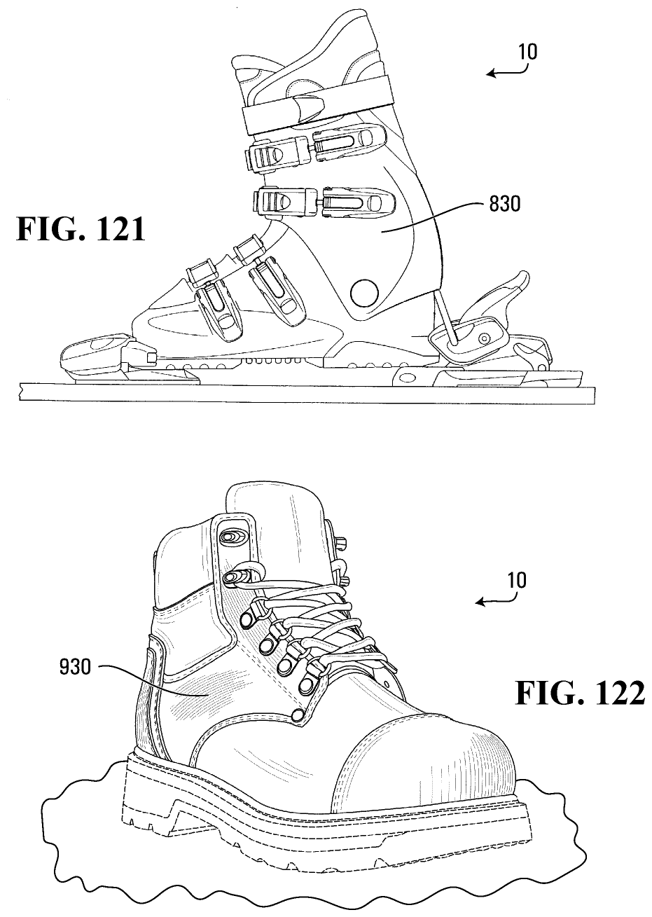

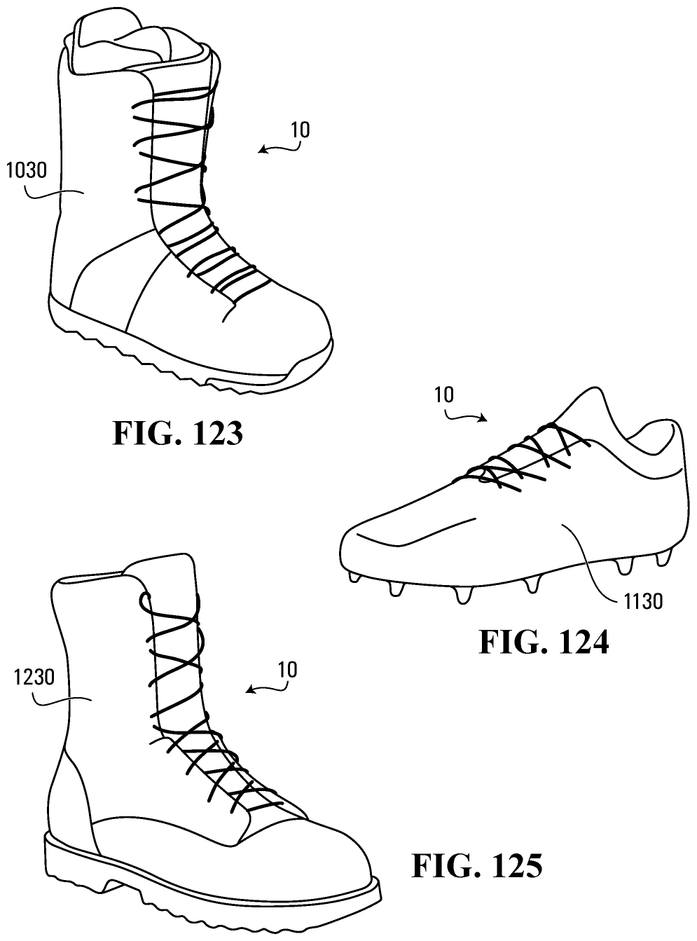

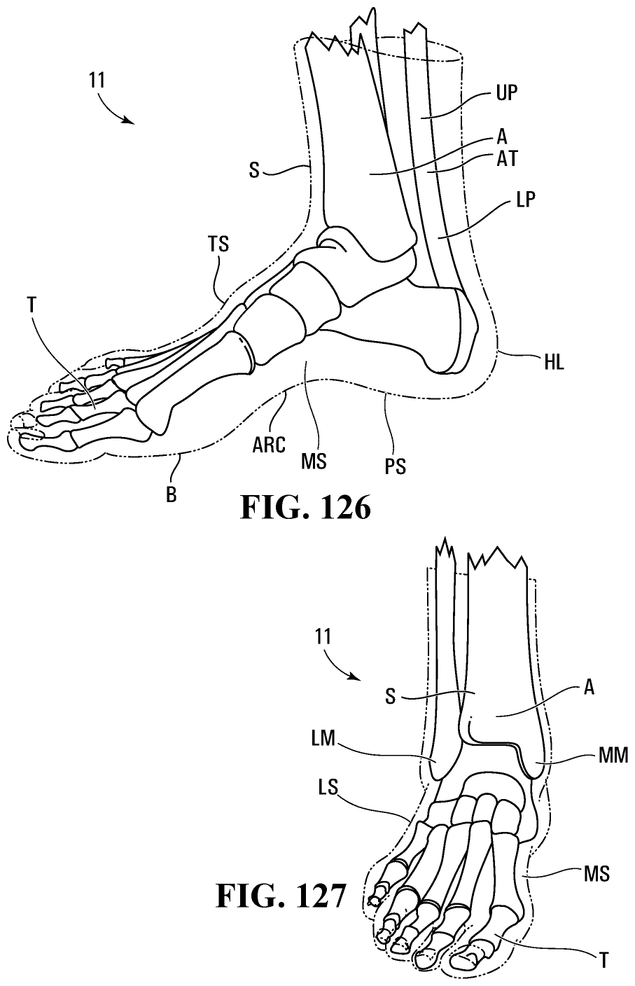

Furthermore, although in embodiments considered above the footwear 10 is a skate for skating on the skating surface 14, in other embodiments, the footwear 10 may be any other suitable type of footwear. For example, as shown in FIG. 121, the footwear 10 may be a ski boot comprising a shell 830 which may be constructed in the manner described above with respect to the shell of the skate. In particular, the ski boot 10 is configured to be attachable and detachable from a ski 802 which is configured to travel on a ground surface 8 (e.g., snow). To that end, the ski boot 10 is configured to interact with an attachment mechanism 800 of the ski 802. In another example, as shown in FIG. 122, the footwear 10 may be a boot (e.g., a work boot or any other type of boot) comprising a shell 930 which can be constructed in the manner described above with respect to the shell of the skate. In another example, as shown in FIG. 123, the footwear 10 may be a snowboard boot comprising a shell 1030 which can be constructed in the manner described above with respect to the shell of the skate. In another example, as shown in FIG. 124, the footwear 10 may be a sport cleat comprising a shell 1130 which can be constructed in the manner described above with respect to the shell of the skate. In another example, as shown in FIG. 125, the footwear 10 may be a hunting boot comprising a shell 1230 which can be constructed in the manner described above with respect to the shell of the skate.

In some embodiments, any feature of any embodiment described herein may be used in combination with any feature of any other embodiment described herein.

Certain additional elements that may be needed for operation of certain embodiments have not been described or illustrated as they are assumed to be within the purview of those of ordinary skill in the art. Moreover, certain embodiments may be free of, may lack and/or may function without any element that is not specifically disclosed herein.

In describing the embodiments, specific terminology has been resorted to for the sake of description but this is not intended to be limited to the specific terms so selected, and it is understood that each specific term comprises all equivalents.

In case of any discrepancy, inconsistency, or other difference between terms used herein and terms used in any document incorporated by reference herein, meanings of the terms used herein are to prevail and be used.

Although various embodiments have been illustrated, this was purposes of describing, but should not be limiting. Various modifications will become apparent to those skilled in the art.

1. A skate boot for a skate, the skate boot being configured to receive a foot of a user and comprising:
a body comprising a medial side portion configured to face a medial side of the user's foot, a lateral side portion configured to face a lateral side of the user's foot, an ankle portion configured to receive an ankle of the user, and a heel portion configured to receive a heel of the user's foot; and
a tendon guard configured to face an Achilles tendon of the user and extending upwardly from the body of the skate boot;
wherein: the body of the skate boot is overmolded onto the tendon guard; and the tendon guard comprises an anchor extending forwardly and overmolded by the ankle portion of the body of the skate boot.

2. The skate boot of claim 1, wherein: the ankle portion of the body of the skate boot comprises a medial ankle portion configured to face a medial side of the user's ankle and a lateral ankle portion configured to face a lateral side of the user's ankle; and the anchor of the tendon guard extends forwardly and is overmolded by at least one of the medial ankle portion and the lateral ankle portion of the body of the skate boot.

3. The skate boot of claim 2, wherein the anchor of the tendon guard extends forwardly and is overmolded by each of the medial ankle portion and the lateral ankle portion of the body of the skate boot.

4. The skate boot of claim 2, wherein: the medial ankle portion of the body of the skate boot comprises a medial depression for receiving a medial malleolus of the user's ankle; the lateral ankle portion of the body of the skate boot comprises a lateral depression for receiving a lateral malleolus of the user's ankle; and the anchor of the tendon guard extends above at least one of the medial depression and the lateral depression of the medial ankle portion and the lateral ankle portion of the body of the skate boot and extends forwardly to overlap the at least one of the medial depression and the lateral depression of the medial ankle portion and the lateral ankle portion of the body of the skate boot in a longitudinal direction of the skate boot.

5. The skate boot of claim 4, wherein the anchor of the tendon guard extends above each of the medial depression and the lateral depression of the medial ankle portion and the lateral ankle portion of the body of the skate boot and extends forwardly to overlap each of the medial depression and the lateral depression of the medial ankle portion and the lateral ankle portion of the body of the skate boot in the longitudinal direction of the skate boot.

6. The skate boot of claim 1, comprising a lacing system configured to receive a lace for tying the skate boot, wherein the anchor of the tendon guard extends forwardly and reaches the lacing system.

7. The skate boot of claim 6, wherein the anchor of the tendon guard engages and is affixed to the lacing system.

8. The skate boot of claim 7, wherein a given one of (i) the anchor of the tendon guard and (ii) the lacing system comprises a connecting void and an other one of (i) the anchor of the tendon guard and (ii) the lacing system comprises a connecting projection that projects into the connecting void for interconnecting the anchor of the tendon guard and the lacing system.

9. The skate boot of claim 6, wherein: the lacing system comprises a medial lacing member and a lateral lacing member that are configured to receive the lace; and the anchor of the tendon guard extends forwardly and reaches each of the medial lacing member and the lateral lacing member.

10. The skate boot of claim 9, wherein the anchor of the tendon guard engages and is affixed to each of the medial lacing member and the lateral lacing member.

11. The skate boot of claim 10, wherein a given one of (i) the anchor of the tendon guard and (ii) each of the medial lacing member and the lateral lacing member comprises a connecting void and an other one of (i) the anchor of the tendon guard and (ii) each of the medial lacing member and the lateral lacing member comprises a connecting projection that projects into the connecting void for interconnecting the anchor of the tendon guard and each of the medial lacing member and the lateral lacing member.

12. The skate boot of claim 6, wherein the body of the skate boot is overmolded onto the lacing system at least at an interface of the lacing system and the anchor of the tendon guard.

13. The skate boot of claim 12, wherein the body of the skate boot is overmolded onto each of the medial lacing member and the lateral lacing member at least at an interface of each of the medial lacing member and the lateral lacing member and the anchor of the tendon guard.

14. The skate boot of claim 13, wherein an entirety of each of the medial lacing member and the lateral lacing member is overmolded by the body of the skate boot.

15. The skate boot of claim 13, wherein each of the medial lacing member and the lateral lacing member comprises a plurality of lacing apertures.

16. The skate boot of claim 15, wherein the lacing apertures include at least eight lacing apertures.

17. The skate boot of claim 1, wherein: the medial side portion, the lateral side portion, the ankle portion, and the heel portion of the body of the skate boot are injection molded with one another; and the body of the skate boot includes a plurality of injection-molded layers that are injection molded with one another.

18. The skate boot of claim 17, wherein respective ones of the injection-molded layers of the body of the skate boot are overmolded onto the tendon guard.

19. The skate boot of claim 1, wherein the anchor of the tendon guard comprises an interlocking hollow space and the body of the skate boot comprises an interlocking part extending in the interlocking hollow space to interlock the tendon guard and the body of the skate boot.

20. The skate boot of claim 19, wherein the interlocking hollow space includes a hole.

21. The skate boot of claim 19, wherein the interlocking hollow space includes a recess.

22. The skate boot of claim 19, wherein the interlocking hollow space comprises a plurality of voids.

23. The skate boot of claim 22, wherein the voids include holes.

24. The skate boot of claim 22, wherein the voids include recesses.

25. The skate boot of claim 1, wherein a material of the tendon guard is different from a material of the body of the skate boot.

26. The skate boot of claim 25, wherein the material of the tendon guard is less stiff than the material of the body of the skate boot.

27. A skate boot for a skate, the skate boot being configured to receive a foot of a user and comprising:
a body comprising a medial side portion configured to face a medial side of the user's foot, a lateral side portion configured to face a lateral side of the user's foot, an ankle portion configured to receive an ankle of the user, and a heel portion configured to receive a heel of the user's foot; and
a tendon guard configured to face an Achilles tendon of the user and extending upwardly from the body of the skate boot;
wherein: the ankle portion of the body of the skate boot comprises a medial ankle portion configured to face a medial side of the user's ankle and a lateral ankle portion configured to face a lateral side of the user's ankle; the body of the skate boot is overmolded onto the tendon guard; and the tendon guard comprises an anchor extending forwardly and overmolded by each of the medial ankle portion and the lateral ankle portion of the body of the skate boot.

28. A skate boot for a skate, the skate boot being configured to receive a foot of a user and comprising:
a body comprising a medial side portion configured to face a medial side of the user's foot, a lateral side portion configured to face a lateral side of the user's foot, an ankle portion configured to receive an ankle of the user, and a heel portion configured to receive a heel of the user's foot;
a tendon guard configured to face an Achilles tendon of the user and extending upwardly from the body of the skate boot; and
a lacing system configured to receive a lace for tying the skate boot;
wherein: the body of the skate boot is overmolded onto the tendon guard; and the tendon guard comprises an anchor extending forwardly, engaging and affixed to the lacing system, and overmolded by the ankle portion of the body of the skate boot.

29. A skate boot for a skate, the skate boot being configured to receive a foot of a user and comprising:
a body comprising a medial side portion configured to face a medial side of the user's foot, a lateral side portion configured to face a lateral side of the user's foot, an ankle portion configured to receive an ankle of the user, and a heel portion configured to receive a heel of the user's foot;
a tendon guard configured to face an Achilles tendon of the user and extending upwardly from the body of the skate boot; and
a medial lacing member and a lateral lacing member configured to receive a lace for tying the skate boot;
wherein: the body of the skate boot is overmolded onto the tendon guard; and the tendon guard comprises an anchor extending forwardly, engaging and affixed to each of the medial lacing member and the lateral lacing member, and overmolded by the ankle portion of the body of the skate boot.

30. A skate boot for a skate, the skate boot being configured to receive a foot of a user and comprising:
a body comprising a medial side portion configured to face a medial side of the user's foot, a lateral side portion configured to face a lateral side of the user's foot, an ankle portion configured to receive an ankle of the user, a heel portion configured to receive a heel of the user's foot, and a toe portion configured to enclose toes of the user's foot; and
a reinforcement affixed to the toe portion of the body of the skate boot;
wherein: the medial side portion, the lateral side portion, the ankle portion, the heel portion, and the toe portion of the body of the skate boot are injection molded with one another; and the reinforcement comprises a lateral side portion configured to face a small toe of the user's foot, a medial side portion configured to face a big toe of the user's foot, an upper portion configured to face a top of the user's toes, and an end portion disposed between the lateral side portion and the medial side portion of the reinforcement and extending downwardly from the upper portion of the reinforcement.

31. The skate boot of claim 30, wherein the reinforcement is within the toe portion of the body of the skate boot.

32. The skate boot of claim 30, wherein the body of the skate boot includes a plurality of injection-molded layers that are injection molded with one another.

33. The skate boot of claim 30, wherein the reinforcement is within at least one of the injection-molded layers.

34. The skate boot of claim 33, wherein the reinforcement is located inside the at least one of the injection-molded layers.

35.-49. (canceled)

50. A skate comprising the skate boot of claim 1.

51. A sleeve for thermoforming a skate boot of a skate on a foot of a user, the skate boot comprising a cavity configured to receive the user's foot, the sleeve comprising:
a covering configured to cover at least part of the skate boot; and
a fastening system configured to fasten the covering to the skate boot and support the skate boot while the skate boot is being thermoformed with the user's foot in the skate boot.

52. The sleeve of claim 51, wherein: the skate boot comprises a medial side portion configured to face a medial side of the user's foot, a lateral side portion configured to face a lateral side of the user's foot, an ankle portion configured to receive an ankle of the user, a heel portion configured to receive a heel of the user's foot, and a sole portion configured to face a plantar surface of the user's foot; and the covering is configured to cover at least part of each of the medial side portion, the lateral side portion, the ankle portion, and the heel portion of the skate boot.

53. The sleeve of claim 52, wherein the covering is configured to cover at least part of the sole portion of the skate boot.

54. The sleeve of claim 51, wherein the fastening system comprises a plurality of fasteners spaced from one another.

55.-80. (canceled)

81. A method for thermoforming a skate boot of a skate on a foot of a user, the skate boot comprising a cavity configured to receive the user's foot, the method comprising:
heating the skate boot;
mounting a sleeve on the skate boot; and
thermoforming the skate boot with the user's foot in the skate boot while the sleeve is mounted to and supports the skate boot.

82.-85. (canceled)
